(19) United States
(12) Patent Application Publication
(10) Pub. No.: US 2026/0200727 A1
(43) Pub. Date: Jul. 16, 2026

(54) ACRIDINE-BASED RU-PINCER CATALYSTS FOR REVERSIBLE HYDROGEN STORAGE BASED ON ETHYLENE GLYCOL

(71) Applicant: YEDA RESEARCH AND DEVELOPMENT CO. LTD., Rehovot (IL)

(72) Inventors: David MILSTEIN, Rehovot (IL); Cai YOU, Rehovot (IL); Lijun LU, Rehovot (IL)

(73) Assignee: YEDA RESEARCH AND DEVELOPMENT CO. LTD., Rehovot (IL)

(21) Appl. No.: 19/448,153

(22) Filed: Jan. 14, 2026

(30) Foreign Application Priority Data
Jan. 15, 2025 (IL) 318418

(51) Int. Cl. C01B 3/0015; B01J 31/18

(52) U.S. Cl. CPC C01B 3/0015; B01J 31/189; B01J 2231/641; B01J 2231/763; B01J 2531/821

(57) ABSTRACT

Provided herein acridine-based Ru-pincer catalysts and methods for reversible loading and discharging hydrogen using ethylene glycol as a liquid organic hydrogen carrier. By reacting ethylene glycol with acridine-based Ru-pincer catalyst, an oligoester of ethylene glycol is formed (hydrogen (H₂) is released), and by reacting oligoester of ethylene glycol with acridine-based Ru-pincer catalyst and hydrogen (H₂), ethylene glycol is formed (hydrogen loading).

### CROSS REFERENCE TO RELATED APPLICATIONS

This application claims the benefit of Israeli Patent Application No. 318418 filed on 15 Jan. 2025 which is incorporated in its entirety herein by reference.

### FIELD OF THE INVENTION

This invention provides acridine-based Ru-pincer catalysts and methods for reversible loading and discharging hydrogen using ethylene glycol as a liquid organic hydrogen carrier. By reacting ethylene glycol with acridine-based Ru-pincer catalyst, an oligoester of ethylene glycol is formed (hydrogen (H₂) is released), and by reacting oligoester of ethylene glycol with acridine-based Ru-pincer catalyst and hydrogen (H₂), ethylene glycol is formed (hydrogen loading).

### BACKGROUND OF THE INVENTION

The excessive consumption of fossil fuels leads to a significant increase in the generation of waste and greenhouse gas emissions, particularly CO₂, which causes environmental pollution and climate change. Additionally, heavy consumption of fossil fuels is unsustainable because they take millions of years to form and are being depleted much faster than they can be naturally replenished. Thus, there is an urgent need to develop green and renewable energy sources to replace traditional fossil fuels for a sustainable future. In this context, hydrogen, which produces only water upon combustion and could be produced by electrochemical water splitting, is considered as a promising renewable energy carrier. However, although hydrogen possesses the highest gravimetric energy density (33.3 kWh kg⁻¹), its low volumetric energy density at ambient conditions (0.003 kWh L⁻¹), along with its flammability and broad explosion limits, impedes efficient handling, storage and transportation, particularly for long-term/long-distance applications. To address these issues, various hydrogen storage methods such as compressed hydrogen, cryogenic hydrogen, metal hydrides, and hydrogen adsorption in porous materials have been established and investigated, but these methods often suffer from high costs, low capacity, or safety risks. Liquid organic hydrogen carriers (LOHCs), which store hydrogen in covalent bonds of liquid organic compounds, have high hydrogen storage capacity (HSC), and can be easily handled and transported, representing a promising approach for chemical hydrogen storage in liquid form. Moreover, the compatibility of LOHCs with existing oil and gas transportation infrastructure is a major benefit that can further reduce the costs of storage and delivery, making them more attractive.

Recently, simple organic compounds, including formic acid, formaldehyde, methanol and methyl formate have been introduced as hydrogen carriers. However, the release of CO₂ and the inconvenient reloading of H₂ due to the consumption of these liquid carriers limit these approaches. To advance more efficient hydrogen storage systems, liquid-organic hydrogen carriers (LOHCs) have emerged as a unique and powerful tool, using a pair of H₂-rich and H₂-lean organic liquids that can reversibly discharge and load hydrogen via catalytic dehydrogenation and hydrogenation cycles. In this regard, aromatic compounds and their hydrogenated alicyclic compounds have been studied, but harsh reaction conditions (usually >250° C.) were required, especially for the strongly endothermic dehydrogenation step. To lower the enthalpy of hydrogenation/dehydrogenation, LOHCs based on nitrogen-containing heterocycles, which have high HSCs ranging from 5.3 to 7.3 wt %, have been developed. However, high temperatures were still required and resulted in decomposition products in some cases. Recently, Milstein (Hu, P.; Fogler, E.; Diskin-Posner, Y; Iron, M. A.; Milstein, D. A novel liquid organic hydrogen carrier system based on catalytic peptide formation and hydrogenation. Nat. Commun. 2015, 6, 6859; Hu, P.; Ben-David, Y; Milstein, D. Rechargeable hydrogen storage system based on the dehydrogenative coupling of ethylenediamine with ethanol. Angew. Chem. Int. Ed. 2016, 55, 1061-1064; Kumar, A.; Janes, T.; Espinosa-Jalapa, N. A.; Milstein, D. Selective hydrogenation of cyclic imides to diols and amines and its application in the development of a liquid organic hydrogen carrier. J. Am. Chem. Soc. 2018, 140, 7453-7457; and Xie, Y; Hu, P.; Ben-David, Y; Milstein, D. Areversible liquid organic hydrogen carrier system based on methanol-ethylenediamine and ethylene urea. Angew. Chem. Int. Ed. 2019, 58, 5105-5109), Prakash (Kothandaraman, J.; Kar, S.; Sen, R.; Goeppert, A.; Olah, G. A.; Prakash, G. K. S. Efficient reversible hydrogen carrier system based on amine reforming of methanol. J. Am. Chem. Soc. 2017, 139, 2549-2552) and Liu (Shao Z.; Li, Y; Liu, C.; Ai, W.; Luo, S.-P.; Liu, Q. Reversible interconversion between methanoldiamine and diamide for hydrogen storage based on manganese catalyzed (de)hydrogenation. Nat. Commun. 2020, 11, 591) have developed LOHCs based on amide bond formation and hydrogenation, and widely available and inexpensive amines along with alcohols have been in these systems. Nevertheless, the solid nature of these amides (hydrogen deficient compounds) leads to difficulties in the hydrogenation step as well as transportation complications. Consequently, the pursuit of ideal liquid-to-liquid paired LOHC systems is challenging, but highly desirable. Moreover, in line with the principles of sustainable development, the advancement of LOHC systems based on bio-based materials is becoming increasingly attractive.

Since 2019, three promising liquid-to-liquid paired LOHC systems based on inexpensive, widely accessible, and bio-based alcohols, including ethylene glycol (Zou, Y Q.; von Wolff, N.; Anaby, A.; Xie, Y; Milstein, D. Ethylene Glycol as an Efficient and Reversible Liquid Organic Hydrogen Carrier. Nat. Catal. 2019, 2, 415-422), 1,4-butanediol (Onoda, M.; Nagano, Y; Fujita, K. Iridium-Catalyzed Dehydrogenative Lactonization of 1,4-Butanediol and Reversal Hydrogenation: New Hydrogen Storage System Using Cheap Organic Resources. Int. J. Hydrogen Energy 2019, 44, 28514-28520), and ethanol (Tran, B. L.; Johnson, S. I.; Brooks, K. P.; Autrey, S. T. Ethanol as a Liquid Organic Hydrogen Carrier for Seasonal Microgrid Application: Catalysis, Theory, and Engineering Feasibility. ACS Sustainable Chem. Eng. 2021, 9, 7130-7138), have been developed by Milstein, Fujita, and Tran, respectively. In comparison to 1,4-butanediol and ethanol systems, whose theoretical HSCs are 4.5 wt % and 4.4 wt %, respectively, Milstein's ethylene glycol system possesses a theoretical HSC of 6.5 wt %, which is above the targets set for 2020 by the European Union (5.0 wt %) and the US Department of Energy (5.5 wt %). Therefore, the economic, environmental and practical merits of ethylene glycol (EG) make it a promising candidate for LOHC applications (FIG. 1A). Nevertheless, due to encountering a dual challenge of catalyst stability and catalytic activity in the acceptorless dehydrogenative coupling of EG, previously tested catalysts suffer from low/modest conversions or insufficient H₂ release, and development of an efficient catalyst for this process is needed.

The reaction pathway for the LOHC based on EG comprises two parts (FIG. 1A, left): the acceptorless catalytic dehydrogenative coupling of EG (hydrogen release process) and the hydrogenation of the corresponding oligoesters back to EG (hydrogen storage process). For the hydrogen release process, the initial step involves the coupling of two molecules of ethylene glycol (EG) to form 2-hydroxyethyl glycolate (HEG), catalyzed by a metal pincer complex, with the concomitant release of two equivalents of hydrogen. Subsequently, HEG can react with additional equivalents of EG in a similar manner to produce higher oligomers (FIG. 1B). However, the acceptorless catalytic dehydrogenative coupling of EG to HEG or corresponding oligoesters is highly challenging due to potential drawbacks that may explain EG's reluctance to efficiently undergo the desired transformation, including: (1) EG chelates the metal center of the pincer complex, hampering catalyst activity; (2) hydrogen bonding between a possible alkoxy metal complex and neighboring EG may hinder the β-hydride elimination steps, preventing the generation of the aldehyde intermediate; (3) HEG can be dehydrogenated to an α-keto ester upon oxidation of the α-hydroxyl group, which could decompose to CO and aldehyde, leading to CO poisoning of the catalyst; and (4) the undesired formation of cyclic side products ((1,3-dioxolan-2-yl)methanol) with lower hydrogen storage capacities. Crucially, as higher HSC is directly contingent upon achieving greater degrees of oligomerization (FIG. 1C), the catalytic capability to facilitate high levels of oligomerization becomes a critical determinant in the success of the system. However, this poses a significant challenge for catalysts due to the increased steric hindrance and the more complex structures of these oligoesters.

Previously, a series of pincer catalysts, which are privileged in hydrogenation and dehydrogenation reactions, including PNNH-Ru (Ru-1, Ru-2 and Ru-3), PNN-Ru (Ru-4, Ru-7 and Ru-8), PNP-Ru (Ru-5 and Ru-6) and MACHO-Ru (Ru-9), were tested by Milstein (Zou, Y Q.; von Wolff, N.; Anaby, A.; Xie, Y; Milstein, D. Ethylene Glycol as an Efficient and Reversible Liquid Organic Hydrogen Carrier. Nat. Catal. 2019, 2, 415-422) and others (Hellman, A. N.; Torquato, N. A.; Foster, M. E.; Dun, C.; Reynolds, J. E.; Yu, C. J.; Tran, A. D.; Shivanna, M.; Frances, G.; Garcia, H.; Yang, J.; Chen, Y; Su, J.; Urban, J. J.; Allendorf, M. D.; Stavila, V. ACS Appl. Energ. Mater 2023, 6, 7353-7362) in the dehydrogenative coupling of EG. However, the low conversions and insufficient H₂ yields (4%~46%) demonstrated that these catalyst systems are inefficient for this transformation, underscoring the challenges of this process (FIG. 1D). In contrast, Milstein's acridine-based complex Ru-10 and its dearomatized version Ru-11, achieved significantly better results, with Ru-10 affording 94% conversion and 56% H₂ yield, and Ru-11 reaching 97% conversion and 64% H₂ yield. Despite Ru-11's improved performance, this result remains insufficient, particularly for practical applications. Therefore, the development of new catalysts that can overcome the limiting factors in the dehydrogenative coupling of EG, give higher reactivities and better H₂ yields, is highly desirable.

### SUMMARY OF THE INVENTION

In some aspects the present invention provides a compound represented by the structure of Formula (A) or any isomer thereof:

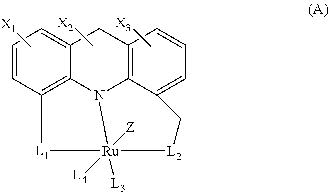

wherein,
L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently substituted or unsubstituted linear or branched C₁-C₁₀ alkyl;
L₃ and L₄ are each independently absent or a mono-dentate two-electron donor selected from the group consisting of CO, P(R)₃, P(OR)₃, NO⁺, As(R)₃, Sb(R)₃, S(R)₂, nitrile (RCN), isonitrile (RNC), ether or cyclic ether; and O—, N— or S— heterocycle or heteroaryl, wherein R is selected from the group consisting of alkyl, cycloalkyl, aryl, alkylaryl, heterocyclyl and heteroaryl; wherein if L₃ is absent then L₄ is mono-dentate two-electron donor selected from the above group; and wherein if L₄ is absent then L₃ is mono-dentate two-electron donor selected from the above group;
Z is H or an anionic ligand selected from the group consisting of halogen, OCOR, OCOCF₃, OSO₂R, OSO₂CF₃, CN, OH, OR, N(R)₂, RS and SH; wherein R is as defined above;
X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety.

In some aspects, the present invention provides a reversible hydrogen loading and discharging method comprising the steps of:
a) hydrogen releasing process wherein ethylene glycol is reacted with at least one compound of Formula A; thereby forming hydrogen molecule (H₂) and oligoester of ethylene glycol;
b) hydrogen loading process wherein said oligoester of ethylene glycol is reacted with at least one compound of Formula A and hydrogen molecule (H₂); thereby forming ethylene glycol.

### BRIEF DESCRIPTION OF THE DRAWINGS

The subject matter regarded as the present invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIGS. 1A-1E show Liquid Organic Hydrogen Carrier (LOHC) concept based on ethylene glycol (EG). FIG. 1A: General concept of LOHC. Cat, catalyst. FIG. 1B: Challenges in catalytic acceptorless dehydrogenative coupling of EG. NEC, N-ethylcarbazole. FIG. 1C: hydrogen storage capacity (HSC) versus degree of polymerization based on EG. FIG. 1D: Previous Ru-pincer catalysts and results of catalytic acceptorless dehydrogenative coupling of EG.

FIG. 1E: Long short arm acridine based Ru-pincer catalysts for reversible hydrogen storage based on EG (present invention).

FIG. 2 shows X-ray crystal structure of LS-Ru-1-Cl.

FIG. 3 shows X-ray crystal structure of acridine-based Ru-pincer catalyst 1.

FIG. 4 shows X-ray crystal structure of LS-Ru-3-Cl.

FIG. 5 shows X-ray crystal structure of acridine-based Ru-pincer catalyst 3.

FIG. 6 shows X-ray crystal structure of LS-Ru-1-OAc.

FIG. 7 shows schematic drawing and sideview of the gas collecting system.

FIG. 8 shows long-short-arm acridine based Ru-pincer complexes catalyzed base-free dehydrogenative coupling of EG. Th=2-Thienyl, Fu=2-Furyl.

FIGS. 9A-9C show a study of 1 and Ru-11 in dehydrogenative coupling of EG. FIG. 9A: The correlation between reaction time, conversions of EG and H₂ yields. FIG. 9B: Continuous experiments with Ru-11. FIG. 9C: Dehydrogenative coupling of HEG (2-hydroxyethyl glycolate).

FIGS. 10A-10B show mechanistic study for acceptorless dehydrogenative coupling of EG into HEG. FIG. 10A: Calculated lowest free energy pathway for acceptorless dehydrogenative coupling of EG into HEG catalyzed by 1. FIG. 10B: Calculated lowest free energy pathway for acceptorless dehydrogenative coupling of EG into HEG catalyzed by Ru-11.

FIG. 11 shows a schematic drawing and sideview of the reduced pressure reaction system as employed in solvent- and additive-free dehydrogenation/hydrogenation cycle of Example 5.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

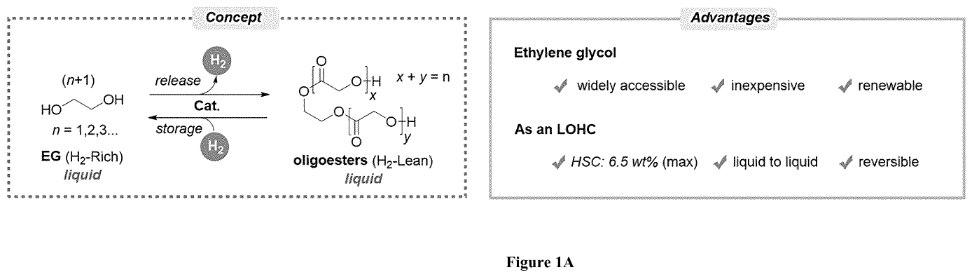

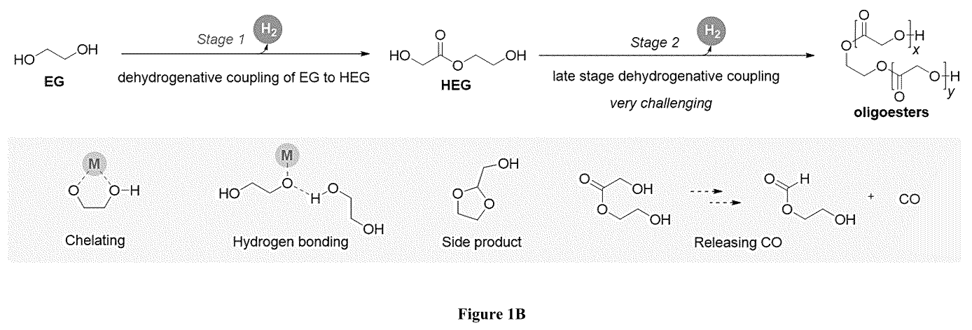

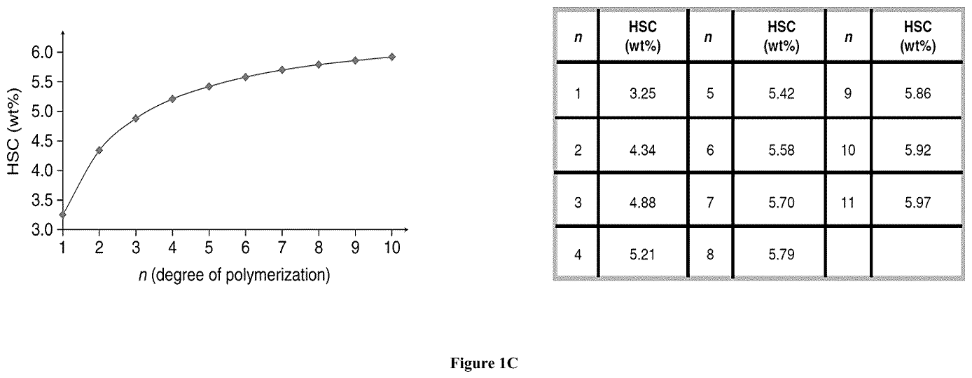

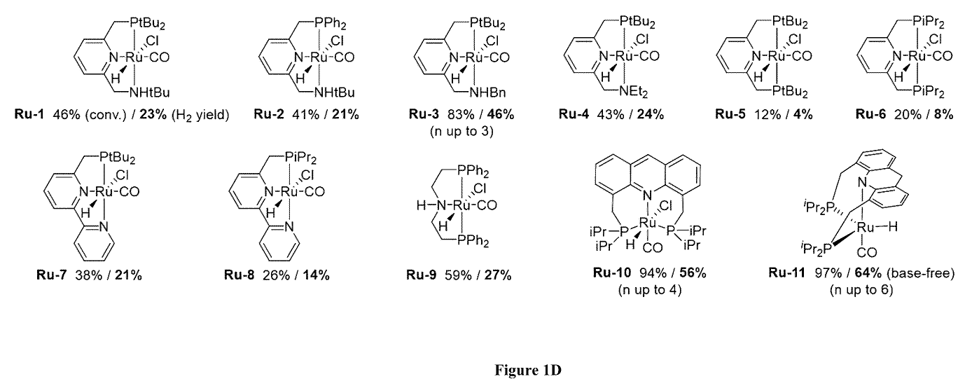

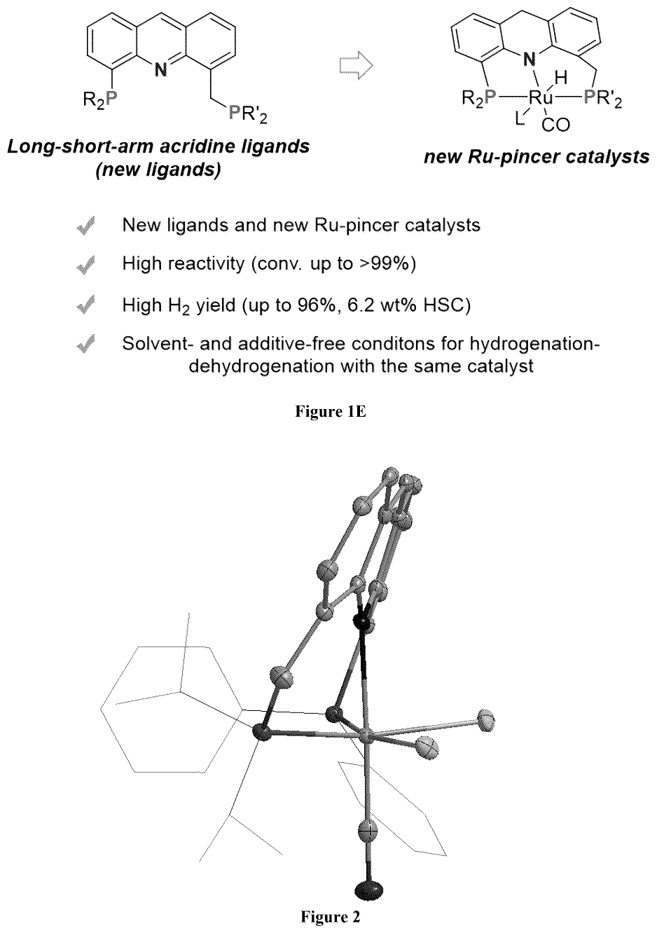

The present invention involves Ru-acridine-based complexes based on innovative long-short-arm acridine ligands and their application in the LOHC system using ethylene glycol (FIG. 1E). These complexes facilitate a highly efficient dehydrogenative coupling of EG, achieving high conversions (up to >99%) and a hydrogen yield exceeding 90% (up to 96%) for the first time, resulting in a hydrogen storage capacity of up to 6.2 wt %. In some embodiments, the entire cycle of the EG-LOHC system, encompassing both dehydrogenation and hydrogenation, has been successfully achieved for the first time using a single catalyst under solvent-free and additive-free conditions.

In one aspect, the present invention provides a compound represented by the structure of Formula (A) or any isomer thereof:

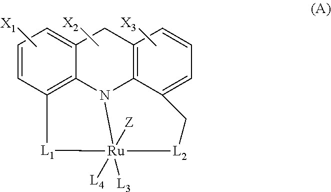

wherein,
L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently substituted or unsubstituted linear or branched C₁-C₁₀ alkyl;
L₃ and L₄ are each independently absent or a mono-dentate two-electron donor selected from the group consisting of CO, P(R)₃, P(OR)₃, NO⁺, As(R)₃, Sb(R)₃, S(R)₂, nitrile (RCN), isonitrile (RNC), ether or cyclic ether; and O—, N— or S— heterocycle or heteroaryl, wherein R is selected from the group consisting of alkyl, cycloalkyl, aryl, alkylaryl, heterocyclyl and heteroaryl;
wherein if L₃ is absent then L₄ is mono-dentate two-electron donor selected from the above group; and wherein if L₄ is absent then L₃ is mono-dentate two-electron donor selected from the above group;
Z is H or an anionic ligand selected from the group consisting of halogen, OCOR, OCOCF₃, OSO₂R, OSO₂CF₃, CN, OH, OR, N(R)₂, RS and SH; wherein R is as defined above;
X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety.

In some embodiments at least one of L₃ and L₄ is a heteroaryl. In some embodiments at least one of L₃ and L₄ is a heterocyclyl. In some embodiments at least one of L₃ and L₄ is a pyridine, thiophen or furan. In some embodiments at least one of L₃ and L₄ is a pyrimidine or tetrahydrofuran.

In some embodiments, Z is H.

In some embodiments, L₃ or L₄ is CO.

In some embodiments, L₁ and L₂ is each independently selected from P(alk₁)(alk₂), P(alk₁)(aryl), P(aryl)(aryl).

In some embodiments, X₁-X₃ each independently represents zero substituents.

In some other embodiments, one of L₃ and L₄ is a heteroaryl or a heterocyclyl and the other (of L₃ and L₄) is CO; Z is H; L₁ and L₂ is each independently selected from P(alk₁)(alk₂), P(alk₁)(aryl), P(aryl)(aryl); and/or X₁-X₃ each independently represents zero substituents. In one embodiment, one of L₃ and L₄ is a heteroaryl or a heterocyclyl and the other (of L₃ and L₄) is CO;
Z is H; L₁ and L₂ is each independently selected from P(alk₁)(alk₂), P(alk₁)(aryl), P(aryl)(aryl); and X₁-X₃ each independently represents zero substituents.

In one embodiment, the present invention provides a compound represented by the structure of Formula (Aa) or isomer thereof:

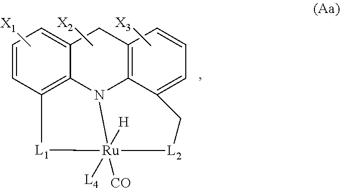

wherein X₁-X₃, L₁-L₂ and L₄ are as described for Formula (A).

In another embodiment, the present invention provides a compound represented by the structure of Formula (Ab) or isomer thereof:

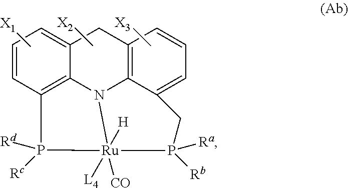

wherein,
each of R^{a}, R^{b}, R^{c} and R^{d} is independently selected from the group consisting of substituted or unsubstituted aryl and linear or branched C₁-C₁₀ alkyl; and
X₁-X₃ and L₄ are as described for Formula (A).

In another embodiment, the present invention provides a compound represented by the structure of Formula (Ac) or isomer thereof:

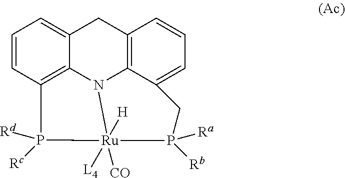

wherein,
R^{a}, R^{b}, R^{c}, R^{d} and L₄ are as described for Formula (Ab).

In another embodiment, the present invention provides a compound represented by structures 1-5 or isomer thereof:

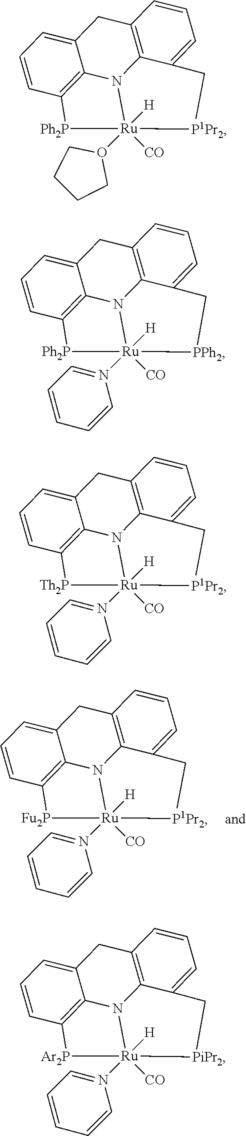

wherein

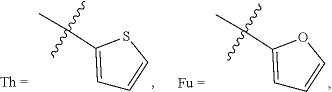 [SMILES: *c1cccs1 ; *c1ccco1]

Ph is phenyl, iPr is isopropyl, and

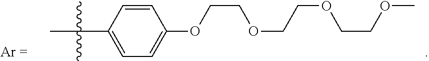 [SMILES: *c1ccc(OCCOCCOCCOC)cc1]

In one additional aspect, the present invention provides a compound represented by the structure of Formula (A1):

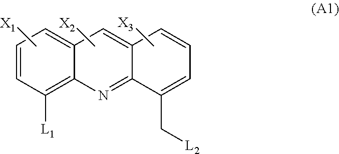

wherein,
L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently linear or branched C₁-C₁₀ alkyl; and
X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety.

In some embodiments, L₁ and L₂ is each independently selected from P(alk₁)(alk₂), P(alk₁)(aryl), P(aryl)(aryl).

In some embodiments, X₁-X₃ each independently represents zero substituents.

In some embodiments, L₁ and L₂ is each independently selected from P(alk₁)(alk₂), P(alk₁)(aryl), P(aryl)(aryl); and/or X₁-X₃ each independently represents zero substituents. In one embodiment, L₁ and L₂ is each independently selected from P(alk₁)(alk₂), P(alk₁)(aryl), P(aryl)(aryl); and X₁-X₃ each independently represents zero substituents.

In one embodiment, the present invention provides a compound represented by the structure of Formula (A1a):

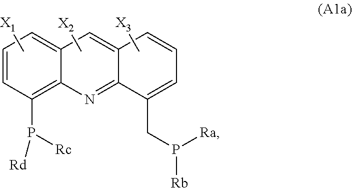

wherein,
each of R^{a}, R^{b}, R^{c} and R^{d} is independently selected from the group consisting of substituted or unsubstituted aryl and linear or branched C₁-C₁₀ alkyl; and
X₁-X₃ are as described in Formula (A1).

In another embodiment, the present invention provides a compound represented by the structure of Formula (A1b):

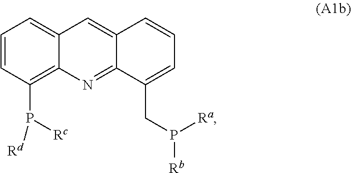

wherein
R^{a}, R^{b}, R^{c}, and R^{d} are as described for Formula (A1a).

In another embodiment, the present invention provides a compound represented by structures 6-10:

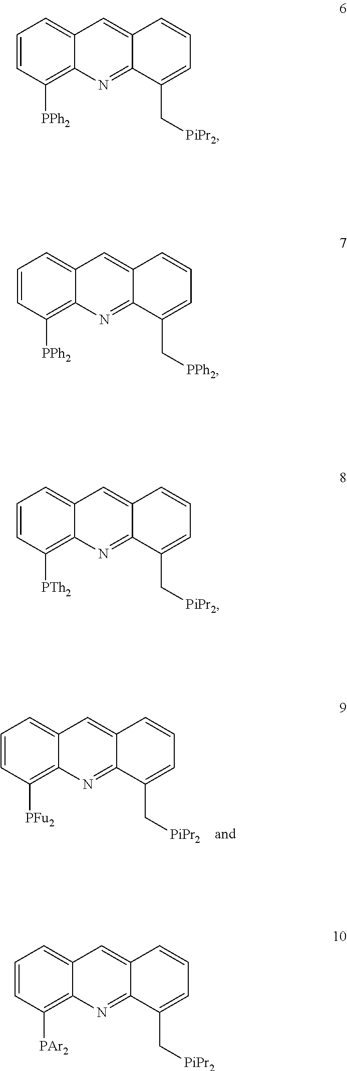

wherein

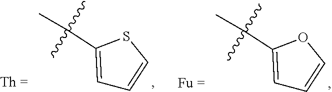 [SMILES: *c1cccs1 ; *c1ccco1]

Ph is phenyl, iPr is isopropyl, and

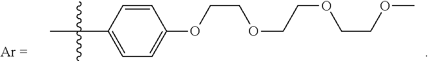 [SMILES: *c1ccc(OCCOCCOCCOC)cc1]

In one further aspect, the present invention provides a reversible hydrogen loading and discharging method comprising the steps of:
a) hydrogen releasing process wherein ethylene glycol is reacted with the compound of Formula (A), (Aa), (Ab) or (Ac) or isomer thereof as described hereinabove; thereby forming hydrogen molecule (H₂) and oligoester of ethylene glycol;
b) hydrogen loading process wherein an oligoester of ethylene glycol is reacted with the compound of Formula (A), (Aa), (Ab) or (Ac) or isomer thereof as described hereinabove and hydrogen molecule (H₂); thereby forming ethylene glycol.

In some embodiments, the compounds of Formula (A), (Ab), (Ac) or isomer thereof and Compounds 1-5 or isomer thereof are acridine-based Ru-pincer catalysts, used in the method of reversible loading and discharging hydrogen. In other embodiments, the ligands of the Ru are linked asymmetrically to the acridine group. In other embodiments, the ligands are linked to the acridine group via a long (CH₂-ligand) and short (direct bond of the ligand to acridine) bonds.

In one embodiment, the at least one compound of Formula (A), (Ab), (Ac) or isomer thereof and Compounds 1-5 or isomer used in the reversible hydrogen loading and discharging method is supported on insoluble matrices; wherein the insoluble matrices are inorganic compounds comprising inorganic oxides or insoluble polymers. In another embodiment, the inorganic oxides comprise alumina, silica, titania, zirconia, magnesia, zeolites, and combinations thereof, optionally attached via tether. In another embodiment, the insoluble polymers comprise cross-linked polystyrene, optionally attached via a tether.

In some other embodiments, the reversible hydrogen loading and discharging method further comprises at least one organic solvent.

In some other embodiments, the reversible hydrogen loading and discharging method is conducted under a temperature of between about 120° C. to 170° C. In one embodiment, the temperature is 130° C.-150° C., 120° C.-150° C., 120° C.-140° C. or 150° C. to 170° C. In another embodiment, the temperature is 150° C.

In some other embodiments, the reversible hydrogen loading method is conducted under pressure of between about 80 mbar to 110 mbar. In one embodiment, the pressure is 80-100 mbar, 90-100 mbar, 90-110 mbar, 80-95 mbar, 95-110 mbar or 100-110 mbar. In another embodiment, the pressure is 95 mbar.

In some other embodiments, the reversible hydrogen loading and discharging method is capable of hydrogen storage capacity of at least 5 wt %. In one embodiment, the hydrogen storage capacity is of at least 6 wt %. In one embodiment, the hydrogen storage capacity is between 5-10 wt %. In one embodiment, the hydrogen storage capacity is between 5-20 wt %. In one embodiment, the hydrogen storage capacity is between 6-8 wt %. In another embodiment, the hydrogen storage capacity is 6.2 wt %.

In one further aspect, the present invention provides a method of preparing a compound represented by the structure of Formula (Aa) or any isomer thereof:

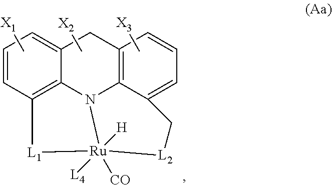

the method comprises:
   providing a compound represented by the structure of Formula (A1):

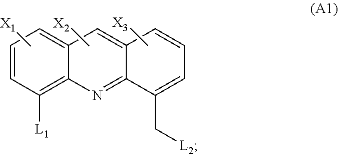

reacting the compound of Formula (A1) with a Ru compound, to provide a compound of Formula (B):

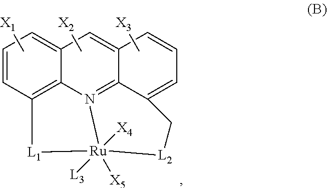

reacting the compound of Formula (B) with a hydride compound, to provide the compound of Formula (Aa);
wherein,
   L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently linear or branched C₁-C₁₀ alkyl; and
   X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety
   X₄ and X₅ are each independently halide, tosylate, triflate or mesylate;

In some embodiments, the Ru compound used in the method of preparing a compound of Formula (Aa) comprises RuCl₂(DMSO)₃(CO) or any other Ru (II) compound/salt comprising halide, tosylate, triflate or mesylate groups.

In some embodiments, the hydride compound used in the method of preparing a compound of Formula (Aa) comprises NaBHEt₃ or any other inorganic (preferably alumino- or boro-) hydride compound.

In some embodiments, one or more of the steps involved in the method of preparing a compound of Formula (Aa) is/are performed in an organic solvent.

In one further aspect, the present invention provides a reversible hydrogen loading and discharging system comprising: ethylene glycol as a liquid organic hydrogen carrier; and a compound of Formula (A), (Aa), (Ab) or (Ac) or isomer thereof as a catalyst. In one embodiment, the system further comprises an organic solvent.

A reversible hydrogen loading and discharging/releasing system of the present invention refers to any type of arrangement capable to holding the reactants of the reactions performed in said system, wherein the discharge and loading of hydrogen molecules is performed using ethylene glycol and the compound of Formula (A), (Aa), (Ab) or (Ac) or isomer thereof as described hereinabove.

Upon reaction of ethylene glycol with said compound of Formula (A), (Aa), (Ab) or (Ac) or isomer thereof, hydrogen molecules are released, to form the corresponding oligoester and a hydrogen molecule. The oligoester is capable of reacting again with another ethylene glycol molecule to form a further hydrogen molecule and a higher degree of oligoester.

Upon loading of hydrogen molecule, the oligoester is reacted with hydrogen molecules to form ethylene glycol.

In some embodiments, the organic solvent as found within the various aspects of the present invention is selected from benzene, toluene, o-, m-orp-xylene, mesitylene (1,3,5-trimethyl benzene), dioxane, THF, DME, DMSO, diglyme, DMF (dimethylformamide), valeronitrile, DMAC (dimethylacetamide), NMM (N-methylmorpholine), pyridine, n-BuCN, anisole, cyclohexane and combination thereof. In some embodiments, one or two organic solvents are employed herein.

In another embodiment, the compound of Formula (A), (Aa), (Ab), (Ac) or isomer thereof (Ruthenium catalyst) is absorbed on a solid support and the storing/loading and releasing/discharging hydrogen is done without a solvent.

In some embodiments, the systems and/or methods of the present invention are provided and/or performed under solvent-free and additive-free conditions. In one embodiment, non-limiting example of such method and/or system utilizing solvent-free and additive-free conditions can be found in Example 5 of the present invention as described hereinbelow.

### Applications

In one embodiment, the method and system of the present invention are used for a hydrogen fuel cell. In another embodiment, the method and system are used for fueling internal combustion engine. The method and system of the present invention releases hydrogen on-board in vehicles powered by a hydrogen fuel cell, for internal combustion engine, or the system stores and releases hydrogen at service stations, garages, central fleet refueling stations, and in residential individuals' homes, or other points of use. The release of the hydrogen is an on-site generation; and can be produced in individuals' homes or other points of use. Following the release of hydrogen, dehydrogenated compounds are taken to a specialized hydrogenation facility and the system is recovered upon treatment with pressurized hydrogen and a catalyst.

In one embodiment, the method and system of the present invention is used for dispensing and monitoring hydrogen-based fuel in a vehicle. The system is configured to store, release and dispense the hydrogen in the vehicle. The system also includes a fuel delivery system on the vehicle configured to deliver the hydrogen to the engine, and a control system configured to control the producing system and to monitor the use of the hydrogen by the vehicle.

The present invention provides a method for releasing hydrogen gas from the system of the present invention and using the hydrogen storage for vehicles powered by a hydrogen fuel cell and/or for internal combustion engine.

In one embodiment, the method and system can be pumped or poured for distribution to holding tanks and storage vessels. The liquid is easily transported using conventional methods for liquid transport and distribution (pipelines, railcars, tanker trucks). The hydrogen is generated on-site in the vehicle or by a dehydrogenation reactor system that delivers hydrogen and recovers the dehydrogenated substrate in a hydrogenation reactor site.

In one embodiment, the system of the present invention comprises a reaction chamber configured to collect the system and the compound of Formula (A), (Aa), (Ab) or (Ac) or isomer thereof as described hereinabove; a heating element configured to heat the system and a catalyst to release hydrogen; a buffer tank in flow communication with the reaction chamber configured to collect and temporarily store the hydrogen; a compressor system in flow communication with the buffer tank configured to pressurize the hydrogen to a selected pressure; a storage system in flow communication with the compressor system configured to store a selected quantity of the hydrogen; a dispensing system in flow communication with the storage system configured to dispense the hydrogen to a hydrogen fuel cell or to the internal combustion engine.

In one embodiment, the system of the present invention for use in the methods of this invention comprises a reaction chamber configured to collect the ethylene glycol (LOHC) and the compound of Formula (A), (Aa), (Ab) or (Ac) or isomer thereof (=the catalyst); a heating element configured to heat the LOHC and the catalyst to release hydrogen; a buffer tank in flow communication with the reaction chamber configured to collect and temporarily store the hydrogen; a compressor system in flow communication with the buffer tank configured to pressurize the hydrogen to a selected pressure; a storage system in flow communication with the compressor system configured to store a selected quantity of the hydrogen the selected pressure; a dispensing system in flow communication with the storage system configured to dispense the hydrogen to the hydrogen fuel cell or to the internal combustion engine. A second dispensing system in flow communication with the reaction chamber configured to dispense spent of the reaction to a spent tank, wherein the dehydrogenated substrate is recovered in the presence of pressurized hydrogen. The recovery of the dehydrogenated substrate is done on-board or off-board.

In some embodiments, L₁ of the compounds provided herein is P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), or N(aryl)(aryl), wherein alk₁, alk₂ are each independently substituted or unsubstituted linear or branched C₁-C₁₀ alkyl. In one embodiment, L₁ is P(alk₁)(alk₂). In one embodiment, L₁ is P(alk₁)(aryl). In one embodiment, L₁ is P(aryl)(aryl). In one embodiment, L₁ is SH. In one embodiment, L₁ is S(alk₁). In one embodiment, L₁ is S(aryl). In one embodiment, L₁ is N(alk₁)(alk₂). In one embodiment, L₁ is NH(alk₁). In one embodiment, L₁ is NH(aryl). In one embodiment, L₁ is NH(benzyl). In one embodiment, L₁ is N(alk₁)(aryl). In one embodiment, L₁ is N(aryl)(aryl).

In some embodiments, L₂ of the compounds provided herein is P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), or N(aryl)(aryl), wherein alk₁, alk₂ are each independently substituted or unsubstituted linear or branched C₁-C₁₀ alkyl. In one embodiment, L₂ is P(alk₁)(alk₂). In one embodiment, L₂ is P(alk₁)(aryl). In one embodiment, L₂ is P(aryl)(aryl). In one embodiment, L₂ is SH. In one embodiment, L₂ is S(alk₁). In one embodiment, L₂ is S(aryl). In one embodiment, L₂ is N(alk₁)(alk₂). In one embodiment, L₁ is NH(alk₁). In one embodiment, L₁ is NH(aryl). In one embodiment, L₂ is NH(benzyl). In one embodiment, L₂ is N(alk₁)(aryl). In one embodiment, L₂ is N(aryl)(aryl).

In some embodiments, L₃ of the compounds provided herein is absent or a mono-dentate two-electron donor. In one embodiment L₃ is absent. In one embodiment L₃ is a mono-dentate two-electron donor. In some embodiment, a mono-dentate two-electron donor comprises CO, P(R)₃, P(OR)₃, NO⁺, As(R)₃, Sb(R)₃, S(R)₂, nitrile (RCN), isonitrile (RNC), ether, cyclic ether, heterocycle or heteroaryl, wherein the heterocycle or the heteroaryl is attached to the Ru via the heteroatom (O, N, S); wherein R is selected from the group consisting of alkyl, cycloalkyl, aryl, alkylaryl, heterocyclyl and heteroaryl. In one embodiment, L₃ is CO. In one embodiment, L₃ is P(R)₃. In one embodiment, L₃ is P(OR)₃. In one embodiment, L₃ is NO⁺. In one embodiment, L₃ is As(R)₃. In one embodiment, L₃ is Sb(R)₃. In one embodiment, L₃ is S(R)₂. In one embodiment, L₃ is nitrile (RCN). In one embodiment, L₃ is isonitrile (RNC). In one embodiment, L₃ is an ether.

In one embodiment, L₃ is a cyclic ether. In one embodiment, L₃ is heterocycle wherein the heterocycle is attached to the Ru via its heteroatom (O, N, S). In one embodiment, L₃ is or heteroaryl, wherein the heteroaryl is attached to the Ru via its heteroatom (O, N, S).

In some embodiments, L₄ of the compounds provided herein is absent or a mono-dentate two-electron donor. In one embodiment L₄ is absent. In one embodiment L₄ is a mono-dentate two-electron donor. In some embodiment, a mono-dentate two-electron donor comprises CO, P(R)₃, P(OR)₃, NO⁺, As(R)₃, Sb(R)₃, S(R)₂, nitrile (RCN), isonitrile (RNC), ether, cyclic ether, heterocycle or heteroaryl, wherein the heterocycle or the heteroaryl is attached to the Ru via the heteroatom (O, N, S); wherein R is selected from the group consisting of alkyl, cycloalkyl, aryl, alkylaryl, heterocyclyl and heteroaryl. In one embodiment, L₄ is CO. In one embodiment, L₄ is P(R)₃. In one embodiment, L₃ is P(OR)₃. In one embodiment, L₄ is NO⁺. In one embodiment, L₄ is As(R)₃. In one embodiment, L₄ is Sb(R)₃. In one embodiment, L₄ is S(R)₂. In one embodiment, L₄ is nitrile (RCN). In one embodiment, L₄ is isonitrile (RNC). In one embodiment, L₄ is an ether.

In one embodiment, L₄ is a cyclic ether. In one embodiment, L₄ is heterocycle wherein the heterocycle is attached to the Ru via its heteroatom (O, N, S). In one embodiment, L₄ is or heteroaryl, wherein the heteroaryl is attached to the Ru via its heteroatom (O, N, S).

In some embodiments if L₃ is absent then L₄ is mono-dentate two-electron donor selected from the above group. In some embodiments, if L₄ is absent then L₃ is mono-dentate two-electron donor selected from the above group.

In some embodiments, Z of the of the compounds provided herein is H or an anionic ligand selected from the group consisting of halogen, OCOR, OCOCF₃, OSO₂R, OSO₂CF₃, CN, OH, OR, N(R)₂, RS and SH; wherein R is selected from the group consisting of alkyl, cycloalkyl, aryl, alkylaryl, heterocyclyl and heteroaryl. In one embodiment Z is H. In one embodiment Z is halogen.

In one embodiment Z is OCOR. In one embodiment Z is OCOCF₃. In one embodiment Z is OSO₂R. In one embodiment Z is OSO₂CF₃. In one embodiment Z is CN. In one embodiment Z is OH. In one embodiment Z is OR. In one embodiment Z is N(R)₂. In one embodiment Z is RS. In one embodiment Z is SH.

In some embodiments, X₁ of the of the compounds provided herein is zero, one, two or three substituents selected from the group consisting of alkyl, aryl, halogen, nitro, amide, ester, cyano, alkoxy, cycloalkyl, alkylaryl, heterocyclyl, heteroaryl, an inorganic support, a polymeric moiety and combination thereof. In one embodiment X₁ is a zero substituent (i.e. all the carbons are with H). In one embodiment X₁ is an alkyl. In one embodiment X₁ is an aryl. In one embodiment X₁ is halogen. In one embodiment X₁ is nitro. In one embodiment X₁ is amide. In one embodiment X₁ is ester. In one embodiment X₁ is cyano. In one embodiment X₁ is alkoxy. In one embodiment X₁ is cycloalkyl. In one embodiment X₁ is alkylaryl. In one embodiment X₁ is heterocyclyl. In one embodiment X₁ is heteroaryl. In one embodiment X₁ is an inorganic support.

In one embodiment X₁ is a polymeric moiety.

In some embodiments, X₂ of the of the compounds provided herein is zero, one, two or three substituents selected from the group consisting of alkyl, aryl, halogen, nitro, amide, ester, cyano, alkoxy, cycloalkyl, alkylaryl, heterocyclyl, heteroaryl, an inorganic support, a polymeric moiety and combination thereof. In one embodiment X₂ is a zero substituent (i.e. all the carbons are with H). In one embodiment X₂ is an alkyl. In one embodiment X₂ is an aryl. In one embodiment X₂ is halogen. In one embodiment X₂ is nitro. In one embodiment X₂ is amide. In one embodiment X₂ is ester. In one embodiment X₂ is cyano. In one embodiment X₂ is alkoxy. In one embodiment X₂ is cycloalkyl. In one embodiment X₂ is alkylaryl. In one embodiment X₂ is heterocyclyl. In one embodiment X₂ is heteroaryl. In one embodiment X₂ is an inorganic support. In one embodiment X₂ is a polymeric moiety.

In some embodiments, X₃ of the of the compounds provided herein is zero, one, two or three substituents selected from the group consisting of alkyl, aryl, halogen, nitro, amide, ester, cyano, alkoxy, cycloalkyl, alkylaryl, heterocyclyl, heteroaryl, an inorganic support, a polymeric moiety and combination thereof. In one embodiment X₃ is a zero substituent (i.e. all the carbons are with H). In one embodiment X₃ is an alkyl. In one embodiment X₃ is an aryl. In one embodiment X₃ is halogen. In one embodiment X₃ is nitro. In one embodiment X₃ is amide. In one embodiment X₃ is ester. In one embodiment X₃ is cyano. In one embodiment X₃ is alkoxy. In one embodiment X₃ is cycloalkyl. In one embodiment X₃ is alkylaryl. In one embodiment X₃ is heterocyclyl. In one embodiment X₃ is heteroaryl. In one embodiment X₃ is an inorganic support. In one embodiment X₃ is a polymeric moiety.

As used herein, the term “alkyl”, used alone or as part of another group, refers, in one embodiment, to a “C₁ to C₈ alkyl” or “C₁ to C₁₀ alkyl” denotes linear and branched, groups, Non-limiting examples are alkyl groups containing from 1 to 6 carbon atoms (C₁ to C₆ alkyls), or alkyl groups containing from 1 to 4 carbon atoms (C₁ to C₄ alkyls). Examples of saturated alkyl groups include, but are not limited to, methyl, ethyl, n-propyl, isopropyl, n-butyl, iso-butyl, sec-butyl, tert-butyl, amyl, tert-amyl, and hexyl.

The alkyl group can be unsubstituted, or substituted with one or more substituents selected from the group consisting of halogen, hydroxy, alkoxy, aryloxy, alkylaryloxy, heteroaryloxy, oxo, cycloalkyl, phenyl, heteroaryls, heterocyclyl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, alkylthio, arylthio, or alkylsulfonyl groups. Any substituents can be unsubstituted or further substituted with any one of these aforementioned substituents. By way of illustration, an “alkoxyalkyl” is an alkyl that is substituted with an alkoxy group.

The term “aryl” used herein alone or as part of another group denotes an aromatic ring system containing from 6-14 ring carbon atoms. The aryl ring can be a monocyclic, bicyclic, tricyclic and the like. Non-limiting examples of aryl groups are phenyl, naphthyl including 1-naphthyl and 2-naphthyl, and the like. The aryl group can be unsubstituted or substituted through available carbon atoms with one or more groups defined hereinabove for alkyl. An alkylaryl group denotes an alkyl group bonded to an aryl group (e.g., benzyl). In one further embodiment, the aryl is an “hydrophilic aryl”, i.e. aryl substituted with functional groups that add water solubility to the aryl. Examples of “hydrophilic aryl” include aryl substituted with various number of ethylene glycol units (possibly terminated with methoxy), e.g. 3-10, 3-5, 5-10, 7-10 or 3 units. In one embodiment, the (hydrophilic) aryl is:

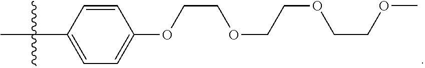 [SMILES: *c1ccc(OCCOCCOCCOC)cc1]

The term “heteroaryl” used herein alone or as part of another group denotes a heteroaromatic system containing at least one heteroatom ring atom selected from nitrogen, sulfur and oxygen. The heteroaryl contains 5 or more ring atoms. The heteroaryl group can be monocyclic, bicyclic, tricyclic and the like. Also included in this expression are the benzoheterocyclic rings. If nitrogen is a ring atom, the present invention also contemplates the N-oxides of the nitrogen containing heteroaryls. Nonlimiting examples of heteroaryls include thienyl, benzothienyl, 1-naphthothienyl, thianthrenyl, furyl, benzofuryl, pyrrolyl, imidazolyl, pyrazolyl, pyridyl, pyrazinyl, pyrimidinyl, pyridazinyl, indolyl, isoindolyl, indazolyl, purinyl, isoquinolyl, quinolyl, naphthyridinyl, quinoxalinyl, quinazolinyl, cinnolinyl, pteridinyl, carbolinyl, thiazolyl, oxazolyl, isothiazolyl, isoxazolyl and the like. The heteroaryl group can be unsubstituted or substituted through available atoms with one or more groups defined hereinabove for alkyl.

The term “heterocycle” (or “heterocyclyl” or “heterocycloalkyl”) unless otherwise stated, refers to a saturated or partially unsaturated group having a single cyclic ring or multiple condensed rings having from 2 to 11 carbon atoms and 1 to 5 heteroatoms, selected from nitrogen, oxygen, sulfur, and combinations thereof. For example, the heterocycloalkyl group can be, for example, dihydrofuran, tetrahydrofuran, pyrrolidine, dihydropyran, tetrahydropyran, 1,3-dioxane, 1,4-dioxane, dihydropyridinone, piperidine, piperazine, morpholine, thiomorpholine, urazole, 2-aza-bicyclo[2.2.2]oct-5-ane-3-one, and the like. Heterocycloalkyl also includes heterocyclic groups to which is fused an aryl or heteroaryl ring, for example tetrahydroisoquinoline or indoline. The heterocycloalkyl groups can be unsubstituted or substituted through available atoms with one or more groups defined hereinabove for alkyl.

The inorganic support which can be attached to the acridine ring as in X₁-X₃ can be, for example, silica, silica gel, glass, glass fibers, titania, zirconia, alumina and nickel oxide.

The polymer (in the polymeric moiety) which can be attached to the acridine ring as in X₁-X₃ is selected from polyolefins, polyamides, polyethylene terephthalate, polyvinylchloride, polyvinylidenechloride, polystyrene, polymethracrylate, natural rubber, polyisoprene, butadiene-styrene random copolymers, butadiene acrylonitrile copolymers, polycarbonate, polyacetal, polyphenylenesulfide, cyclo-olefin copolymers, styrene-acrylonitrile copolymers, ABS, styrene-maleic anhydride copolymers, chloroprene polymers, isobutylene copolymers, polystyrene, polyethylene, polypropylene, and the like.

As used herein, the term “isomers” refers to different structural forms having an identical chemical (empirical) formula. For example, isomers may include cis/trans and fac/mer isomers, structural and stereoisomers, as well as enantiomers and diastereomers.

As used herein, numerical ranges preceded by the term “about” should not be considered to be limited to the recited range. Rather, numerical ranges preceded by the term “about” should be understood to include a range accepted by those skilled in the art for any given element in according to the present invention, for example by up to +5%-10% of the numerical ranges.

The following examples are presented in order to more fully illustrate the preferred embodiments of the present invention. They should in no way, however, be construed as limiting the broad scope of the present invention.

### EXAMPLES

### Materials and Methods

All reactions were performed under an atmosphere of purified nitrogen in an MBraun glovebox, or by using standard Schlenk techniques unless otherwise noted. All commercially available reagents were used as received unless otherwise mentioned. Ethylene glycol (Acros Organics) was further dried over 4 Å molecular sieves (MS) before using. All solvents were purified according to standard procedures under an argon atmosphere, and stored over 4 Å MS.

Deuterated benzene, chloroform, dichloromethane and THF were degassed with nitrogen and stored in the glovebox over 4 Å MS. The pincer complex Ru-11 was prepared according to the literature procedure (Tang, S.; Rauch, M.; Montag, M.; Diskin-Posner, Y.; Ben-David, Y.; Milstein. D., Catalytic Oxidative Deamination by Water with H₂ Liberation. J. Am. Chem. Soc. 2020, 142, 20875-20882). Elevated temperatures were maintained using Thermostat-controlled silicone oil baths. Gas chromatography (GC) analysis was performed on an HP 6890 chromatograph, equipped with a thermal conductivity detector (TCD), using helium as the carrier gas. High resolution electrospray ionization mass spectrometry (HR-ESI-MS) was carried out on a Waters Xevo G2-XS QT of mass spectrometer at the Department of Chemical Research Support, Weizmann Institute of Science. NMR spectra were recorded using BrukerAvance NEO 300 MHz, Avance NEO 400 MHz, or Avance III HD 500 MHz spectrometers at 293 K. ¹H NMR chemical shifts are referenced to the residual hydrogen signal of the deuterated solvent, and the ¹³C NMR chemical shifts are referenced to the ¹³C signal of the deuterated solvent. ³¹P NMR chemical shifts are referenced with respect to an external solution of 85% phosphoric acid in D₂O. Abbreviations used in the description of NMR data are as follows: br, broad; s, singlet; d, doublet; t, triplet; q, quartet; m, multiplet. Infrared (IR) spectra were recorded on a Thermo Nicolet 6700 FT-IR spectrometer. Analytical TLC was performed on Merck silica gel 60 F254 plates. Flash chromatography columns were packed with 200-300 mesh silica gel.

### Preparation of Standard Curve by GC for H₂ and CO

GC conditions: HP 6890 Series GC System; column: SUPELCO 1-2382, 5Ft×1/8In S.S. SUPPORT 45/60 CARBOXEN™ 1000, Packed Column. Inlets: 87° C.; Detector: TCD 250° C.; Carrier Gas: He; Flow: 29.1 mL/min; Oven: 35° C., hold 2 min; 10° C./min to 60° C., hold 0 min; 30° C./min to 200° C.

### Example 1

### Synthesis of Compounds (Ligands) 6-10

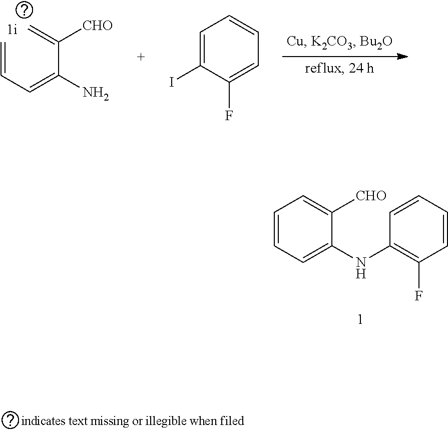

### Synthesis of 2-((2-fluorophenyl)amino)benzaldehyde (1i)

Under an N₂ atmosphere, 2-aminobenzaldehyde (146.6 mmol), 1-fluoro-2-iodobenzene (146.6 mmol), K₂CO₃ (99.7 mmol), and Cu (23.5 mmol) were dissolved in Bu₂O (16.0 mL) and heated to reflux for 24 h. The reaction was then filtered and concentrated in vacuo. The crude product was purified via flash chromatography (hexane/ethyl acetate=100:1 to 30:1) to give 1i as a yellow solid (33.5 g, 77% yield).

¹H NMR (300 MHz, CDCl₃) δ 9.93 (s, 1H), 9.90 (s, 1H), 7.59 (dd, J=7.7, 1.3 Hz, 1H), 7.48-7.34 (m, 2H), 7.21-7.10 (m, 3H), 7.07 (d, J=8.6 Hz, 1H), 6.88 (t, J=7.4 Hz, 1H).

¹³C NMR (75 MHz, CDCl₃) δ 194.47, 156.22 (d, J=247.2 Hz), 147.29, 136.58, 135.63, 125.57 (d, J=7.6 Hz), 124.85 (d, J=1.4 Hz), 124.51 (d, J=3.9 Hz), 119.96, 117.82, 116.53 (d, J=19.8 Hz), 113.17 (d, J=1.2 Hz).

¹⁹F NMR (282 MHz, CDCl₃) δ−124.64 (s).

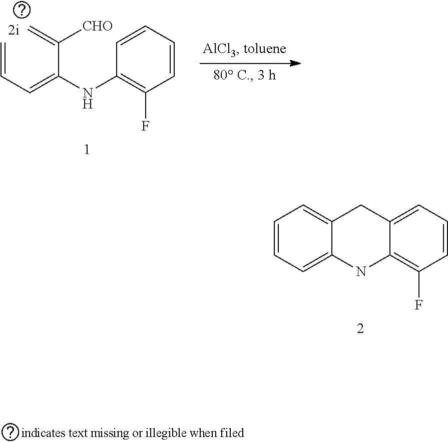 [SMILES: C=C/C=C(/Nc1ccccc1F)C(=C)C=O ; Fc1cccc2c1Nc1ccccc1C2]

### Synthesis of 4-fluoroacridine (2i)

AlCl₃ (104.0 mmol) was added into a solution of 2-((2-fluorophenyl)amino)benzaldehyde 1i (52.0 mmol) in toluene (208.0 mL) and the mixture was heated at 80° C. for 3 h. After the reaction was cooled to room temperature, it was poured onto crushed ice and stirred slowly for 1 h. The mixture was extracted with dichloromethane and the combined organic phase was dried over Na₂SO₄, filtered and concentrated. The crude product was purified by flash chromatography (hexane/ethyl acetate=20:1 to 5:1) to give 2i as a yellow solid (9.2 g, 90% yield).

¹H NMR (400 MHz, CDCl₃) δ 8.73 (s, 1H), 8.33 (d, J=8.9 Hz, 1H), 7.95 (d, J=8.5 Hz, 1H), 7.81-7.70 (m, 2H), 7.56-7.50 (m, 1H), 7.45-7.36 (m, 2H).

¹³C NMR (101 MHz, CDCl₃) δ 157.88 (d, J=258.0 Hz), 148.93, 140.19 (d, J=12.8 Hz), 136.07 (d, J=3.4 Hz), 130.91, 129.97, 128.20, 127.96 (d, J=2.3 Hz), 127.02, 126.54, 124.95 (d, J=7.7 Hz), 124.08 (d, J=5.1 Hz), 113.01 (d, J=19.1 Hz).

¹⁹F NMR (282 MHz, CDCl₃) δ−125.80.

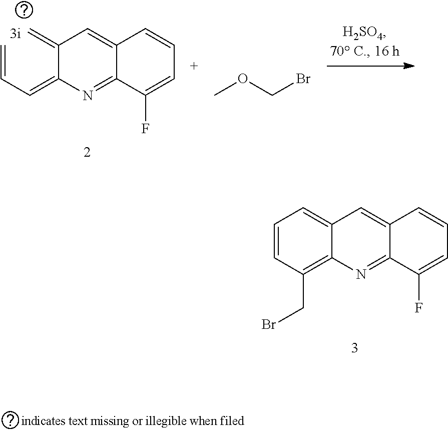

### Synthesis of 4-(bromomethyl)-5-fluoroacridine (3i)

A mixture of 4-fluoroacridine 2i (10.0 mmol) and concentrated H₂SO₄ (98%, 20.0 mL) was stirred under argon at 70° C. and bromomethyl methyl ether (20.0 mmol) was added to it in one portion. The mixture was maintained under nitrogen for 16 h at 70° C. and cooled to room temperature before slowly transferred to a beaker containing crushed ice and dichloromethane.

The mixture was extracted with dichloromethane and the combined organic phase was dried over Na₂SO₄, filtered and concentrated. The crude product was purified by flash chromatography (hexane/dichloromethane=4:1) to give 3i as a yellow solid (1.14 g, 39% yield).

¹H NMR (500 MHz, CDCl₃) δ 8.80 (s, 1H), 8.01-7.95 (m, 2H), 7.83-7.77 (m, 1H), 7.55 (t, J=7.7 Hz, 1H), 7.51-7.44 (m, 2H), 5.44 (s, 2H). (7.26 ppm)

¹³C NMR (126 MHz, CDCl₃) δ 158.32 (d, J=259.4 Hz), 146.33, 139.84 (d, J=12.9 Hz), 136.83, 136.22 (d, J=3.3 Hz), 131.76, 129.12, 128.23 (d, J=1.7 Hz), 127.09, 126.33, 125.52 (d, J=7.6 Hz), 123.86 (d, J=5.2 Hz), 113.31 (d, J=18.8 Hz), 29.83. (77.16 ppm)

¹⁹F NMR (471 MHz, CDCl₃) δ−124.99.

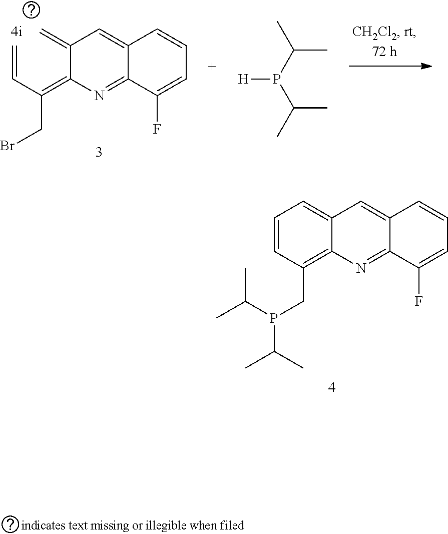

### Synthesis of 4-((diisopropylphosphanyl)methyl)-5-fluoroacridine (4i

In a glovebox, 4-(bromomethyl)-5-fluoroacridine 3i (748.0 mg, 2.58 mmol) was dissolved in dichloromethane (50 mL) in an oven-dried 100 mL round-bottom flask equipped with a magnetic stirring bar. Then diisopropylphosphane (457.4 mg, 3.87 mmol) was added and stirred at room temperature for 72 h. Triethylamine (1.31 g, 12.9 mmol) was added, and the resulting solution was stirred at room temperature for 1 hour. The solvent was removed under vacuum and the residue was extracted with diethyl ether. Subsequently, the diethyl ether solution was filtered through Celite and then removed under vacuum to yield 4i as a yellow solid (770.0 mg, 91% yield).

¹H NMR (400 MHz, CDCl₃) δ 8.74 (s, 1H), 7.82 (d, J=7.7 Hz, 2H), 7.79-7.74 (m, 1H), 7.49 (t, J=7.7 Hz, 1H), 7.41 (pd, J=7.4, 3.3 Hz, 2H), 3.68 (d, J=3.5 Hz, 2H), 1.93 (dtd, J=14.2, 7.1, 2.0 Hz, 2H), 1.17 (ddd, J=19.9, 12.3, 7.1 Hz, 12H).

¹³C NMR (126 MHz, CDCl₃) δ 158.56 (d, J=259.3 Hz), 147.66 (s), 140.60 (d, J=8.2 Hz), 139.37 (d, J=12.9 Hz), 135.99 (d, J=3.3 Hz), 130.41 (d, J=9.3 Hz), 128.01 (d, J=2.1 Hz), 127.37 (s), 126.42 (s), 125.90 (d, J=2.2 Hz), 124.95 (d, J=7.6 Hz), 123.75 (d, J=5.1 Hz), 112.58 (d, J=18.8 Hz), 24.42 (d, J=18.9 Hz), 24.08 (d, J=14.6 Hz), 19.80 (d, J=13.0 Hz), 19.63 (d, J=12.0 Hz).

³¹P NMR (121 MHz, CDCl₃) δ 18.12.

¹⁹F NMR (377 MHz, CDCl₃) δ-143.31.

HRMS (ESI): Exact mass calculated for C₂₀H₂₄FNP⁺ ([M+H]⁺): 328.1625, mass found: 328.1626.

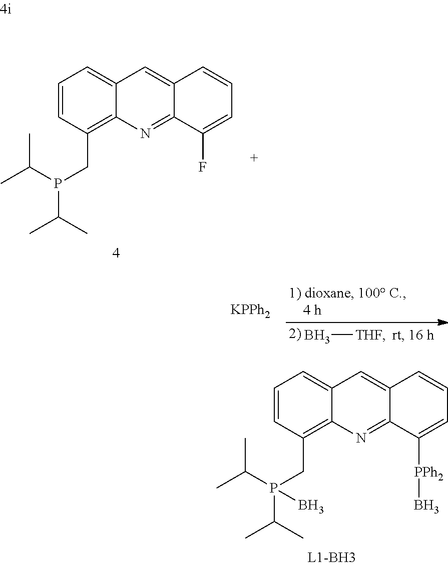

### Synthesis of L1-BH₃

In a glovebox, to a solution of 4-((diisopropylphosphanyl)methyl)-5-fluoroacridine 4i (1.42 g, 4.34 mmol) in dioxane (86 mL) was added dropwise 8.7 mL (4.34 mmol) of 0.5 M KPPh₂ in THF. The reaction tube was taken out of the glovebox and heated at 100° C. for 4 h, and cooled to room temperature. Then, BH₃-THF complex (13.0 mL, 13.0 mmol, 1M) was added and the mixture was stirred for 16 h at room temperature under nitrogen protected conditions. The resulting solution was concentrated in vacuo. The crude product was purified by flash chromatography (hexane/dichloromethane=4:1 to 2:1) to give L1-BH₃ as a yellow solid (1.31 g, 58% yield).

¹H NMR (500 MHz, CDCl₃) δ 8.79 (s, 1H), 8.28 (d, J=5.8 Hz, 1H), 8.15 (d, J=7.8 Hz, 1H), 7.84 (d, J=7.9 Hz, 1H), 7.63 (t, J=8.6 Hz, 4H), 7.51-7.45 (m, 3H), 7.44-7.34 (m, 6H), 3.66 (d, J=12.5 Hz, 2H), 1.85-1.75 (m, 2H), 1.96-1.46 (broad, 3H, BH₃), 1.00 (dd, J=14.0, 6.7 Hz, 6H), 0.86 (dd, J=13.3, 6.8 Hz, 6H), 0.82-0.25 (broad, 3H, BH₃).

¹³C NMR (126 MHz, CDCl₃) δ 147.72 (d, J=6.8 Hz), 147.10 (d, J=5.4 Hz), 138.89 (d, J=5.5 Hz), 137.45, 133.60 (d, J=2.3 Hz), 133.48, 133.40, 132.70, 132.68, 132.36 (d, J=4.4 Hz), 130.95, 130.94, 130.76, 130.29, 129.44, 128.98, 128.78, 128.70, 126.96, 126.67, 126.40 (d, J=5.4 Hz), 126.24, 124.99 (d, J=10.3 Hz), 22.81 (d, J=33.3 Hz), 19.82 (d, J=31.1 Hz), 17.38.

³¹P NMR (202 MHz, CDCl₃) δ 37.23-35.91 (broad), 23.08-21.62 (broad).

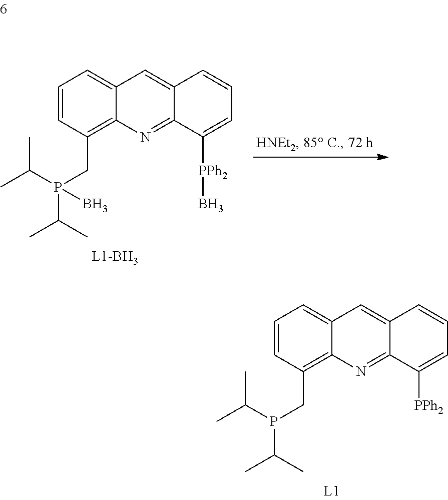

### Synthesis of 6

In a glovebox, L1-BH₃ (1.54 g, 3.04 mmol) and HNEt₂ (40 mL) were added into a 100 mL Schlenk tube equipped with a magnetic stirring bar. The reaction tube was taken out of the glovebox and heated at 85° C. for 72 h, cooled to room temperature and taken back into the glovebox. The solvent was removed under vacuum and the residue was extracted with diethyl ether. The diethyl ether solution was filtered through Celite and then removed under vacuum. The resulting yellow solid was washed with a small amount of methanol to obtain the pure ligand 6 (1.39 g, 93% yield).

¹H NMR (300 MHz, CDCl₃) δ 8.73 (s, 1H), 7.96 (dd, J=10.7, 4.8 Hz, 2H), 7.79 (d, J=8.3 Hz, 1H), 7.46 (dd, J=8.2, 7.2 Hz, 1H), 7.42-7.27 (m, 11H), 7.12 (ddd, J=6.8, 3.7, 1.2 Hz, 1H), 3.38 (d, J=3.4 Hz, 2H), 1.73-1.57 (m, 2H), 1.02 (dd, J=13.6, 7.1 Hz, 6H), 0.83 (dd, J=11.2, 7.0 Hz, 6H).

¹³C NMR (126 MHz, CDCl₃) δ 148.90 (d, J=16.2 Hz), 147.23, 140.20, 140.13, 139.49 (d, J=12.1 Hz), 138.11 (d, J=11.2 Hz), 136.45, 136.44, 134.94, 134.54, 134.38, 130.46, 130.33, 128.85, 128.52, 128.48, 128.42, 126.97, 126.06, 125.97, 125.82, 125.40, 125.38, 24.10 (d, J=12.6 Hz), 22.21 (d, J=16.5 Hz), 20.09 (d, J=14.6 Hz), 19.39 (d, J=9.9 Hz).

³¹P NMR (121 MHz, CDCl₃) δ 13.01, −12.32.

HRMS (ESI): Exact mass calculated for C₃₂H₃₄NP₂⁺ ([M+H]⁺): 494.2161, mass found: 494.2162.

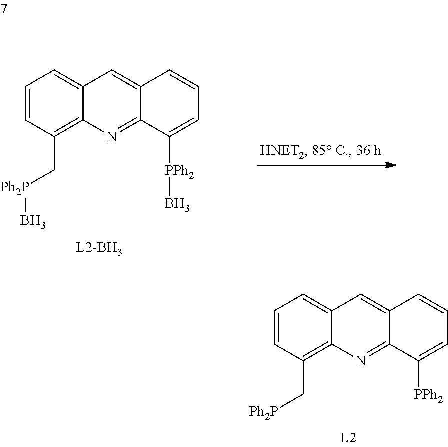

### Synthesis of 7

In a glovebox, L2-BH₃ (140.0 mg, 0.24 mmol) and HNEt₂ (10 mL) were added into a 100 mL Schlenk tube equipped with a magnetic stirring bar. The reaction tube was taken out of the glovebox and heated at 85° C. for 36 h, cooled to room temperature and taken back into the glovebox. The solvent was removed under vacuum and the residue was extracted with toluene.

The toluene solution was filtered through Celite and then removed under vacuum. The resulting yellow solid was washed with a small amount of methanol to obtain the pure ligand 7 (121.2 mg, 90% yield).

¹H NMR (300 MHz, CDCl₃) δ 8.72 (s, 1H), 7.99 (d, J=8.4 Hz, 1H), 7.81-7.75 (m, 1H), 7.52-7.46 (m, 4H), 7.45-7.39 (m, 1H), 7.36-7.31 (m, 9H), 7.30-7.27 (m, 4H), 7.25-7.15 (m, 6H), 3.90 (d, J=1.3 Hz, 2H).

¹³C NMR (75 MHz, CDCl₃) δ 148.79 (d, J=16.0 Hz), 146.73 (dd, J=3.3, 1.8 Hz), 140.04, 139.87, 139.61, 139.40, 137.92, 137.78, 137.09, 136.99, 136.31 (d, J=1.5 Hz), 134.66, 134.39, 133.59, 133.34, 129.79, 129.63, 128.69, 128.49, 128.47, 128.37, 128.30, 128.21, 126.89, 126.22 (d, J=1.4 Hz), 126.16 (d, J=2.5 Hz), 125.90, 125.64 (d, J=1.3 Hz), 29.98 (d, J=14.0 Hz).

³¹P NMR (121 MHz, CDCl₃) δ −11.34 (d, J=6.5 Hz), −12.66 (d, J=6.5 Hz).

HRMS (ESI): Exact mass calculated for C₃₈H₃₀NP₂⁺ ([M+H]⁺): 562.1848, mass found: 562.1854.

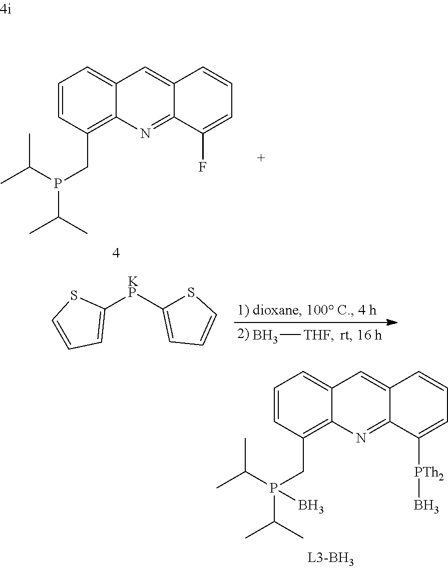

### Synthesis of L3-BH₃

In a glovebox, to a suspension of KH (1.1 equiv.) in anhydrous THF (0.5 M) was added dropwise di(thiophen-2-yl)phosphane⁴ (1.0 equiv.) at room temperature. Then the reaction mixture was stirred at room temperature for 12 hours, affording a THF solution of potassium di(thiophen-2-yl)phosphanide (~0.5 M), which was used directly in the next step.

In a glovebox, to a solution of 4-((diisopropylphosphanyl)methyl)-5-fluoroacridine 4i (654.8 mg, 2.00 mmol) in dioxane (40 mL) was added dropwise 4.4 mL (~2.20 mmol) of potassium di(thiophen-2-yl)phosphanide in THF. The reaction tube was taken out of the glovebox and heated at 100° C. for 4 h, and cooled to room temperature. Then, BH₃-THF complex (6.0 mL, 6.0 mmol, 1M) was added and the mixture was stirred for 16 h at room temperature under nitrogen protected condition. The resulting solution was concentrated in vacuo. The crude product was purified by flash chromatography (hexane/dichloromethane=4:1 to 2:1) to give L3-BH₃ as a yellow solid (554.6 mg, 52% yield).

¹H NMR (500 MHz, CDCl₃) δ 8.80 (s, 1H), 8.32 (d, J=6.9 Hz, 1H), 8.18 (d, J=8.2 Hz, 1H), 7.86 (d, J=8.3 Hz, 1H), 7.71-7.65 (m, 2H), 7.61-7.45 (m, 5H), 7.22-7.15 (m, 2H), 3.77 (d, J=12.6 Hz, 2H), 1.98 (qd, J=14.1, 7.1 Hz, 2H), 1.90-1.45 (broad, 3H, BH₃), 1.05 (dd, J=14.4, 7.1 Hz, 6H), 0.95 (dd, J=13.8, 7.1 Hz, 6H), 0.79-0.30 (broad, 3H, BH₃).

¹³C NMR (126 MHz, CDCl₃) δ 147.47 (d, J=7.8 Hz), 147.14 (d, J=5.4 Hz), 138.12 (d, J=6.1 Hz), 137.50, 137.13 (d, J=10.2 Hz), 133.74 (d, J=3.1 Hz), 133.59 (d, J=2.6 Hz), 133.14 (d, J=2.3 Hz), 132.51 (d, J=4.5 Hz), 132.01, 131.50, 130.13, 129.64, 128.55, 128.46, 126.97, 126.78 (d, J=1.6 Hz), 126.45, 126.38 (d, J=1.5 Hz), 125.02, 124.94, 22.94 (d, J=33.3 Hz), 20.20 (d, J=31.2 Hz), 17.50, 17.47.

³¹P NMR (202 MHz, CDCl₃) δ 37.55-35.98 (broad), 6.82-5.55 (broad).

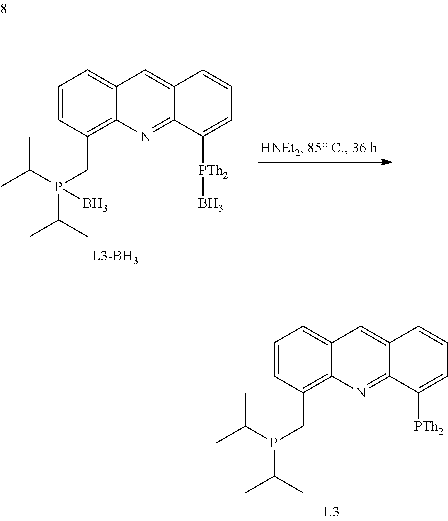

### Synthesis of 8

In a glovebox, L3-BH₃ (427.0 mg, 0.80 mmol) and HNEt₂ (18 mL) were added into a 100 mL Schlenk tube equipped with a magnetic stirring bar. The reaction tube was taken out of the glovebox and heated at 85° C. for 36 h, cooled to room temperature and taken back into the glovebox. The solvent was removed under vacuum and the residue was extracted with diethyl ether. The diethyl ether solution was filtered through Celite and then removed under vacuum. The resulting yellow solid was washed with a small amount of methanol to obtain the pure ligand 8 (347.8 mg, 86% yield).

¹H NMR (500 MHz, CDCl₃) δ 8.72 (s, 1H), 7.99 (d, J=8.3 Hz, 1H), 7.94 (d, J=6.4 Hz, 1H), 7.78 (d, J=8.4 Hz, 1H), 7.52 (d, J=4.9 Hz, 2H), 7.48-7.42 (m, 2H), 7.41-7.35 (m, 3H), 7.11 (t, J=4.0 Hz, 2H), 3.49 (d, J=3.1 Hz, 2H), 1.88-1.78 (m, 2H), 1.09 (dd, J=13.4, 7.1 Hz, 6H), 0.97 (dd, J=11.4, 7.0 Hz, 6H).

¹³C NMR (126 MHz, CDCl₃) δ 148.41 (d, J=16.9 Hz), 147.19 (dd, J=2.7, 2.0 Hz), 140.09, 140.02 (d, J=2.5 Hz), 139.97, 139.80, 139.60, 136.49 (d, J=1.8 Hz), 135.43, 135.22, 133.97, 131.40, 130.56, 130.43, 129.30, 128.05 (d, J=7.6 Hz), 126.96, 126.06 (d, J=1.6 Hz), 126.00, 125.70, 125.53 (d, J=2.0 Hz), 24.18 (d, J=13.0 Hz), 22.61 (d, J=16.9 Hz), 20.13 (d, J=14.2 Hz), 19.54 (d, J=10.3 Hz).

³¹P NMR (202 MHz, CDCl₃) δ 14.15, −41.16.

HRMS (ESI): Exact mass calculated for C₂₈H₃₀NP₂S₂⁺ ([M+H]⁺): 506.1289, mass found: 506.1295.

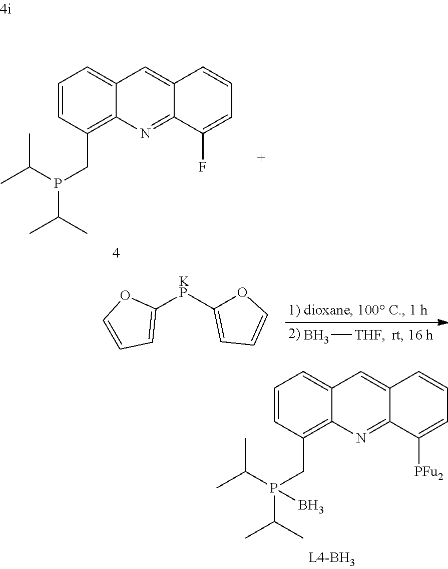

### Synthesis of L4-BH₃

In a glovebox, to a suspension of KH (1.1 equiv.) in anhydrous 1,4-dioxane (0.5 M) was added dropwise di(furan-2-yl)phosphane⁴ (1.0 equiv.) at room temperature. Then the reaction mixture was stirred at room temperature for 10 minutes, affording a 1,4-dioxane solution of potassium di(furan-2-yl)phosphanide (~0.5 M), which was used directly in the next step.

In a glovebox, to a solution of 4-((diisopropylphosphanyl)methyl)-5-fluoroacridine 4i (114.6 mg, 0.35 mmol) in dioxane (3.5 mL) was added dropwise 3.5 mL (~1.75 mmol) of potassium di(furan-2-yl)phosphanide in 1,4-dioxane. The reaction tube was taken out of the glovebox and heated at 100° C. for 1 h, and cooled to room temperature. Then, BH₃-THF complex (1.1 mL, 1.1 mmol, 1M) was added and the mixture was stirred for 16 h at room temperature under nitrogen protected condition. The resulting solution was concentrated in vacuo. The crude product was purified by flash chromatography (hexane/dichloromethane=4:1 to 2:1) to give L4-BH₃ as a yellow solid (68.2 mg, 40% yield).

¹H NMR (500 MHz, CDCl₃) δ 8.74 (s, 1H), 8.04 (d, J=6.6 Hz, 1H), 8.01 (d, J=8.0 Hz, 1H), 7.87 (d, J=8.3 Hz, 1H), 7.66-7.62 (m, 2H), 7.54-7.43 (m, 3H), 6.68 (s, 2H), 6.43 (s, 2H), 3.89 (d, J=12.6 Hz, 2H), 2.22-2.10 (m, 2H), 1.11 (dd, J=14.2, 7.0 Hz, 7H), 1.03 (dd, J=13.7, 6.9 Hz, 7H), 0.73-0.15 (broad, 3H, BH₃).

¹³C NMR (126 MHz, CDCl₃) δ 151.64 (d, J=8.4 Hz), 148.65, 148.52, 147.21, 147.19, 146.82 (d, J=2.7 Hz), 136.88, 136.32, 134.66, 133.08 (d, J=4.6 Hz), 132.07 (d, J=4.5 Hz), 129.36, 126.86, 126.84, 126.16 (d, J=1.3 Hz), 126.06, 125.96 (d, J=2.2 Hz), 121.01, 120.85, 111.08, 111.04, 22.49 (d, J=32.3 Hz), 20.54 (d, J=29.8 Hz), 17.48, 17.35.

³¹P NMR (202 MHz, CDCl₃) δ 38.82-37.70 (broad), −55.48.

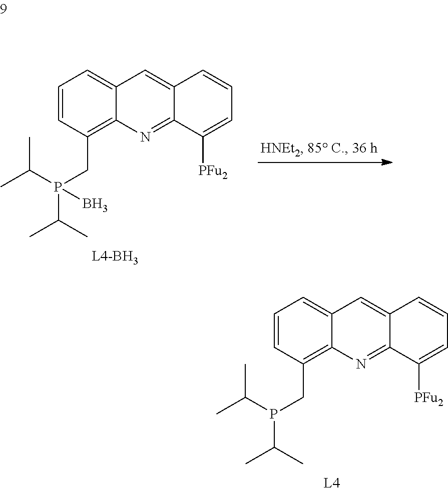

### Synthesis of 9

In a glovebox, L4-BH₃ (58.0 mg, 0.12 mmol) and HNEt₂ (4.0 mL) were added into a 50 mL Schlenk tube equipped with a magnetic stirring bar. The reaction tube was taken out of the glovebox and heated at 85° C. for 36 h, cooled to room temperature and taken back into the glovebox. The solvent was removed under vacuum and the residue was extracted with diethyl ether. The diethyl ether solution was filtered through Celite and then removed under vacuum. The resulting yellow solid was washed with a small amount of methanol to obtain the pure ligand 9 (52.2 mg, 92% yield).

¹H NMR (500 MHz, C₆D₆) δ 8.09 (d, J=6.5 Hz, 1H), 8.02 (s, 1H), 7.66-7.61 (m, 1H), 7.50 (d, J=8.3 Hz, 1H), 7.40 (d, J=8.3 Hz, 1H), 7.24 (s, 2H), 7.21 (t, J=7.7 Hz, 1H), 7.08 (t, J=7.5 Hz, 1H), 6.76 (s, 2H), 6.07 (s, 2H), 3.78 (s, 2H), 1.97 (dt, J=13.8, 6.9 Hz, 2H), 1.16 (d, J=7.1 Hz, 6H), 1.14 (d, J=7.4 Hz, 6H).

¹³C NMR (126 MHz, C₆D₆) δ 152.66 (d, J=11.1 Hz), 148.91 (d, J=17.0 Hz), 147.65, 147.09 (d, J=1.8 Hz), 140.72 (d, J=9.4 Hz), 137.56, 136.57 (d, J=1.5 Hz), 134.43, 130.91, 130.78, 129.20, 128.35, 127.22, 126.30, 126.04, 125.76, 125.64, 121.15, 120.98, 111.09, 111.05, 24.54 (d, J=15.1 Hz), 23.07 (d, J=18.8 Hz), 20.32 (d, J=14.9 Hz), 19.67 (d, J=10.9 Hz).

³¹P NMR (202 MHz, C₆D₆) δ 13.66, −55.32.

HRMS (ESI): Exact mass calculated for C₂₈H₃₀NO₂P₂⁺ ([M+H]⁺): 474.1746, mass found: 474.1745.

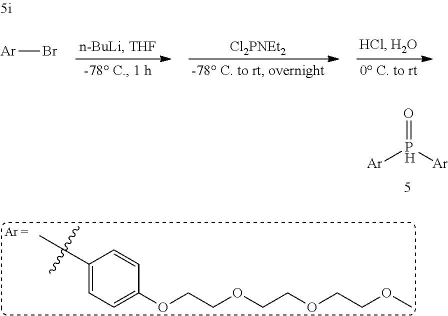

### Synthesis of bis(4-(2-(2-(2-methoxyethoxy)ethoxy)ethoxy)phenyl)phosphine oxide (5i)

1-Bromo-4-(2-(2-(2-methoxyethoxy)ethoxy)ethoxy)benzene⁵ (3.19 g, 10.0 mmol) was added to THF (25 ml) in a 100 ml Schlenk round-bottom flask and cooled to −78° C. n-BuLi (6.25 mL, 10.0 mmol, 1.6 M in hexanes) was added dropwise to the solution over 10 min and the mixture was allowed to stir for 1 hour, before a solution of diethylphosphoramidous dichloride (870.5 mg, 5.0 mmol) in THF (5.0 mL) was added dropwise. The resulting solution was allowed to warm to room temperature overnight. Hydrochloric acid (10 ml, 40.0 mmol, 4 M) was then added slowly at 0° C., the resulting solution was warmed to room temperature and stirred for a further 1 hour.

The mixture was extracted with dichloromethane and the combined organic phase was dried over Na₂SO₄, filtered and concentrated. The crude product was purified by flash chromatography (dichloromethane/MeOH=50:1) to give 5i as a light-yellow oil (1.85 g, 70% yield).

¹H NMR (500 MHz, CDCl₃) δ 7.96 (d, J=477.4 Hz, 1H). 7.53 (dd, J=12.4, 8.4 Hz, 4H), 6.95 (d, J=8.2 Hz, 4H), 4.16-4.08 (m, 4H), 3.85-3.77 (m, 4H), 3.69-3.65 (m, 4H), 3.60 (m, 8H), 3.50-3.46 (m, 4H), 3.31 (s, 6H).

¹³C NMR (126 MHz, CDCl₃) δ 162.13 (d, J=2.6 Hz), 132.59 (d, J=12.9 Hz), 123.12 (d, J=107.8 Hz), 115.01 (d, J=13.9 Hz), 71.89, 70.84, 70.62, 70.54, 69.47, 67.54, 59.00.

³¹P NMR (202 MHz, CDCl₃) δ 21.79.

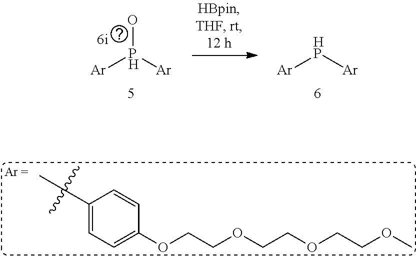

### Synthesis of bis(4-(2-(2-(2-methoxyethoxy)ethoxy)ethoxy)phenyl)phosphane (6i)

This compound was prepared according to a literature procedure.⁶ In a glovebox, 5i (1.85 g, 3.50 mmol) was added to THF (12 ml) a 100 ml round-bottom flask. Pinacolborane (678.3 mg, 5.30 mmol) was then added to the solution and the resulting solution was stirred for 12 hours at room temperature. 4.5 ml of degassed isopropyl alcohol was then added to quench the residual HBPin, after which all the solvent was removed under vacuum. The residue was re-dissolved in MeCN and passed through a plug of alumina. The solvent was then removed under vacuum to afford 6i as a colorless oil (1.63 g, 91%).

¹H NMR (500 MHz, CDCl₃) δ 7.36 (t, J=7.7 Hz, 4H), 6.85 (d, J=8.3 Hz, 4H), 5.16 (d, J=218.6 Hz, 1H), 4.11-4.08 (m, 4H), 3.85-3.81 (m, 4H), 3.73-3.69 (m, 4H), 3.68-3.62 (m, 8H), 3.54-3.51 (m, 4H), 3.36 (s, 6H).

¹³C NMR (126 MHz, CDCl₃) δ 159.38, 135.49 (d, J=18.3 Hz), 126.04 (d, J=7.4 Hz), 114.99 (d, J=7.1 Hz), 72.03, 70.93, 70.76, 70.67, 69.75, 67.43, 59.13.

³¹P NMR (202 MHz, CDCl₃) δ −43.48.

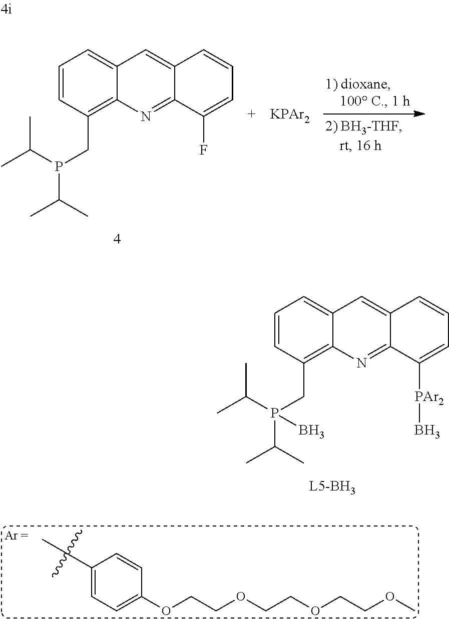

### Synthesis of L5-BH₃

In a glovebox, to a suspension of KH (1.1 equiv.) in anhydrous THF (0.2 M) was added dropwise 6i (1.0 equiv.) at room temperature. Then the reaction mixture was stirred at room temperature for 12 hours, affording a THF solution of potassium bis(4-(2-(2-(2-methoxyethoxy)ethoxy)ethoxy)phenyl)phosphanide (~0.2 M), which was used directly in the next step.

In a glovebox, to a solution of 4-((diisopropylphosphanyl)methyl)-5-fluoroacridine 4i (163.7 mg, 0.50 mmol) in dioxane (5.0 mL) was added dropwise 3.0 mL (~0.60 mmol) of potassium di(furan-2-yl)phosphanide in THF. The reaction tube was taken out of the glovebox and heated at 100° C. for 1 h, and cooled to room temperature. Then, BH₃-THF complex (1.8 mL, 1.8 mmol, 1M) was added and the mixture was stirred for 16 h at room temperature under nitrogen protected condition. The resulting solution was concentrated in vacuo. The crude product was purified by flash chromatography (hexane/acetone=4:1 to 3:1) to give L5-BH₃ as a yellow solid (267.0 mg, 63% yield).

¹H NMR (500 MHz, CDCl₃) δ 8.79 (s, 1H), 8.27 (d, J=6.9 Hz, 1H), 8.14 (d, J=8.3 Hz, 1H), 7.85 (d, J=8.4 Hz, 1H), 7.53-7.46 (m, 5H), 7.43 (t, J=7.6 Hz, 1H), 7.32 (dd, J=12.8, 6.9 Hz, 1H), 6.92 (d, J=8.3 Hz, 4H), 4.12 (t, J=4.5 Hz, 4H), 3.85 (t, J=4.5 Hz, 4H), 3.75-3.70 (m, 6H), 3.68-3.65 (m, 4H), 3.65-3.62 (m, 4H), 3.55-3.52 (m, 4H), 3.36 (s, 6H), 1.83-1.74 (m, 2H), 1.72-1.36 (broad, 3H, BH₃), 1.00 (dd, J=14.4, 7.0 Hz, 6H), 0.84 (dd, J=13.7, 7.0 Hz, 6H), 0.76-0.28 (broad, 3H, BH₃).

¹³C NMR (126 MHz, CDCl₃) δ 161.00 (d, J=1.5 Hz), 147.84 (d, J=6.9 Hz), 147.19 (d, J=5.2 Hz), 138.71 (d, J=5.3 Hz), 137.34 (s), 133.77 (d, J=1.7 Hz), 132.47 (s), 130.48 (s), 130.02 (s), 126.96 (s), 126.62 (s), 126.30 (s), 122.07 (s), 121.56 (s), 72.04 (s), 70.98 (s), 70.78 (s), 70.71 (s), 69.64 (s), 67.54 (s), 59.17 (s), 22.89 (d, J=33.4 Hz), 19.85 (d, J=31.1 Hz), 17.46 (s), 17.37 (s).

³¹P NMR (202 MHz, CDCl₃) δ 37.62-36.40 (broad), 20.10-19.28 (broad).

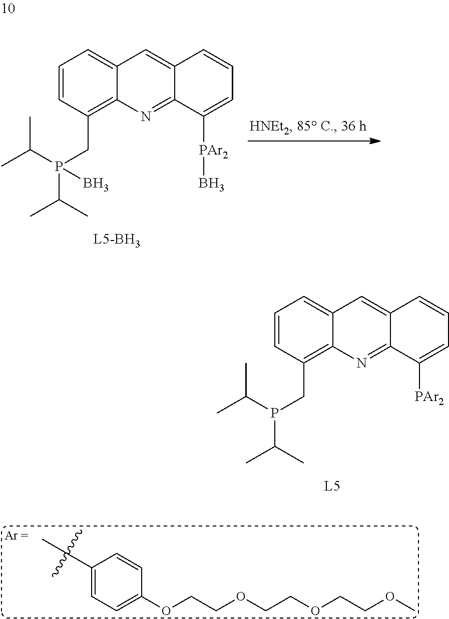

### Synthesis of 10

In a glovebox, L5-BH₃ (253.6 mg, 0.30 mmol) and HNEt₂ (6.0 mL) were added into a 100 mL Schlenk tube equipped with a magnetic stirring bar. The reaction tube was taken out of the glovebox and heated at 85° C. for 36 h, cooled to room temperature and taken back into the glovebox. The solvent was removed under vacuum and the residue was extracted with toluene.

The toluene solution was filtered through Celite and then removed under vacuum. The resulting yellow solid was washed with a small amount of methanol to obtain the pure ligand 10 (230.8 mg, 94% yield).

¹H NMR (300 MHz, CDCl₃) δ 8.70 (s, 1H), 7.95 (d, J=8.4 Hz, 2H), 7.77 (d, J=8.2 Hz, 1H), 7.48-7.35 (m, 2H), 7.26 (dd, J=8.6, 7.3 Hz, 4H), 7.11 (ddd, J=6.8, 3.8, 1.2 Hz, 1H), 6.86 (d, J=8.1 Hz, 4H), 4.14-4.08 (m, 4H), 3.88-3.82 (m, 4H), 3.76-3.71 (m, 4H), 3.70-3.63 (m, 8H), 3.57-3.51 (m, 4H), 3.40 (d, J=3.4 Hz, 2H), 3.37 (s, 6H), 1.72-1.58 (m, 2H), 1.03 (dd, J=13.6, 7.1 Hz, 6H), 0.84 (dd, J=11.2, 7.0 Hz, 6H).

¹³C NMR (75 MHz, CDCl₃) δ 159.22, 148.73 (d, J=16.0 Hz), 147.07 (dd, J=3.1, 1.8 Hz), 140.31 (d, J=12.3 Hz), 140.04 (d, J=9.5 Hz), 136.27 (d, J=1.3 Hz), 135.74, 135.45, 134.65, 130.32, 130.10, 129.43, 129.32, 128.52, 126.77, 125.96 (d, J=1.3 Hz), 125.79, 125.70, 125.27 (d, J=1.8 Hz), 114.70, 114.59, 71.96, 70.86, 70.69, 70.61, 69.71, 67.26, 59.06, 24.05 (d, J=12.6 Hz), 22.13 (d, J=16.4 Hz), 20.00 (d, J=14.6 Hz), 19.35 (d, J=9.9 Hz).

³¹P NMR (121 MHz, CDCl₃) δ 13.82, −14.75.

HRMS (ESI): Exact mass calculated for C₄₆H₆₂NO₈P₂⁺ ([M+H]⁺): 818.3945, mass found: 818.3976.

### Example 2

### Synthesis of Compounds (Complexes) 1-5

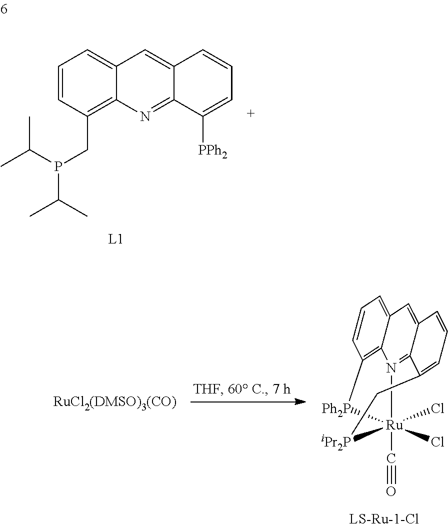

### Synthesis of LS-Ru-1-Cl

In a glovebox, 6 (118.5 mg, 0.24 mmol) and RuCl₂(CO)(DMSO)₃ (Evans, I. P.; Spencer, A.; Wilkinson, G. Dichlorotetrakis-(dimethyl sulfoxide)ruthenium(II) and its Use as a Source Material for Some New Ruthenium(II) Complexes. J. Chem. Soc., Dalton Trans. 1973, 204, 204-209; and Alessio, E.; Milani, B.; Bolle, M.; Mestroni, G.; Faleschini, P.; Todone, F.; Geremia, S.; Calligaris, M. Carbonyl Derivatives of Chloride-Dimethyl Sulfoxide-Ruthenium (II) Complexes: Synthesis, Structural Characterization, and Reactivity of Ru(CO)ₓ(DMSO)₄₋ₓCl₂ Complexes (x=1-3). Inorg. Chem. 1995, 34, 4722-4734.) (86.9 mg, 0.20 mmol) were suspended in tetrahydrofuran (8.0 mL) in an oven-dried 100 mL Schlenk flask equipped with a magnetic stirring bar. The flask was sealed and taken out of the glovebox, and stirred at 60° C. for 7 hours. After cooling the reaction mixture to room temperature, the Schlenk flask was taken into the glovebox again and the solvent was removed under vacuum. The resulting orange solid was washed with ether for several times and dried under vacuum to give the desired product LS-Ru-1-Cl as an orange solid (128.2 mg, 92% yield). Crystals suitable for X-ray analysis were obtained by slow evaporation of the dichloromethane solution of LS-Ru-1-Cl.

³¹P NMR (202 MHz, CD₂Cl₂) δ 57.24 (d, J=22.9 Hz), 56.43 (d, J=22.0 Hz).

¹H NMR (500 MHz, CD₂Cl₂) δ 9.03 (s, 1H, aryl), 8.27-8.20 (m, 2H, aryl), 8.18 (d, J=8.3 Hz, 1H, aryl), 8.08 (dd, J=10.1, 6.7 Hz, 1H, aryl), 8.02 (d, J=8.3 Hz, 1H, aryl), 7.84 (d, J=6.9 Hz, 1H, aryl), 7.63 (t, J=7.6 Hz, 1H, aryl), 7.58 (t, J=7.7 Hz, 1H, aryl), 7.55-7.51 (m, 1H, aryl), 7.51-7.46 (m, 2H, aryl), 7.43-7.37 (m, 1H, aryl), 7.36-7.25 (m, 4H, aryl), 4.67 (dd, J=16.5, 11.7 Hz, 1H, CH₂P), 2.85 (dd, J=16.6, 11.8 Hz, 1H, CH₂P), 2.53-2.43 (m, 1H, PCH(CH₃)₂), 1.64 (dd, J=15.6, 7.1 Hz, 3H, PCH(CH₃)₂), 1.30 (dd, J=16.3, 7.1 Hz, 3H, PCH(CH₃)₂), 0.76 (dd, J=12.2, 7.0 Hz, 3H, PCH(CH₃)₂), 0.53-0.44 (m, 1H, PCH(CH₃)₂), −0.28 (dd, J=14.7, 7.0 Hz, 3H, PCH(CH₃)₂).

¹³C NMR (126 MHz, CD₂Cl₂) δ 142.45 (s, Ar), 138.41 (s, Ar), 138.05 (s, Ar), 137.86 (d, J=1.3 Hz, Ar), 137.42 (d, J=10.3 Hz, Ar), 135.77 (d, J=11.3 Hz, Ar), 135.60 (s, Ar), 134.89 (s, Ar), 132.81-132.64 (m, Ar), 131.80 (d, J=2.1 Hz, Ar), 131.55 (d, J=2.5 Hz, Ar), 130.81 (d, J=2.3 Hz, Ar), 130.71 (s, Ar), 129.04 (s, Ar), 128.80 (d, J=10.1 Hz, Ar), 128.44 (d, J=7.4 Hz, Ar), 128.33 (s, Ar), 126.77 (d, J=1.0 Hz, Ar), 125.86 (d, J=7.1 Hz, Ar), 28.13 (d, J=29.4 Hz, PCH(CH₃)₂), 24.81 (d, J=24.7 Hz, PCH(CH₃)₂), 24.55 (d, J=28.2 Hz, CH₂P), 19.09 (s PCH(CH₃)₂), 18.36 (d, J=1.7 Hz PCH(CH₃)₂), 17.79 (d, J=6.1 Hz PCH(CH₃)₂).

IR (KBr)=1962 cm⁻¹ (CO).

HRMS (ESI): Exact mass calculated for C₃₃H₃₂NOP₂Ru⁺ ([M−2Cl−H]⁺): 622.0997, mass found: 622.1017.

The diffraction data from single crystals of LS-Ru-1-Cl were at 100 K on a Rigaku Synergy-S diffractometer dual source equipped with Dectris Pilatus3 R CdTe 300K detector, MoKα (λ=0.71073 Å). All datasets were processed with CrysAlisPRO and structures were solved with SHELXT. All non-hydrogen atoms were further refined by SHELXL with anisotropic displacement coefficients. Hydrogens were placed in calculated positions and refined in a riding mode. Hydride atoms were located in the electron density map, incorporated and refined. Refinement was carried out with the OLEX-2 GUI. Crystallographic data and refinement parameters are summarized in FIG. 2 and Table S1.

TABLE S1
Crystallographic data for complex LS-Ru-1-Cl

| | |
|---|---|
| CCDC No. | 2382562 |
| Formula | C₃₃H₃₃Cl₂NOP₂Ru + 2CH₂Cl₂ |
| Molecular weight | 863.36 |
| Crystal system | Triclinic |
| Space group | P1̅ |
| Crystal size (mm) | 0.415 × 0.268 × 0.078 |
| Crystal color and shape | Yellow Chunk |
| Temperature (K) | 100 |
| Wavelength (Å) | 0.71073 |
| a (Å) | 12.1470(4) |
| b (Å) | 12.1541(4) |
| c (Å) | 14.7138(4) |
| α (°) | 102.276(3) |
| β (°) | 97.576(2) |
| γ (°) | 116.988(3) |
| Volume (Å³) | 1825.27(11) |
| Z | 2 |
| r_{calcd} (g · cm⁻¹) | 1.571 |
| μ (mm⁻¹) | 0.987 |
| No. of reflections (unique) | 32320 (7440) |
| Rᵢₙₜ | 0.0398 |
| Completeness to θ (%) | 99.8 |
| θ max | 26.372 |
| Data/restraints/parameters | 7440/5/432 |
| Goodness-of-fit on F² | 1.056 |
| Final R₁ and wR₂ indices [I > 2 s(I)] | 0.0390, 0.0971 |
| R₁ and wR₂ indices (all data) | 0.0460, 0.1005 |
| Highest diff Peak and Deepest hole | 1.252, −0.799 |

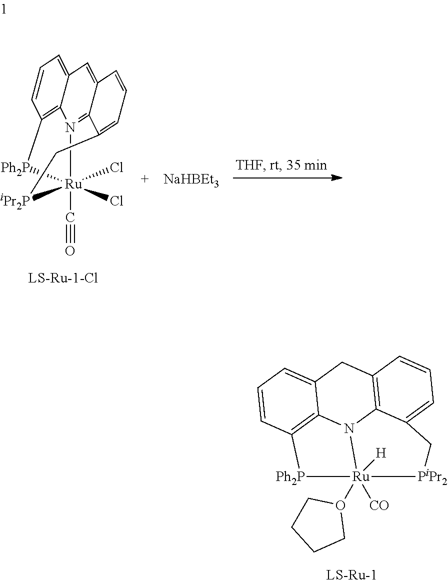

### Synthesis of 1

A THF solution of NaBEt₃H was prepared by adding 200 μl of 1.0 M NaBEt₃H (0.20 mmol) in THF to 1.8 mL of THF. The afforded solution was added to a stirring suspension of 69.3 mg (0.10 mmol) of LS-Ru-1-Cl in 8.0 mL of THF. The resulting mixture was stirred at room temperature for 35 minutes, before passed through a 0.2 m PTFE filter. The solvent was then removed under vacuum. The residue was washed twice with 2 mL of n-pentane to remove a dark impurity, and the remaining solid was dried under vacuum, affording 1 as a yellow solid (66.7 mg; 96% yield).

³¹P NMR (202 MHz, THF-d₈) δ 60.38 (d, J=255.0 Hz), 50.70 (d, J=257.8 Hz).

¹H NMR (500 MHz, THF-d₈) δ 8.01-7.94 (m, 2H, aryl), 7.39-7.29 (m, 8H, aryl), 7.00 (t, J=8.5 Hz, 1H, aryl), 6.89 (d, J=6.7 Hz, 1H, aryl), 6.86-6.81 (m, 2H, aryl), 6.57 (t, J=7.2 Hz, 1H, aryl), 6.51 (t, J=7.2 Hz, 2H, aryl), 3.80-3.70 (m, 2H, ArCH₂Ar), 3.63-3.59 (m, 4H, CH₂CH₂OCH₂CH₂), 3.26 (dd, J=12.9, 5.0 Hz, 1H, CH₂P), 2.95 (td, J=12.8, 4.6 Hz, 1H, CH₂P), 2.46-2.37 (m, 1H, PCH(CH₃)₂), 1.98-1.88 (m, 1H, PCH(CH₃)₂), 1.78-1.75 (m, 4H, CH₂CH₂OCH₂CH₂), 1.40 (dd, J=14.9, 7.0 Hz, 3H, PCH(CH₃)₂), 1.32 (dd, J=13.8, 6.9 Hz, 3H, PCH(CH₃)₂), 1.16 (dd, J=14.1, 7.7 Hz, 3H, PCH(CH₃)₂), 1.12 (dd, J=12.0, 7.7 Hz, 3H, PCH(CH₃)₂), −18.80 (t, J=20.5 Hz, 1H, Ru-H).

¹³C NMR (126 MHz, THF-d₈) δ 207.15 (s, Ru-CO), 165.86 (dd, J=28.4, 2.8 Hz, Ar), 148.79 (d, J=5.2 Hz, Ar), 138.63 (d, J=36.6 Hz, Ar), 137.08 (d, J=49.7 Hz, Ar), 134.72 (s, Ar), 134.62 (s, Ar), 132.96 (s, Ar), 132.88 (s, Ar), 131.21 (s, Ar), 130.80 (d, J=6.2 Hz, Ar), 130.26 (d, J=2.1 Hz, Ar), 129.50 (d, J=1.7 Hz, Ar), 129.22 (s, Ar), 128.72 (s, Ar), 128.65 (s, Ar), 128.61 (s, Ar), 128.53 (s, Ar), 127.41 (s, Ar), 126.40 (s, Ar), 123.64 (s, Ar), 122.23 (d, J=13.5 Hz, Ar), 118.10 (s, Ar), 117.67 (d, J=6.7 Hz, Ar), 112.74 (d, J=41.3 Hz, Ar), 68.03 (s, CH₂CH₂OCH₂CH₂), 35.84 (s, ArCH₂Ar), 32.21 (d, J=22.5 Hz, CH₂P), 26.77 (d, J=25.9 Hz, PCH(CH₃)₂), 26.18 (s, CH₂CH₂OCH₂CH₂), 25.11 (d, J=11.2 Hz, PCH(CH₃)₂), 19.68 (s, PCH(CH₃)₂), 19.44 (d, J=2.0 Hz, PCH(CH₃)₂), 19.16 (d, J=3.8 Hz, PCH(CH₃)₂), 17.32 (s, PCH(CH₃)₂).

IR (KBr)=1937 cm⁻¹ (CO).

HRMS (ESI): Exact mass calculated for C₃₃H₃₂NOP₂Ru+([M-TF-3H]): 622.0997, mass found: 622.1028.

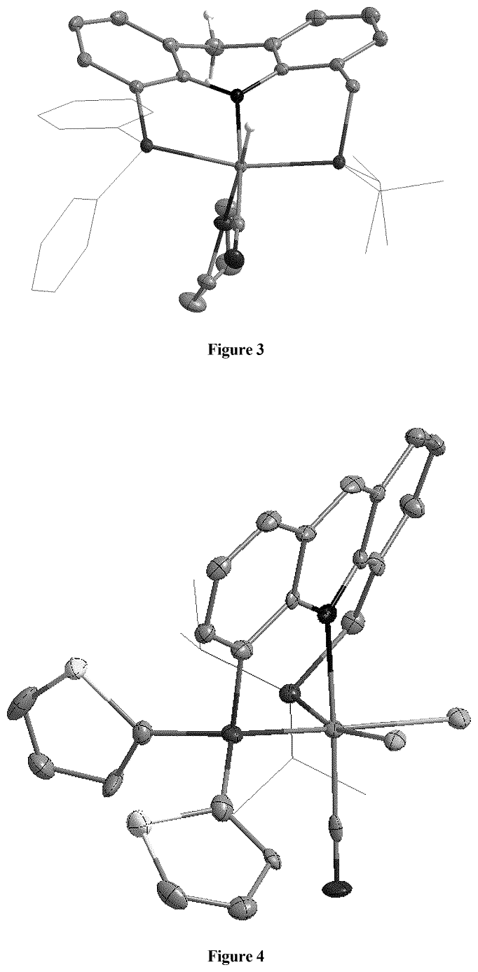

The diffraction data from single crystals of 1 were at 100 K on a Rigaku Synergy-S diffractometer dual source equipped with Dectris Pilatus3 R CdTe 300K detector, MoKα (λ=0.71073 Å). All datasets were processed with CrysAlisPRO and structures were solved with SHIELXT. All non-hydrogen atoms were further refined by SHIELXL with anisotropic displacement coefficients. Hydrogens were placed in calculated positions and refined in a riding mode. Hydride atoms were located in the electron density map, incorporated and refined. Refinement was carried out with the OLEX-2 GUI. Crystallographic data and refinement parameters are summarized in FIG. 3 and Table S2.

TABLE S2
Crystallographic data for complex 1

| | |
|---|---|
| CCDC No. | 2382564 |
| Formula | 2C₃₇H₄₃NO₂P₂Ru + C₄H₈O |
| Molecular weight | 1465.57 |
| Crystal system | Monoclinic |
| Space group | P2₁/c |
| Crystal size (mm) | 0.219 × 0.090 × 0.070 |
| Crystal color and shape | Yellow prism |
| Temperature (K) | 100 |
| Wavelength (Å) | 0.71073 |
| a (Å) | 12.54529(17) |
| b (Å) | 29.8644(4) |
| c (Å) | 18.5709(3) |
| α (°) | 90 |
| β (°) | 91.1248(13) |
| γ (°) | 90 |
| Volume (Å³) | 6956.37(17) |
| Z | 4 |
| r_{calcd} (g · cm⁻¹) | 1.399 |
| μ (mm⁻¹) | 0.579 |
| No. of reflections (unique) | 294958 (15950) |
| Rᵢₙₜ | 0.0553 |
| Completeness to θ (%) | 100.0 |
| θ max | 27.484 |
| Data/restraints/parameters | 15950/0/841 |
| Goodness-of-fit on F² | 1.054 |
| Final R₁ and wR₂ indices [I > 2 s(I)] | 0.0310, 0.0720 |
| R₁ and wR₂ indices (all data) | 0.0354, 0.0735 |
| Highest diff Peak and Deepest hole | 0.861, −0.473 |

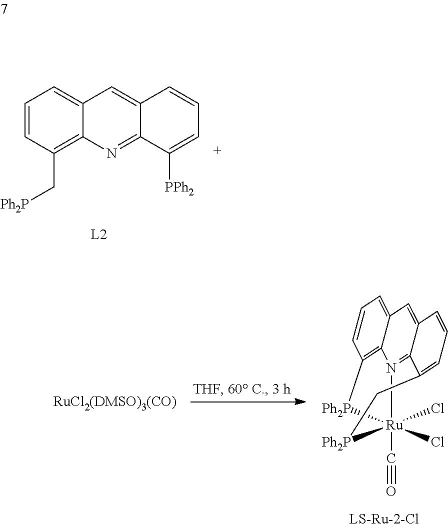

### Synthesis of LS-Ru-2-Cl

In a glovebox, 7 (24.7 mg, 0.044 mmol) and RuCl₂(CO)(DMSO)₃ (17.4 mg, 0.04 mmol) were suspended in tetrahydrofuran (2.0 mL) in an oven-dried 15 mL sealed tube equipped with a magnetic stirring bar. The tube was sealed and taken out of the glovebox, and stirred at 60° C. for 3 hours. After cooling the reaction mixture to room temperature, the sealed tube was taken into the glovebox again and the solvent was removed under vacuum. The resulting orange solid was washed with ether for several times and dried under vacuum to give the desired product LS-Ru-2-Cl as an orange solid (27.4 mg, 90% yield).

³¹P NMR (202 MHz, CD₂Cl₂) δ 56.33 (d, J=21.5 Hz), 48.02 (d, J=21.5 Hz).

¹H NMR (500 MHz, CD₂Cl₂) δ 9.06 (s, 1H, aryl), 8.17-8.08 (m, 4H, aryl), 7.95-7.88 (m, 3H, aryl), 7.76 (dd, J=9.9, 6.9 Hz, 1H, aryl), 7.59 (t, J=7.6 Hz, 2H, aryl), 7.55-7.46 (m, 6H, aryl), 7.02-6.96 (m, 2H, aryl), 6.72 (t, J=7.0 Hz, 4H, aryl), 6.69-6.62 (m, 4H, aryl), 4.96 (vt, J=14.6 Hz, 1H, CH₂P), 3.27 (vt, J=12.8 Hz, 1H, CH₂P).

¹³C NMR (126 MHz, CD₂Cl₂) δ 203.58 (t, J=13.5 Hz, Ru-CO), 156.53 (d, J=16.1 Hz, Ar), 150.92 (s, Ar), 142.66 (s, Ar), 137.54 (s, Ar), 137.10 (d, J=10.4 Hz, Ar), 136.39 (s, Ar), 135.67 (d, J=11.4 Hz, Ar), 135.24 (d, J=4.2 Hz, Ar), 134.90 (s, Ar), 134.79 (s, Ar), 134.36 (s, Ar), 133.98 (s, Ar), 133.59 (s, Ar), 132.89 (d, J=9.4 Hz, Ar), 131.86 (d, J=2.0 Hz, Ar), 131.64 (d, J=9.9 Hz, Ar), 131.18 (s, Ar), 130.59 (d, J=2.0 Hz, Ar), 130.49 (d, J=9.2 Hz, Ar), 129.97 (d, J=1.6 Hz, Ar), 129.70 (d, J=1.9 Hz, Ar), 129.30 (s, Ar), 128.98 (s, Ar), 128.89 (d, J=2.5 Hz, Ar), 128.69 (d, J=1.3 Hz, Ar), 128.61 (s, Ar), 128.53 (s, Ar), 127.02 (s, Ar), 126.91 (d, J=7.6 Hz, Ar), 126.12 (d, J=7.3 Hz, Ar), 33.27 (d, J=33.0 Hz, CH₂P).

IR (KBr)=1958 cm¹ (CO).

HRMS (ESI): Exact mass calculated for C₃₉H₂₈NOP₂Ru⁺ ([M−2Cl−H]⁺): 690.0684, mass found: 690.0703

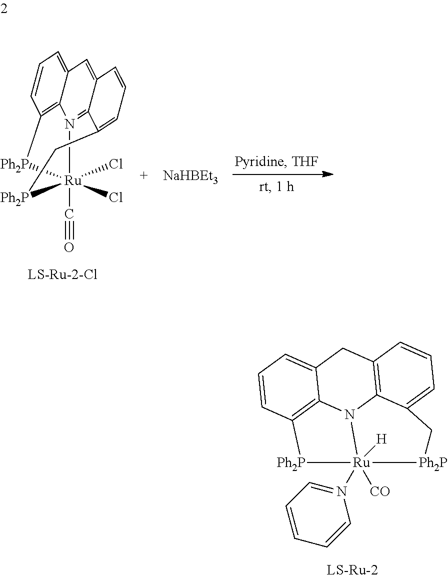

### Synthesis of 2

A THF solution of NaBEt₃H was prepared by adding 42 μl of 1.0 M NaBEt₃H (0.042 mmol) in THF to 0.4 mL of THF. The afforded solution was added to a stirring suspension of LS-Ru-2-Cl (16.0 mg, 0.021 mmol) and pyridine (3.3 mg, 0.042 mmol) in 2.5 mL of THF. The resulting mixture was stirred at room temperature for 1 hour. The solvent was then removed under vacuum. The residue was redissolved in a mixture of THF (4.0 mL) and diethyl ether (2.0 mL), before passed through a 0.2 m PTFE filter. The solvent was then removed under vacuum and the residue was washed twice with 1.0 mL of n-pentane to remove a dark impurity. The remaining solid was dried under vacuum, affording 2 as a yellow solid (15.1 mg; 93% yield).

³¹P NMR (121 MHz, THF-d₈) δ 56.87 (d, J=255.3 Hz), 45.21 (d, J=255.2 Hz).

¹H NMR (400 MHz, THF-d₈) δ 8.27-8.17 (m, 2H, aryl), 7.90 (d, J=5.1 Hz, 2H, aryl), 7.71-7.64 (m, 2H, aryl), 7.48-7.41 (m, 3H, aryl), 7.38-7.31 (m, 3H, aryl), 7.28 (t, J=7.4 Hz, 1H, aryl), 7.20-7.12 (m, 3H, aryl), 7.12-7.01 (m, 3H, aryl), 6.99-6.92 (m, 4H, aryl), 6.91-6.81 (m, 4H, aryl), 6.63-6.57 (m, 2H, aryl), 6.54-6.47 (m, 2H, aryl), 3.90 (dd, J=13.6, 6.7 Hz, 1H, CH₂P), 3.82-3.71 (m, 3H, CH₂P, ArCH₂Ar), −13.25 (t, J=20.3 Hz, 1H, Ru-H).

¹³C NMR (126 MHz, THF-d₈) δ 206.68 (t, J=13.8 Hz, Ru-CO), 164.94 (dd, J=27.1, 2.0 Hz, Ar), 153.38 (s, Ar), 148.75 (d, J=5.6 Hz, Ar), 140.01 (d, J=45.5 Hz, Ar), 137.42 (d, J=40.7 Hz, Ar), 136.73 (d, J=51.3 Hz, Ar), 136.00 (s, Ar), 135.36 (s, Ar), 135.26 (s, Ar), 134.23 (s, Ar), 134.15 (s, Ar), 133.34 (d, J=4.1 Hz, Ar), 133.10 (s, Ar), 133.02 (s, Ar), 132.51 (s, Ar), 132.45 (s, Ar), 132.33 (s, Ar), 132.25 (s, Ar), 131.17 (s, Ar), 130.61 (s, Ar), 129.88 (d, J=1.2 Hz, Ar), 129.78 (s, Ar), 129.31 (s, Ar), 128.89 (s, Ar), 128.82 (s, Ar), 128.54 (s, Ar), 128.47 (s, Ar), 127.91 (s, Ar), 126.72 (s, Ar), 124.62 (s, Ar), 122.83 (d, J=13.6 Hz, Ar), 122.67 (s, Ar), 118.38 (s, Ar), 117.99 (d, J=6.7 Hz, Ar), 113.19 (d, J=41.6 Hz, Ar), 38.44 (d, J=27.0 Hz, CH₂P), 36.33 (s, ArCH₂Ar).

IR (KBr)=1914 cm¹ (CO).

HRMS (ESI): Exact mass calculated for C₃₉H₂₈NOP₂Ru⁺ ([M−Pyridine−3H]⁺): 690.0684, mass found: 690.0715.

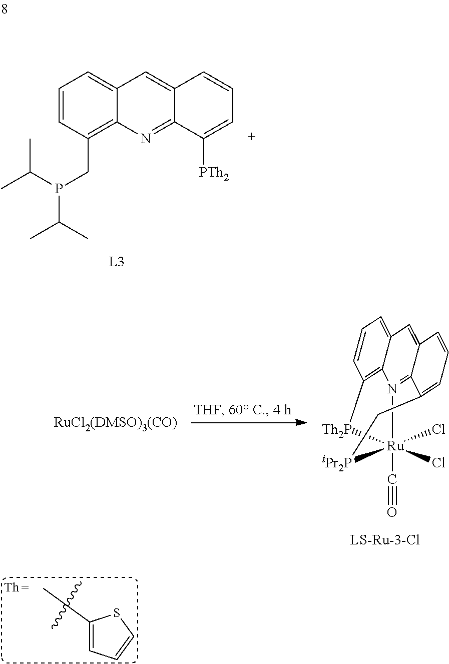

### Synthesis of LS-Ru-3-Cl

In a glovebox, 8 (80.9 mg, 0.16 mmol) and RuCl₂(CO)(DMSO)₃ (56.5 mg, 0.13 mmol) were suspended in tetrahydrofuran (6.0 mL) in an oven-dried 100 mL Schlenk flask equipped with a magnetic stirring bar. The flask was sealed and taken out of the glovebox, and stirred at 60° C. for 4 hours. After cooling the reaction mixture to room temperature, the Schlenk flask was taken into the glovebox again and the solvent was removed under vacuum. The resulting orange solid was washed with ether for several times and dried under vacuum to give the desired product LS-Ru-3-Cl as an orange solid (88.0 mg, 96% yield). Crystals suitable for X-ray analysis were obtained from a dichloromethane/THF solution of LS-Ru-3-Cl at −40° C.

³¹P NMR (202 MHz, CD₂Cl₂) δ 57.03 (d, J=24.7 Hz), 38.30 (d, J=24.7 Hz).

¹H NMR (500 MHz, CD₂Cl₂) δ 9.04 (s, 1H, aryl), 8.21-8.13 (m, 3H, aryl), 8.03 (d, J=8.3 Hz, 1H, aryl), 7.86 (d, J=6.9 Hz, 1H, aryl), 7.82 (t, J=3.8 Hz, 1H, aryl), 7.72-7.68 (m, 1H, aryl), 7.65 (t, J=7.6 Hz, 1H, aryl), 7.58 (t, J=7.7 Hz, 1H, aryl), 7.26-7.22 (m, 1H, aryl), 7.21-7.16 (m, 1H, aryl), 7.11 (t, J=4.0 Hz, 1H, aryl), 4.70 (dd, J=16.6, 11.7 Hz, 1H, CH₂P), 2.92 (dd, J=16.6, 12.0 Hz, 1H, CH₂P), 2.62-2.48 (m, 1H, PCH(CH₃)₂), 1.66 (dd, J=15.8, 7.1 Hz, 3H, PCH(CH₃)₂), 1.39 (dd, J=16.4, 7.1 Hz, 3H, PCH(CH₃)₂), 1.08-0.99 (m, 1H, PCH(CH₃)₂), 0.90 (dd, J=12.2, 6.9 Hz, 3H, PCH(CH₃)₂), −0.22 (dd, J=14.9, 7.0 Hz, 3H, PCH(CH₃)₂).

¹³C NMR (126 MHz, CD₂Cl₂) δ 154.66 (s, Ar), 154.50 (s, Ar), 149.57 (s, Ar), 142.09 (s, Ar), 141.16 (d, J=11.4 Hz, Ar), 137.28 (s, Ar), 136.19 (d, J=9.3 Hz, Ar), 135.51 (d, J=11.1 Hz, Ar), 135.03 (s, Ar), 132.97 (s, Ar), 131.69 (s, Ar), 128.73 (s, Ar), 128.19 (s, Ar), 127.93 (s, Ar), 127.85 (s, Ar), 127.76 (s, Ar), 126.35 (s, Ar), 125.50 (d, J=7.9 Hz, Ar), 27.76 (d, J=29.3 Hz, PCH(CH₃)₂), 25.06 (d, J=24.8 Hz, PCH(CH₃)₂), 23.99 (d, J=28.6 Hz, CH₂P), 18.71 (s, PCH(CH₃)₂), 18.49 (s, PCH(CH₃)₂), 18.09 (s, PCH(CH₃)₂), 17.50 (d, J=6.4 Hz, PCH(CH₃)₂).

IR (KBr)=1961 cm⁻¹ (CO).

RMS (ESI): Exact mass calculated for C₂₉H₂₉NOP₂S2Ru⁺ ([M−2Cl−H]): 634.0126, mass found: 634.0149; C₂₉H₂₉NOP₂S2ClRu+([M-Cl]⁺): 669.9892, mass found: 669.9918.

The diffraction data from single crystals of LS-Ru-3-Cl were at 100 K on Rigaku Xtalab Pro dual source equippedPilatus 200K detectoriMoKcl (=0.71073 Å). All datasetswere processed with CrysAlisPRO and structures were solved with SHIELXT⁹. All non-hydrogen atoms were further refined by STIELXL¹⁰ with anisotropic displacement coefficients. Hydrogens were placed in calculated positions and refined in a riding mode. Hydride atoms were located in the electron density map, incorporated and refined. Refinement was carried out with the OLEX-2¹¹ GUI. Crystallographic data and refinement parameters are summarized in Table S3 and FIG. 4.

TABLE S3
Crystallographic data for complex LS-Ru-3-Cl

| | |
|---|---|
| CCDC No. | 2382560 |
| Formula | C₂₉H₂₉Cl₂NOP₂RuS₂ + CH₂Cl₂ |
| Molecular weight | 790.49 |
| Crystal system | Triclinic |
| Space group | P1̅ |
| Crystal size (mm) | 0.123 × 0.044 × 0.031 |
| Crystal color and shape | Yellow prism |
| Temperature (K) | 100 |
| Wavelength (Å) | 0.71073 |
| a (Å) | 10.7807(7) |
| b (Å) | 11.5170(10) |
| c (Å) | 15.2302(9) |
| α (°) | 86.011(6) |
| β (°) | 75.374(5) |
| γ (°) | 63.999(8) |
| Volume (Å³) | 1642.7(2) |
| Z | 2 |
| r_{calcd} (g · cm⁻¹) | 1.598 |
| μ (mm⁻¹) | 1.053 |
| No. of reflections (unique) | 17282 (5968) |
| Rᵢₙₜ | 0.0943 |
| Completeness to θ (%) | 99.3 |
| θ max | 25.348 |
| Data/restraints/parameters | 5968/0/393 |
| Goodness-of-fit on F² | 1.019 |
| Final R₁ and wR₂ indices [I > 2 s(I)] | 0.0580, 0.1238 |
| R₁ and wR₂ indices (all data) | 0.1106, 0.1462 |
| Highest diff Peak and Deepest hole | 0.944, −0.831 |

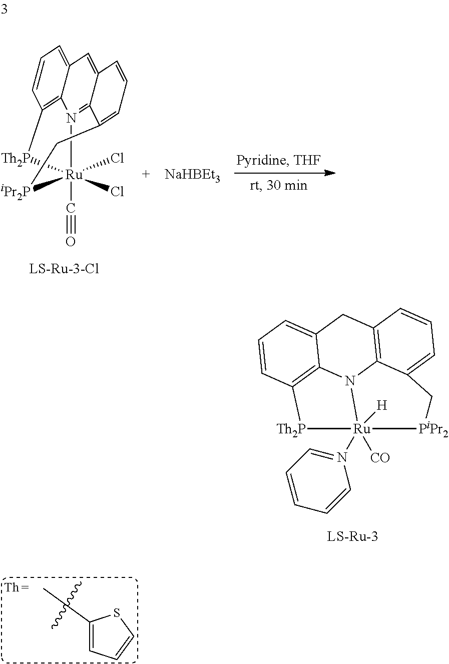

A THF solution of NaBEt₃H was prepared by adding 200 μl of 1.0 M NaBEt₃H (0.20 mmol) in THF to 1.8 mL of THF. The afforded solution was added to a stirring suspension of LS-Ru-3-Cl (70.5 mg, 0.10 mmol) and pyridine (15.8 mg, 0.20 mmol) in 8.0 mL of THF. The resulting mixture was stirred at room temperature for 30 minutes. The solvent was then removed under vacuum. The residue was redissolved in 10 mL diethyl ether, before passed through a 0.2 m PTFE filter. Diethyl ether was then removed under vacuum and the residue was washed twice with 2 mL of n-pentane to remove a dark impurity. The remaining solid was dried under vacuum, affording 3 as a yellow solid (64.1 mg; 91% yield).

³¹P NMR (202 MHz, THF-d₈) δ 58.42 (d, J=261.2 Hz), 34.60 (d, J=261.1 Hz).

¹H NMR (500 MHz, THF-d₈) δ 8.30 (d, J=5.0 Hz, 2H, aryl), 7.78 (dd, J=6.7, 3.4 Hz, 1H, aryl), 7.76-7.73 (m, 1H, aryl), 7.41 (t, J=7.4 Hz, 1H, aryl), 7.38-7.33 (m, 1H, aryl), 7.26-7.21 (m, 1H, aryl), 7.17 (t, J=4.1 Hz, 1H, aryl), 6.91 (d, J=7.1 Hz, 1H, aryl), 6.87-6.82 (m, 4H, aryl), 6.82-6.79 (m, 1H, aryl), 6.65-6.60 (m, 1H, aryl), 6.57-6.50 (m, 2H, aryl), 3.91 (d, J=16.8 Hz, 1H, ArCH₂Ar), 3.80 (d, J=16.9 Hz, 1H, ArCH₂Ar), 3.44-3.40 (m, 1H, CH₂P), 2.97 (td, J=12.9, 5.0 Hz, 1H, CH₂P), 2.51-2.41 (m, 1H, PCH(CH₃)₂), 1.84-1.75 (m, 1H, PCH(CH₃)₂), 1.44-1.37 (m, 6H, PCH(CH₃)₂), 1.01 (dd, J=10.6, 7.2 Hz, 3H, PCH(CH₃)₂), 0.59 (dd, J=14.3, 7.4 Hz, 3H, PCH(CH₃)₂), −13.87 (dd, J=22.9, 19.7 Hz, 1H, Ru-H).

¹³C NMR (126 MHz, THF-d₈) δ 207.45 (t, J=13.8 Hz, Ru-CO), 164.59 (d, J=30.8 Hz, Ar), 153.07 (s, Ar), 148.44 (d, J=4.7 Hz, Ar), 141.13 (d, J=53.1 Hz, Ar), 139.41 (d, J=40.7 Hz, Ar), 136.76 (d, J=9.9 Hz, Ar), 136.36 (s, Ar), 133.77 (d, J=9.0 Hz, Ar), 133.41 (d, J=3.4 Hz, Ar), 131.21 (d, J=6.3 Hz, Ar), 131.07 (s, Ar), 130.72 (s, Ar), 129.70 (s, Ar), 128.63 (d, J=10.9 Hz, Ar), 127.92 (d, J=10.0 Hz, Ar), 127.63 (s, Ar), 127.11 (s, Ar), 124.98 (s, Ar), 123.77 (s, Ar), 122.61 (d, J=14.6 Hz, Ar), 118.51 (s, Ar), 117.78 (d, J=7.1 Hz, Ar), 114.50 (d, J=44.6 Hz, Ar), 36.06 (d, J=1.7 Hz, ArCH₂Ar), 33.69 (d, J=23.6 Hz, CH₂P), 27.03 (d, J=25.6 Hz, PCH(CH₃)₂), 24.53 (dd, J=11.4, 4.9 Hz, PCH(CH₃)₂), 20.06 (s, PCH(CH₃)₂), 19.77 (d, J=2.9 Hz, PCH(CH₃)₂), 19.08 (d, J=5.3 Hz, PCH(CH₃)₂), 17.00 (d, J=2.1 Hz, PCH(CH₃)₂).

IR (KBr)=1907 cm⁻¹ (CO).

HRMS (ESI): Exact mass calculated for C₂₉H₂₈NOP₂RuS2+([M−Pyridine−3H]⁺): 634.0126, mass found: 634.0151.

The diffraction data from single crystals of 3 were at 100 K on a Rigaku Synergy-S diffractometer dual source equipped with Dectris Pilatus3 R CdTe 300K detector, MoKα (λ=0.71073 Å). All datasets were processed with CrysAlisPRO and structures were solved with SHELXT⁹. All non-hydrogen atoms were further refined by SHELXL¹⁰ with anisotropic displacement coefficients. Hydrogens were placed in calculated positions and refined in a riding mode. Hydride atoms were located in the electron density map, incorporated and refined.

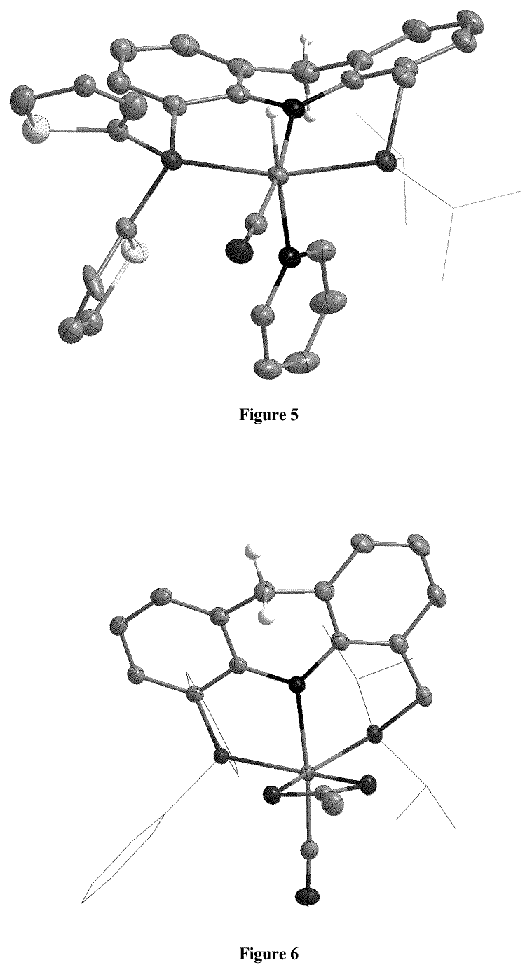

Refinement was carried out with the OLEX-2¹¹ GUI. Crystallographic data and refinement parameters are summarized in Table S4 and FIG. 5.

TABLE S4
Crystallographic data for complex 3

| | |
|---|---|
| CCDC No. | 2382561 |
| Formula | 2C₃₄H₃₆N₂OP₂RuS₂ + C₄H₁₀O |
| Molecular weight | 1505.67 |
| Crystal system | Monoclinic |
| Space group | I2ₐ |
| Crystal size (mm) | 0.334 × 0.156 × 0.151 |
| Crystal color and shape | Yellow prism |
| Temperature (K) | 100 |
| Wavelength (Å) | 0.71073 |
| a (Å) | 24.3111(7) |
| b (Å) | 14.5463(3) |
| c (Å) | 22.3501(7) |
| α (°) | 90 |
| β (°) | 119.466(4) |
| γ (°) | 90 |
| Volume (Å³) | 6881.4(4) |
| Z | 4 |
| r_{calcd} (g · cm⁻¹) | 1.453 |
| μ (mm⁻¹) | 0.704 |
| No. of reflections (unique) | 59269 (11373) |
| Rᵢₙₜ | 0.0457 |
| Completeness to θ (%) | 99.1 |
| θ max | 31.505 |
| Data/restraints/parameters | 11373/67/487 |
| Goodness-of-fit on F² | 1.064 |
| Final R₁ and wR₂ indices [I > 2 s(I)] | 0.0337, 0.0834 |
| R₁ and wR₂ indices (all data) | 0.0448, 0.0876 |
| Highest diff Peak and Deepest hole | 1.188, −0.798 |

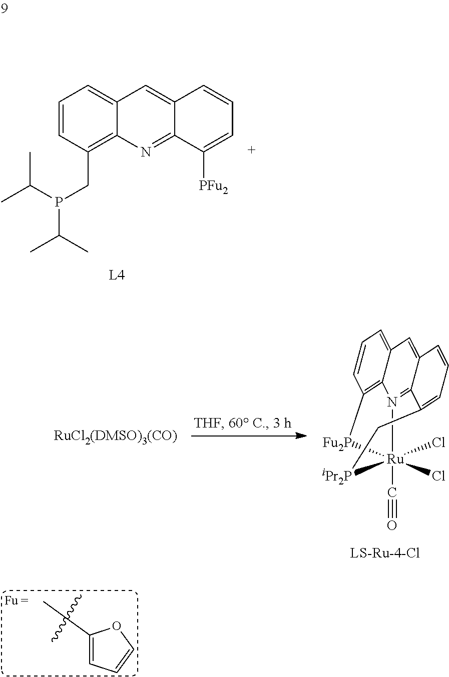

### Synthesis of LS-Ru-4-Cl

In a glovebox, 9 (25.5 mg, 0.054 mmol) and RuCl₂(CO)(DMSO)₃ (21.3 mg, 0.049 mmol) were suspended in tetrahydrofuran (4.0 mL) in an oven-dried 15 mL sealed tube equipped with a magnetic stirring bar. The tube was sealed and taken out of the glovebox, and stirred at 60° C. for 3 hours. After cooling the reaction mixture to room temperature, the sealed tube was taken into the glovebox again and the solvent was removed under vacuum. The resulting orange solid was washed with ether for several times and dried under vacuum to give the desired product LS-Ru-4-Cl as an orange solid (29.8 mg, 90% yield).

³¹P NMR (202 MHz, CD₂Cl₂) δ 60.16 (d, J=25.7 Hz), 27.62 (d, J=25.7 Hz).

¹H NMR (500 MHz, CD₂Cl₂) δ 9.04 (s, 1H, aryl), 8.41 (dd, J=11.8, 7.0 Hz, 1H, aryl), 8.21 (d, J=8.2 Hz, 1H, aryl), 8.03 (d, J=8.3 Hz, 1H, aryl), 7.89 (s, 1H, aryl), 7.86 (d, J=6.9 Hz, 1H, aryl), 7.77 (s, 1H, aryl), 7.73 (s, 1H, aryl), 7.69 (t, J=7.5 Hz, 1H, aryl), 7.60 (t, J=7.5 Hz, 1H, aryl), 6.64 (s, 1H, aryl), 6.45 (s, 1H, aryl), 6.35 (s, 1H, aryl), 4.69 (dd, J=16.5, 11.9 Hz, 1H, CH₂P), 2.93 (dd, J=16.1, 12.7 Hz, 1H, CH₂P), 2.58-2.48 (m, 1H, PCH(CH₃)₂), 1.64 (dd, J=15.9, 6.9 Hz, 3H, PCH(CH₃)₂), 1.35 (dd, J=16.5, 6.9 Hz, 3H, PCH(CH₃)₂), 0.91 (dd, J=12.1, 6.9 Hz, 3H, PCH(CH₃)₂), 0.73-0.65 (m, 1H, PCH(CH₃)₂), −0.23 (dd, J=14.9, 6.8 Hz, 3H, PCH(CH₃)₂).

¹³C NMR (126 MHz, CD₂Cl₂) δ 148.82 (d, J=5.2 Hz, Ar), 148.30 (d, J=6.2 Hz, Ar), 142.45 (s, Ar), 138.28 (d, J=2.2 Hz, Ar), 136.01 (d, J=11.4 Hz, Ar), 135.36 (s, Ar), 132.15 (d, J=2.1 Hz, Ar), 129.20 (s, Ar), 128.49 (s, Ar), 127.39 (d, J=23.0 Hz, Ar), 126.85 (s, Ar), 126.27 (d, J=7.7 Hz, Ar), 120.64 (d, J=11.1 Hz, Ar), 112.23 (d, J=9.1 Hz, Ar), 111.78 (d, J=5.5 Hz, Ar), 27.75 (d, J=29.6 Hz, PCH(CH₃)₂), 26.15 (d, J=26.0 Hz, PCH(CH₃)₂), 23.91 (d, J=27.9 Hz, CH₂P), 18.86 (s, PCH(CH₃)₂), 18.80 (s, PCH(CH₃)₂), 18.06 (d, J=6.5 Hz, PCH(CH₃)₂), 17.97 (d, J=1.9 Hz, PCH(CH₃)₂).

IR (KBr)=1968 cm⁻¹ (CO).

HRMS (ESI): Exact mass calculated for C₂₉H₂₈NO₃P₂Ru⁺ ([M−2Cl−H]⁺): 602.0582, mass found: 602.0605.

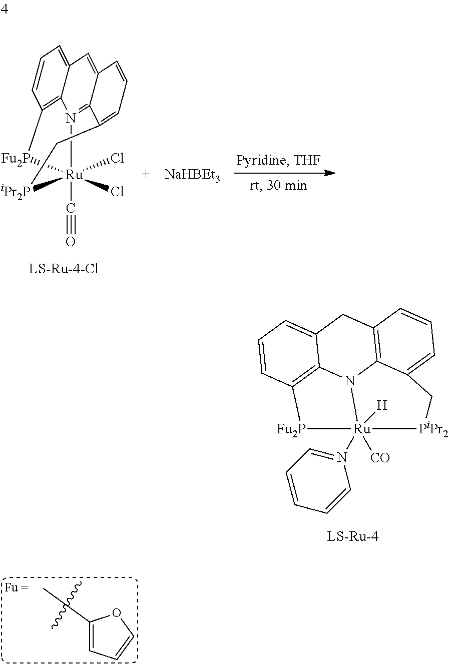

### Synthesis of 4

A THF solution of NaBEt₃H was prepared by adding 98 μl of 1.0 M NaBEt₃H (0.098 mmol) in THF to 1.0 mL of THF. The afforded solution was added to a stirring suspension of LS-Ru-4-Cl (32.8 mg, 0.049 mmol) and pyridine (7.8 mg, 0.098 mmol) in 4.0 mL of THF. The resulting mixture was stirred at room temperature for 30 minutes. The solvent was then removed under vacuum. The residue was redissolved in 6.0 mL diethyl ether, before passed through a 0.2 m PTFE filter. Diethyl ether was then removed under vacuum and the residue was washed twice with 1.0 mL of n-pentane to remove a dark impurity. The remaining solid was dried under vacuum, affording 4 as a yellow solid (29.3 mg; 87% yield).

³¹P NMR (121 MHz, C₆D₆) δ 58.17 (d, J=257.9 Hz), 21.62 (d, J=257.8 Hz).

¹H NMR (400 MHz, C₆D₆) δ 8.48 (d, J=4.8 Hz, 2H, aryl), 8.24-8.10 (m, 2H, aryl), 7.94-7.88 (m, 1H, aryl), 7.55-7.49 (m, 1H, aryl), 7.22 (s, 1H, aryl), 6.99 (s, 1H, aryl), 6.89 (s, 1H, aryl), 6.78-6.74 (m, 1H, aryl), 6.68-6.62 (m, 1H, aryl), 6.56 (t, J=7.4 Hz, 1H, aryl), 6.37-6.31 (m, 1H, aryl), 6.14-6.10 (m, 1H, aryl), 6.09-6.07 (m, 1H, aryl), 6.00 (d, J=3.2 Hz, 1H, aryl), 4.09 (d, J=16.9 Hz, 1H, ArCH₂Ar), 3.93 (d, J=17.0 Hz, 1H, ArCH₂Ar), 3.33 (dd, J=12.9, 5.8 Hz, 1H, CH₂P), 2.62 (td, J=12.7, 5.1 Hz, 1H, CH₂P), 2.12-2.05 (m, 1H, PCH(CH₃)₂), 1.87-1.78 (m, 1H, PCH(CH₃)₂), 1.38 (dd, J=15.0, 7.0 Hz, 3H, PCH(CH₃)₂), 1.29 (dd, J=14.3, 6.8 Hz, 3H, PCH(CH₃)₂), 0.86 (dd, J=10.7, 7.1 Hz, 3H, PCH(CH₃)₂), 0.58 (dd, J=14.3, 7.5 Hz, 3H, PCH(CH₃)₂), −13.78 (dd, J=24.0, 19.4 Hz, 1H, Ru-H).

¹³C NMR (126 MHz, C₆D₆) δ 206.97 (t, J=13.8 Hz, Ru-CO), 164.76 (d, J=32.0 Hz, Ar), 152.87 (s, Ar), 152.13 (d, J=67.7 Hz, Ar), 151.30 (d, J=64.0 Hz, Ar), 148.30 (d, J=4.6 Hz, Ar), 147.99 (d, J=3.9 Hz, Ar), 146.55 (d, J=5.1 Hz, Ar), 145.43 (s, Ar), 137.64 (s, Ar), 135.15 (s, Ar), 132.01 (s, Ar), 131.05 (d, J=6.3 Hz, Ar), 129.98 (s, Ar), 126.73 (d, J=0.7 Hz, Ar), 124.34 (d, J=25.1 Hz, Ar), 124.33 (s, Ar), 123.88 (s, Ar), 123.36 (s, Ar), 122.02 (d, J=14.9 Hz, Ar), 118.41 (s, Ar), 118.14 (s, Ar), 118.09 (s, Ar), 111.00 (d, J=8.9 Hz, Ar), 110.32 (d, J=5.0 Hz, Ar), 110.00 (s, Ar), 35.97 (s, ArCH₂Ar), 33.32 (d, J=23.8 Hz, CH₂P), 26.32 (d, J=25.9 Hz, PCH(CH₃)₂), 23.79 (dd, J=11.9, 4.7 Hz, PCH(CH₃)₂), 19.93 (s, PCH(CH₃)₂), 19.48 (d, J=2.3 Hz, PCH(CH₃)₂), 18.86 (d, J=5.4 Hz, PCH(CH₃)₂), 16.72 (d, J=2.6 Hz, 2.1 Hz, PCH(CH₃)₂).

IR (KBr)=1911 cm¹ (CO).

HRMS (ESI): Exact mass calculated for C₂₉H₂₈NO₃P₂Ru⁺ ([M−Pyridine−3H]⁺): 602.0582, mass found: 602.0598.

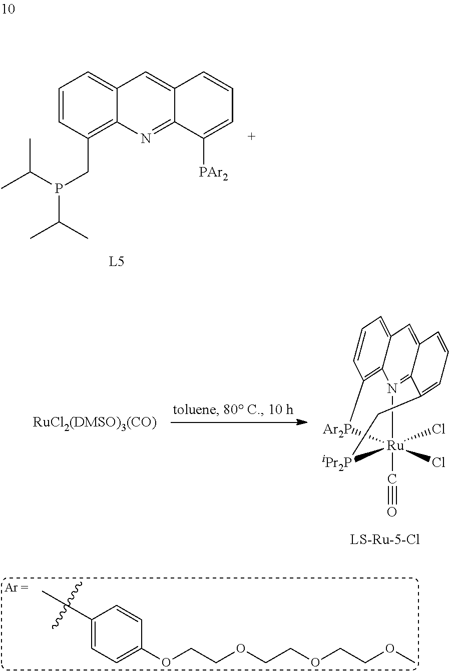

### Synthesis of LS-Ru-5-Cl

In a glovebox, 10 (130.9 mg, 0.160 mmol) and RuCl₂(CO)(DMSO)₃ (63.0 mg, 0.145 mmol) were suspended in toluene (10 mL) in an oven-dried 100 mL Schlenk flask equipped with a magnetic stirring bar. The flask was sealed and taken out of the glovebox, and stirred at 80° C. for 10 hours. After cooling the reaction mixture to room temperature, the flask was taken into the glovebox again and the solvent was removed under vacuum. The residue was dissolved in a small amount of toluene, and ether was added to precipitate an orange solid. The resulting solid was then washed with ether for several times and dried under vacuum to give the desired product LS-Ru-5-Cl as an orange solid (140.1 mg, 95% yield).

³¹P NMR (202 MHz, C₆D₆) δ 56.09 (d, J=22.6 Hz), 54.80 (d, J=23.1 Hz).

¹H NMR (400 MHz, C₆D₆) δ 9.19 (s, 1H, aryl), 8.52 (t, J=9.5 Hz, 2H, aryl), 8.43 (d, J=6.5 Hz, 1H, aryl), 7.85-7.77 (m, 2H, aryl), 7.36 (d, J=4.7 Hz, 1H, aryl), 7.05-6.95 (m, 2H, aryl), 6.91-6.79 (m, 4H, aryl), 6.59 (d, J=6.4 Hz, 2H, aryl), 4.95-4.81 (m, 1H, CH₂P), 3.83-3.76 (m, 4H, OCH₂), 3.52-3.46 (m, 10H, OCH₂), 3.41-3.36 (m, 8H, OCH₂), 3.30-3.27 (m, 2H, OCH₂), 3.16 (s, 3H, OCH₃), 3.08 (s, 3H, OCH₃), 2.61-2.50 (m, 1H, CH₂P), 2.28-2.17 (m, 1H, PCH(CH₃)₂), 1.84 (dd, J=15.1, 6.8 Hz, 3H, PCH(CH₃)₂), 1.23 (dd, J=16.1, 6.8 Hz, 3H, PCH(CH₃)₂), 0.57-0.44 (m, 4H, PCH(CH₃)₂, PCH(CH₃)₂), −0.34-−0.48 (m, 3H, PCH(CH₃)₂).

¹³C NMR (126 MHz, C₆D₆) δ 205.29 (t, J=13.0 Hz, Ru-CO), 161.64 (s, Ar), 160.69 (s, Ar), 155.56 (d, J=17.1 Hz, Ar), 150.16 (s, Ar), 144.71 (s, Ar), 139.78 (s, Ar), 139.69 (s, Ar), 136.29 (s, Ar), 135.77 (s, Ar), 135.41 (d, J=12.1 Hz, Ar), 133.88 (s, Ar), 133.13 (s, Ar), 131.08 (s, Ar), 130.20 (d, J=50.6 Hz, Ar), 129.63 (s, Ar), 127.31 (d, J=8.0 Hz, Ar), 125.60 (s, Ar), 124.51 (s, Ar), 124.47 (s, Ar), 122.08 (d, J=63.3 Hz, Ar), 114.60 (s, Ar), 114.51 (s, Ar), 72.43 (s, OCH₂), 72.34 (s, OCH₂), 71.11 (s, OCH₂), 71.07 (s, OCH₂), 70.99 (s, OCH₂), 70.86 (s, OCH₂), 69.71 (s, OCH₂), 69.65 (s, OCH₂), 68.04 (s, OCH₂), 67.82 (s, OCH₂), 58.77 (s, OCH₃), 58.68 (s, OCH₃), 27.72 (d, J=29.2 Hz, PCH(CH₃)₂), 24.77 (d, J=28.6 Hz, CH₂P), 24.66 (d, J=18.3 Hz, PCH(CH₃)₂), 19.52 (s, PCH(CH₃)₂), 18.98 (s, PCH(CH₃)₂), 18.38 (s, PCH(CH₃)₂), 17.71 (d, J=5.6 Hz, PCH(CH₃)₂).

IR (KBr)=1951 cm⁻¹ (CO).

HRMS (ESI): Exact mass calculated for C₄₇H₆₀NO₉P₂Ru⁺ ([M−2Cl−H]⁺): 946.2781, mass found: 946.2805.

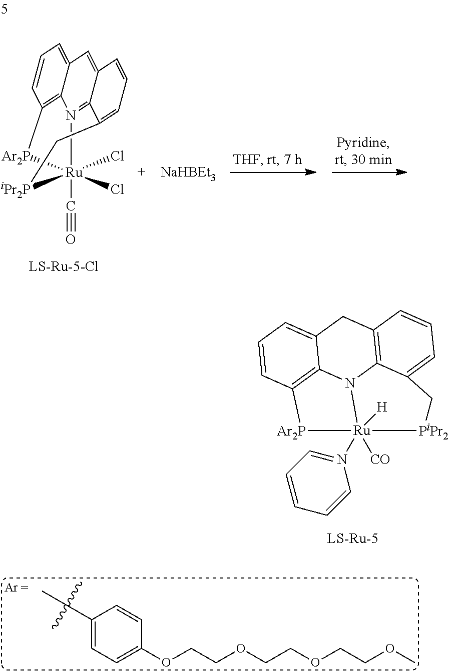

### Synthesis of 5

A THF solution of NaBEt₃H was prepared by adding 258 μl of 1.0 M NaBEt₃H (0.258 mmol) in THF to 2.5 mL of THF. The afforded solution was added dropwise to a stirring solution of LS-Ru-5-Cl (131.2 mg, 0.129 mmol) in 7.5 mL of THF. The resulting mixture was stirred at room temperature for 7 hours, after which pyridine (20.4 mg, 0.258 mmol) was added, and the mixture was stirred for an additional 30 minutes at room temperature. The solvent was then removed under vacuum. The residue was redissolved in 10 mL toluene, before passed through a 0.2 m PTFE filter. Toluene was then removed under vacuum and the residue was washed twice with 4.0 mL of n-pentane to remove a dark impurity. The remaining product was dried under vacuum, affording 5 as a brown semi-solid (125.0 mg; 94% yield).

³¹P NMR (121 MHz, C₆D₆) δ 58.36 (d, J=248.1 Hz), 53.46 (d, J=248.1 Hz).

¹H NMR (400 MHz, C₆D₆) δ 8.37-8.31 (m, 2H, aryl), 8.16 (d, J=5.2 Hz, 2H, aryl), 7.28 (t, J=8.4 Hz, 1H, aryl), 7.20 (d, J=6.9 Hz, 1H, aryl), 7.02 (d, J=6.7 Hz, 1H, aryl), 6.95 (d, J=8.5 Hz, 1H, aryl), 6.89 (t, J=7.3 Hz, 2H, aryl), 6.76 (t, J=7.2 Hz, 1H, aryl), 6.67 (t, J=7.4 Hz, 2H, aryl), 6.62-6.55 (m, 1H, aryl), 6.42-6.32 (m, 4H, aryl), 6.12-6.06 (m, 1H, aryl), 4.21 (d, J=16.8 Hz, 1H, ArCH₂Ar), 4.00 (d, J=17.0 Hz, 1H, ArCH₂Ar), 3.79-3.73 (m, 2H, OCH₂), 3.73-3.64 (m, 2H, OCH₂), 3.54-3.38 (m, 17H, CH₂P, OCH₂), 3.36-3.30 (m, 4H, OCH₂), 3.15-3.09 (m, 6H, OCH₃), 2.73 (td, J=12.3, 3.6 Hz, 1H, CH₂P), 2.23-2.11 (m, 1H, PCH(CH₃)₂), 1.83 (td, J=13.9, 7.0 Hz, 1H, PCH(CH₃)₂), 1.45-1.34 (m, 6H PCH(CH₃)₂), 0.89-0.86 (m, 3H PCH(CH₃)₂), 0.54 (dd, J=13.8, 7.4 Hz, 3H), −13.46 (t, J=19.8 Hz, 1H, Ru-H).

¹³C NMR (126 MHz, C₆D₆) δ 207.80 (t, J=13.1 Hz, Ru-CO), 164.41 (dd, J=27.1, 2.6 Hz, Ar), 161.03 (d, J=1.8 Hz, Ar), 159.32 (s, Ar), 152.52 (s, Ar), 148.48 (d, J=4.5 Hz, Ar), 145.34 (s, Ar), 137.77 (s, Ar), 136.61 (d, J=13.6 Hz, Ar), 134.79 (s, Ar), 133.01 (d, J=11.1 Hz, Ar), 131.18 (d, J=6.1 Hz, Ar), 130.91 (s, Ar), 129.36 (s, Ar), 128.76 (d, J=44.7 Hz, Ar), 127.76 (s, Ar), 127.34 (d, J=54.3 Hz, Ar), 126.48 (s, Ar), 124.40 (s, Ar), 123.83 (s, Ar), 123.52 (s, Ar), 121.85 (d, J=13.2 Hz, Ar), 118.29 (s, Ar), 118.17 (d, J=6.6 Hz, Ar), 114.74 (d, J=11.1 Hz, Ar), 114.33 (s, Ar), 114.26 (s, Ar), 113.88 (s, Ar), 72.39 (s, OCH₂), 72.38 (s, OCH₂), 71.16 (s, OCH₂), 71.15 (s, OCH₂), 71.07 (s, OCH₂), 71.06 (s, OCH₂), 70.94 (s, OCH₂), 70.91 (s, OCH₂), 69.78 (s, OCH₂), 69.77 (s, OCH₂), 67.69 (s, OCH₂), 67.61 (s, OCH₂), 58.71 (s, OCH₃), 58.70 (s, OCH₃), 36.24 (s, ArCH₂Ar), 33.78 (d, J=22.7 Hz, CH₂P), 26.44 (d, J=24.8 Hz, PCH(CH₃)₂), 24.00 (dd, J=10.9, 4.6 Hz, PCH(CH₃)₂), 20.02 (s, PCH(CH₃)₂), 19.64 (d, J=2.3 Hz, PCH(CH₃)₂), 18.90 (d, J=5.6 Hz, PCH(CH₃)₂), 16.87 (d, J=2.8 Hz, PCH(CH₃)₂).

IR (KBr)=1900 cm⁻¹ (CO).

HRMS (ESI): Exact mass calculated for C₄₇H₆₀NO₉P₂Ru⁺ ([M-Pyridine−3H]⁺): 946.2781, mass found: 946.2803.

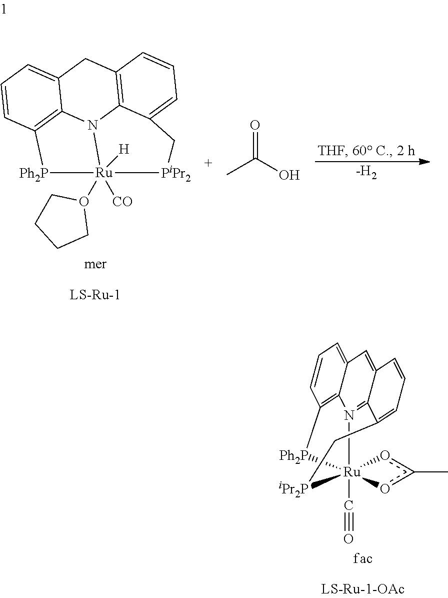

### Formation of the Acetate Complex LS-Ru-1-OAc:

Complex 1 (13.9 mg, 0.020 mmol) was dissolved in 3 mL of THF in a 15 mL sealed tube. To this solution was added dropwise a solution of 1.2 equiv. of acetic acid in THF (0.024 mmol, 240 μL, 1M). The tube was sealed and taken out of the glovebox, and stirred at 60° C. for 2 hours. After cooling the reaction mixture to room temperature, the sealed tube was taken into the glovebox again and the solvent was removed under vacuum. The resulting solid was washed two times with 1 mL of cold pentane to afford complex LS-Ru-1-OAc as an orange brown solid (12.1 mg, 88% yield). Crystals suitable for X-ray analysis were obtained by slow evaporation of a Et₂O/n-hexane solution of LS-Ru-1-OAc.

³¹P NMR (202 MHz, C₆D₆) δ 65.01 (d, J=29.5 Hz), 56.48 (d, J=29.5 Hz).

¹H NMR (500 MHz, C₆D₆) δ 7.99 (dd, J=11.2, 8.2 Hz, 2H, aryl), 7.69 (dd, J=10.2, 8.5 Hz, 2H, aryl), 7.08-7.03 (m, 3H, aryl), 7.01-6.91 (m, 5H, aryl), 6.91-6.84 (m, 3H, aryl), 6.64 (t, J=7.2 Hz, 1H, aryl), 4.03 (d, J=16.2 Hz, 1H, ArCH₂Ar), 3.84 (dd, J=16.7, 11.7 Hz, 1H, CH₂P), 3.79 (d, J=16.8 Hz, 1H, ArCH₂Ar), 2.35 (t, J=15.6 Hz, 1H, CH₂P), 1.67 (s, 3H, OOCCH₃), 1.58-1.49 (m, 1H, PCH(CH₃)₂), 1.38 (dd, J=15.2, 6.7 Hz, 3H, PCH(CH₃)₂), 0.89 (dd, J=16.0, 6.9 Hz, 3H, PCH(CH₃)₂), 0.44-0.38 (m, 3H, PCH(CH₃)₂), 0.30-0.20 (m, 4H, PCH(CH₃)₂, PCH(CH₃)₂)

¹³C NMR (126 MHz, C₆D₆) δ 201.74 (dd, J=15.3, 12.0 Hz, Ru-CO), 189.73 (t, J=2.5 Hz, OOCCH₃), 162.36 (d, J=21.1 Hz, Ar), 148.53 (d, J=3.1 Hz, Ar), 136.25 (d, J=59.0 Hz, Ar), 135.68 (dd, J=49.2, 1.3 Hz, Ar), 133.74 (s, Ar), 133.65 (s, Ar), 133.17 (s, Ar), 133.09 (s, Ar), 130.73 (s, Ar), 130.51 (d, J=2.6 Hz, Ar), 130.20 (d, J=2.4 Hz, Ar), 130.05 (d, J=1.9 Hz, Ar), 129.74 (d, J=9.8 Hz, Ar), 128.71 (s, Ar), 128.62 (s, Ar), 128.19 (s, Ar), 128.11 (s, Ar), 126.96 (d, J=11.2 Hz, Ar), 126.58 (s, Ar), 125.83 (d, J=1.0 Hz, Ar), 122.67 (d, J=1.7 Hz, Ar), 118.34 (s, Ar), 118.27 (s, Ar), 114.35 (d, J=50.5 Hz, Ar), 35.42 (d, J=1.6 Hz, ArCH₂Ar), 26.99 (d, J=30.4 Hz, PCH(CH₃)₂), 24.56 (s, OOCCH₃), 23.95 (d, J=24.4 Hz, PCH(CH₃)₂), 23.67 (d, J=26.3 Hz, CH₂P), 19.34 (s, PCH(CH₃)₂), 17.99 (s, PCH(CH₃)₂), 16.89 (d, J=2.8 Hz, PCH(CH₃)₂), 16.51 (d, J=7.0 Hz, PCH(CH₃)₂).

IR (KBr)=1941 cm⁻¹ (CO), 1459 cm⁻¹ (COO), 1414 cm⁻¹ (COO).

HRMS (ESI): Exact mass calculated for C₃₃H₃₂NOP₂Ru⁺ ([M−HOAc−H]⁺): 622.0997, mass found: 622.1016.

The diffraction data from single crystals of LS-Ru-1-OAc were at 100 K on on a Rigaku Synergy-R diffractometer equipped with a HyPix ARC 1500 detector and CuKα (λ=1.54184 Å).

All datasets were processed with CrysAlisPRO and structures were solved with SHELXT⁹. All non-hydrogen atoms were further refined by SHELXL¹⁰ with anisotropic displacement coefficients. Hydrogens were placed in calculated positions and refined in a riding mode. Hydride atoms were located in the electron density map, incorporated and refined. Refinement was carried out with the OLEX-2¹¹ GUI. Crystallographic data and refinement parameters are summarized in Table S5 and FIG. 6.

TABLE S5
Crystallographic data for complex LS-Ru-1-OAc

| | |
|---|---|
| CCDC No. | 2382563 |
| Formula | C₃₅H₃₇NO₃P₂Ru + 0.5C₆H₁₄ |
| Molecular weight | 725.75 |
| Crystal system | Orthorhombic |
| Space group | Pbca |
| Crystal size (mm) | 0.333 × 0.135 × 0.021 |
| Crystal color and shape | Orange prism |
| Temperature (K) | 100 |
| Wavelength (Å) | 1.54184 |
| a (Å) | 10.89264(5) |
| b (Å) | 16.70247(8) |
| c (Å) | 37.71001(19) |
| α (°) | 90 |
| β (°) | 90 |
| γ (°) | 90 |
| Volume (Å³) | 6860.73(6) |
| Z | 8 |
| r_{calcd} (g · cm⁻¹) | 1.405 |
| μ (mm⁻¹) | 4.873 |
| No. of reflections (unique) | 173888 (7042) |
| Rᵢₙₜ | 0.0521 |
| Completeness to θ (%) | 99.4 |
| θ max | 75.153 |
| Data/restraints/parameters | 7042/0/426 |
| Goodness-of-fit on F² | 1.038 |
| Final R₁ and wR₂ indices [I > 2 s(I)] | 0.0250, 0.0674 |
| R₁ and wR₂ indices (all data) | 0.0278, 0.0697 |
| Highest diff Peak and Deepest hole | 0.621, −0.769 |

### Synthesis of 1 and Conversion Thereof to LS-Ru-1-OAc- Discussion

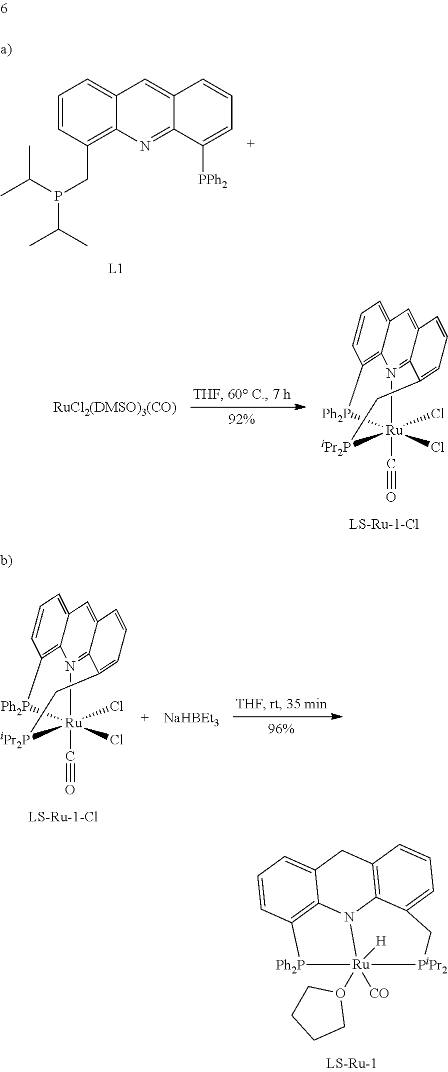

A new long-short-arm acridine based ligand, 6, was synthesized. The corresponding novel pincer complex, LS-Ru-1-Cl, was prepared by reaction of 6 with [RuCl₂(DMSO)₃(CO)] in THF at 60° C. for 4 h. The NMR spectra of LS-Ru-1-Cl showed two doublet phosphine signals at 57.2 ppm (J=22.9 Hz) and 56.4 ppm (J=22.0 Hz) in the ³¹P NMR spectrum. The structure of LS-Ru-1-Cl was determined by single-crystal X-ray crystallography and exhibited a distorted octahedral structure with the CO and N ligands trans to each other and the two phosphorus ‘arms’ in mutually cis positions, which performs a fac coordination model (FIG. 2). The reaction of LS-Ru-1-Cl with 2 equivalents of NaHBEt₃ in a THF solution at room temperature for 35 minutes, gave the dearomatized complex, 1, which is expected to be utilized in dehydrogenation and hydrogenation reactions in a base-free manner. The NMR spectra of complex 1 showed two doublet phosphine signals at 60.4 ppm (J=255.0 Hz) and 50.7 ppm (J=257.8 Hz) in the ³¹P NMR spectrum. The structure of complex 1 was then determined by single-crystal X-ray crystallography and exhibited a distorted octahedral structure with the CO and N ligands trans to each other and the two phosphorus ‘arms’ in mutually trans positions, which performs a mer coordination model (FIG. 3).

At the outset, it was unclear whether this new acridine-based pincer complex 1 would be flexible enough to allow a mer-fac fluxionality. Thus, a density functional theory (DFT) calculations were performed on mer-1 and fac-1. The energy barrier between mer-1 and fac-1 is only 6.5 kcal mol⁻¹, indicating a very easy interconversion between these two isomers. From the experimental aspect, the reaction of 1 with one equivalent of acetic acid in a THF solution at 60° C. for 2 hours, gave a kinetically stable complex LS-Ru-1-OAc (scheme 1).

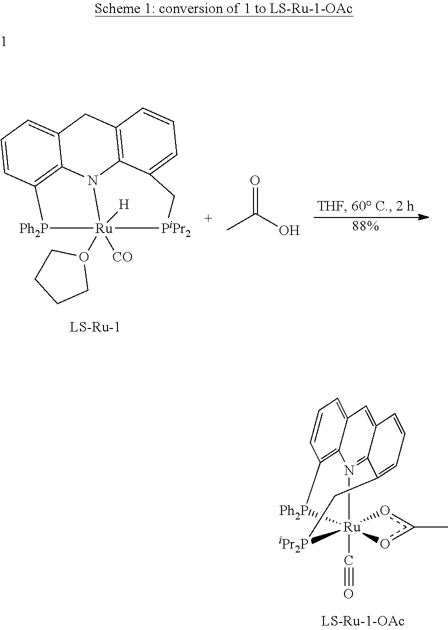

The ¹H NMR spectrum of LS-Ru-1-OAc did not show any characteristic hydride peaks, as expected. The NMR spectra of LS-Ru-1-OAc showed two doublet phosphine signals at 65.0 ppm (J=29.5 Hz) and 56.5 ppm (J=29.5 Hz) in the ³¹P NMR spectrum. The structure of complex LS-Ru-1-OAc was then determined by single-crystal X-ray crystallography and exhibited a distorted octahedral structure with the CO and N ligands trans to each other and the two phosphorus ‘arms’ in mutually cis positions, performing a fac coordination model (FIG. 6, bottom). Therefore, both computational and experimental results suggest the fluxionality ability of this new complex, 1.

### Example 3

### Acceptorless Dehydrogenative Coupling of Ethylene Glycol (EG)

### Experimental

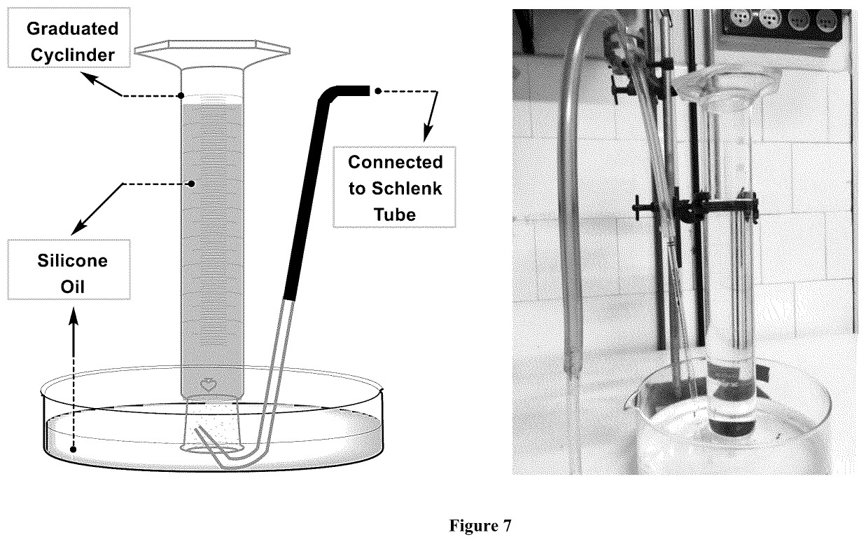

In a glovebox, ethylene glycol (62.1 mg, 1.0 mmol) was added into a 100 mL Schlenk tube equipped with a magnetic stirring bar through a glass pipette. A 5 mL vial containing a magnetic stirring bar was charged with the ruthenium pincer complex (0.005 mmol; compounds 1-5) and dry and degassed dimethoxyethane (0.5 mL) and the solution was transferred into the above Schlenk tube using the same glass pipette. The vial was washed with toluene (2*0.25 mL) and the solution was transferred into the Schlenk tube. The Schlenk tube was taken out of the glovebox and stirred at 150° C. for 72 hours. Then the reaction mixture was firstly cooled to room temperature, and then the Schlenk tube was connected to the gas collecting system to measure the volume of gas. Finally, the solvent was removed under vacuum, mesitylene was added into Schlenk tube as an internal standard. The residue was dissolved in d₆-Acetone, and the resulting solution was passed through a short Celite column and then submitted to NMR analysis. This setup and drawing thereof is presented in FIG. 7.

### Discussion

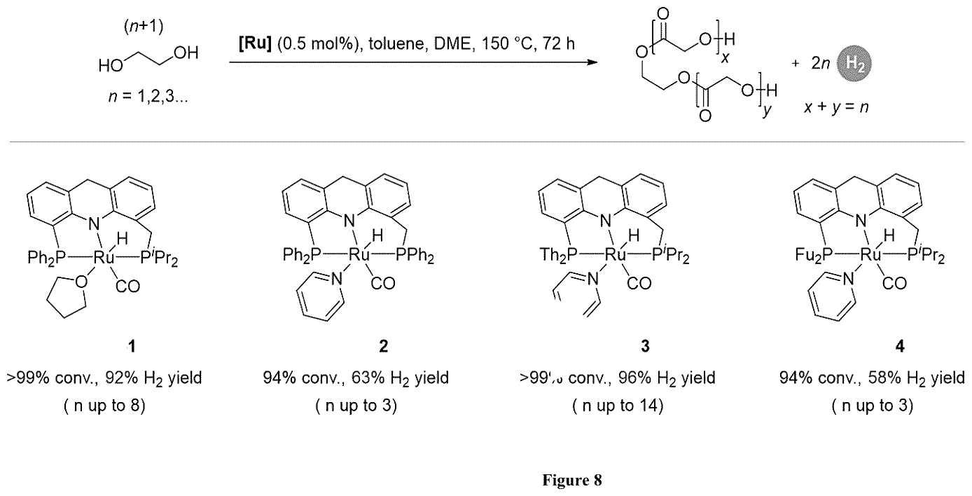

With 0.5 mol % 1 as the catalyst, the base-free dehydrogenative coupling of ethylene glycol (EG) was carried out at 150° C. in a 1:1 (v/v) mixture of toluene and 1,2-dimethoxyethane. To our delight, >99% conversion of EG, a very high H₂ yield (92%) with 99.00% purity, and oligoesters with high degrees of oligomerization (n up to 8) were achieved (FIG. 5), indicating superior performance compared to the previous catalyst, Ru-11, which required 1.0 mol % loading, achieved 97% conversion, 64% H₂ yield, and oligomers with n up to 6. To investigate the impact of phosphine parts with different substituents, a series of novel long-short arm acridine based ligands (7-9) were synthesized, followed by the preparation of their dearomatized Ru-pincer complexes (2-4). The structures of LS-Ru-3-Cl and 3 were determined by single-crystal X-ray crystallography and exhibit similar coordination models to the those of LS-Ru-1-Cl and 1, respectively (FIGS. 2-5). Next, their performance in the base-free dehydrogenative coupling of EG were investigated (FIG. 8). 2, featuring a diphenylphosphine group on the long arm, achieved 94% conversion but yielded only a moderate H₂ production (63%, 98.52% purity), along with lower degrees of oligomerization, with n reaching only up to 3. In contrast, 3, which incorporates a dithienylphosphine group on the short arm, achieved a significantly high H₂ yield of 96% (98.70% purity). Analysis of the reaction mixture also revealed that higher degrees of oligomerization, with n reaching up to 14, were attained. However, substituting the dithienylphosphine in 3 with a difurylphosphine in 4 resulted in a dramatically lower H₂ yield of 58% (98.98% purity), and much lower degrees of oligomerization, along with much lower degrees of oligomerization, with n reaching only up to 3.

### Example 3

### Investigation of Differences Between 1 and Previous Compound Ru-11

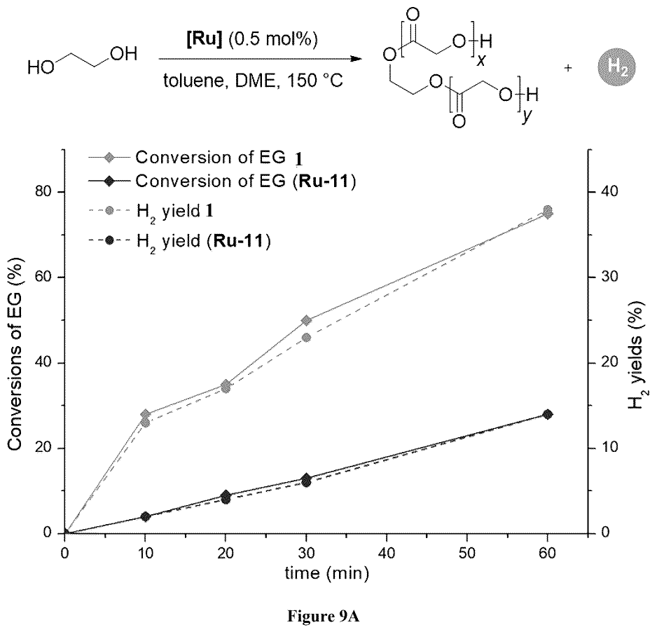

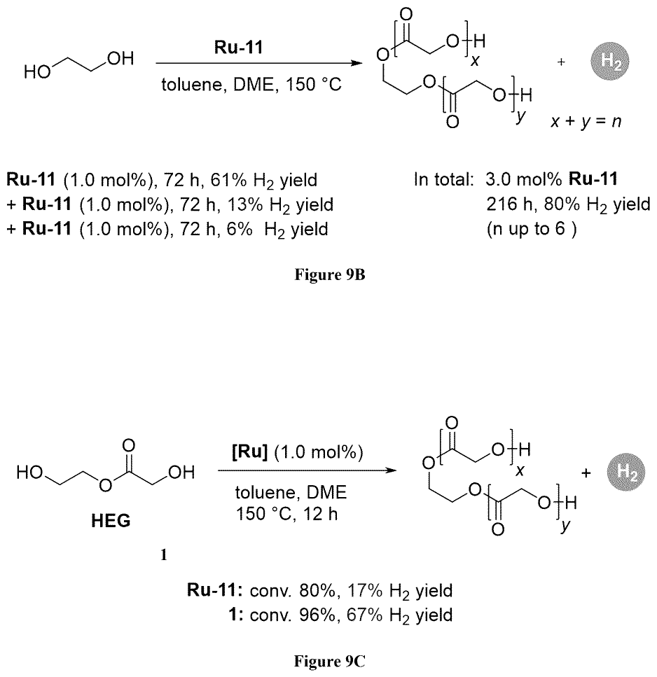

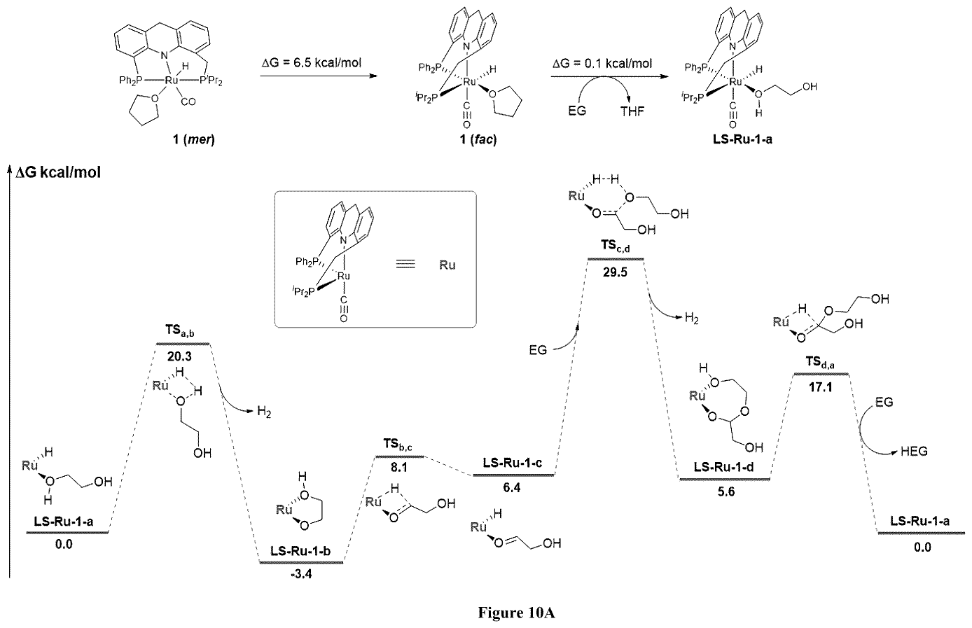

In order to gain a deeper understanding of the differences between 1 and Ru-11, a series of experiments were designed and conducted, as shown in FIGS. 9A-9C. Firstly, the base-free dehydrogenative coupling of EG was carried out with different reaction times. As shown in FIG. 9A, both the conversion of EG and the H₂ generation rate are significantly faster in the 1-catalyzed system compared to the Ru-11-catalyzed system, indicating that the reactivity of 1 is considerably higher than that of Ru-11. There are two potential reasons for the significantly higher H₂ yield observed in the 1 system compared to that in the Ru-11 system: 1) 1 exhibits better stability during the current transformation, enabling it to operate for a longer duration; 2) 1 demonstrates a superior ability to achieve high degrees of oligomerization, particularly during the late-stage dehydrogenative coupling of HEG (2-hydroxyethyl glycolate) or other higher-grade oligoesters. Then, Ru-11 was tested in a continuous experiment as follows: in a glovebox, ethylene glycol (124.1 mg, 2.0 mmol) was added into a 100 mL Schlenk tube equipped with a magnetic stirring bar through a glass pipette. A 5 mL vial containing a magnetic stirring bar was charged with Ru-11 (0.02 mmol) and dry and degassed dimethoxyethane (1.0 mL) and the solution was transferred into the above Schlenk tube using the same glass pipette. The vial was washed with toluene (2*0.5 mL) and the solution was transferred into the Schlenk tube. The Schlenk tube was taken out of the glovebox and stirred at 150° C. (oil bath temperature) for 72 hours. Then the reaction mixture was firstly cooled to room temperature and submitted to the gas collecting system for measurement of the volume of formed hydrogen (59 mL of H₂ was collected). The reaction tube was taken into the glovebox, and 0.02 mmol of Ru-11 in toluene/DME (0.1 mL/0.1 mL) was added. The reaction mixture was stirred at 150° C. (oil bath temperature) for another 72 hours, then cooled to room temperature and the hydrogen evolved was collected (12 mL of H₂). The reaction tube was taken into the glovebox again, and 0.02 mmol of Ru-11 in toluene/DME (0.1 mL/0.1 mL) was added. The reaction mixture was stirred at 150° C. (oil bath temperature) for another 72 hours, then cooled to room temperature and the hydrogen evolved was collected (6 mL of H₂). In total, we collected 77 mL of H₂. Then, the solvent was removed under vacuum, mesitylene was added into Schlenk tube as an internal standard. The residue was dissolved in acetone-d6, and the resulting solution was passed through a short Celite column and then submitted to NMR analysis. The EG conversion is >99%.

As shown in FIG. 9B, the continuous experiment utilizing 3.0 mol % Ru-11 over a duration of 216 hours resulted in a total H₂ yield of 80%, which remains lower than that achieved in in the 1 system (0.5 mol % 1, 92% H₂ yield) and the 3 system (0.5 mol % 3, 96% H₂ yield). The maximum degree of oligomerization was limited to 6, which is lower than that observed in the 1 system (with n up to 8) and the 3 system (with n up to 14). This result suggests that stability is not the primary factor limiting Ru-11's capacity to achieve a high H₂ yield. Since HEG should be the primary product in the early stage of the dehydrogenative coupling of EG, HEG was employed as the substrate to further compare the performance of 1 and Ru-11. As shown in FIG. 9C, reactions were conducted with 1.0 mol % 1 or Ru-11 at 150° C. for 12 hours. 1 produced a significantly higher H₂ yield (67%) compared to Ru-11 (17%). Given the substantially greater steric hindrance of HEG relative to EG, these results suggest that 1 is more effective than Ru-11 in the late-stage dehydrogenative coupling of EG, which is very critical for achieving high H₂ yields (FIG. 1C).

### Example 4

### Mechanistic Studies

### Computational Details

Density functional theory (DFT) calculations were performed with Gaussian 16 (C.01 revision), using Truhlar's M06-L functional, the triple-ξ def2-TZVP basis set, W06 density fitting, and Grimme's D3(0) empirical dispersion correction. Frequency calculations at this level of theory were run at 423.15K to confirm stationary points and transition states, and to obtain thermodynamic corrections. Single point energies of the M06-L optimized structures were computed with ORCA (5.0.3), using the range-separated meta-GGA hybrid functional ωB97M-V of the Head-Gordon group, including dispersion correction, together with the triple-ξ def2-TZVPP basis set, and the corresponding auxiliary basis sets, def2/J and def2-TZVPP/C, for RIJCOSX density fitting. The functional and basis set selections are based on recent benchmark studies (Iron, M. A.; Janes, T. Evaluating Transition Metal Barrier Heights with the Latest Density Functional Theory Exchange-Correlation Functionals: The MOBH35 Benchmark Database. J. Phys. Chem. A 2019, 123, 3761-3781).

Gibbs free energies at 423.15 K were computed by adding the free energy correction term from the frequency calculation to the single point energy in water, according to the following equation:

$${G}^{o ω B 97 M - V} ( gas , 423.15 K ) = {E}^{ω B 97 M - V} gas + {corr}^{M 06 - L} freq ( gas , 423.15 K )$$

where E^{ωB97M-V}_{water} is the single point energy, and corr^{M06-L}_{freq} is the thermal correction to the Gibbs free energy from the frequency calculation (at T=423.15 K).

Free energy values (G°) were corrected to account for changes in standard states (G°→G). Standard state corrections were employed, such that all species are treated as 1 M (using an ideal gas approximation), with the exception of H₂ (maintained as 1 atm).

### Discussion

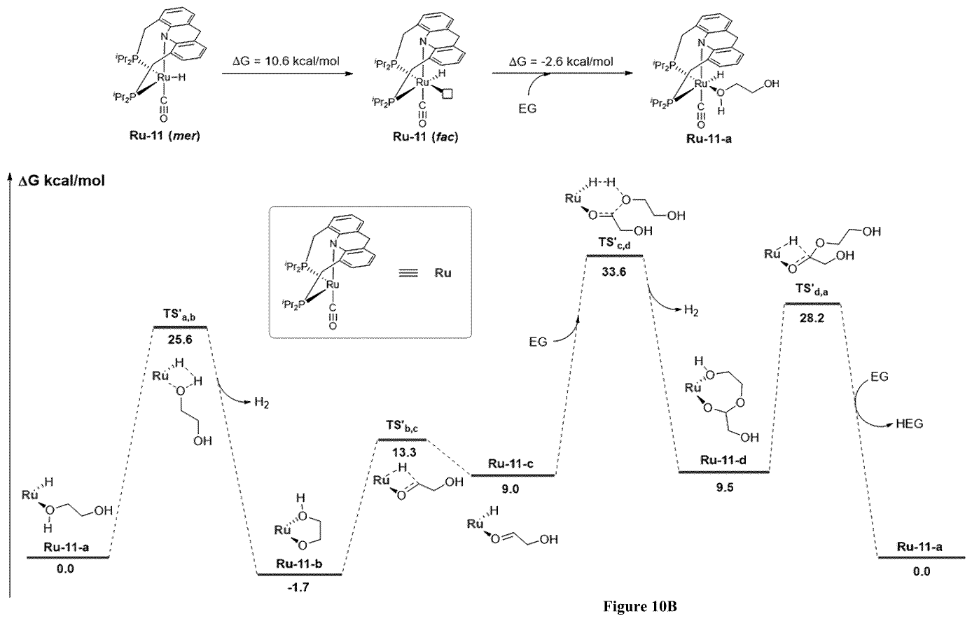

To gain mechanistic insights and understand the differences between the current 1 system and the previous Ru-11 system, density functional theory (DFT) calculations were conducted to analyze the overall dehydrogenation process of EG to HEG for both catalytic systems (FIG. 10A-10B). For the fac-mer fluxionality step, the fac isomer of 1 was found to be 6.5 kcal mol⁻¹ higher in energy than the mer isomer, and this energy difference suggests that mer-1 can access fac-1 easily (FIG. 10A). In comparison, the energy difference between the mer-isomer and fac-isomer of Ru-11 is a little higher, which is 10.6 kcal mol⁻¹ (FIG. 10B). Next, due to the dissociation energy of THF from the Ru center, there is a very slight uphill in energy (0.1 kcal mol⁻¹) from fac-1 to the EG coordinated LS-Ru-1-a, while a slight downhill in energy (−2.6 kcal mol⁻¹) is calculated in the Ru-11 system for EG coordination to the five-coordinate complex fac-Ru-11. Compared with the dehydrogenation of the EG complex Ru-11-a, the dehydrogenation of the EG complex LS-Ru-1-a, leading to the generation of LS-Ru-1-b and H₂, is less energetically demanding (ΔG^{±}=20.3 kcal mol⁻¹ for the reaction LS-Ru-1-a to LS-Ru-1-b, vs 25.6 kcal mol⁻¹ for the reaction Ru-11-a to Ru-11-b). Decoordination of the hydroxo group allows for β-hydride elimination via TS_{b,c} (8.1 kcal mol⁻¹) and reforms a Ru-H bond in LS-Ru-1-c (6.4 kcal mol⁻¹). With another molecule of EG, LS-Ru-1-c undergoes dehydrogenation to LS-Ru-1-d (5.6 kcal mol⁻¹) via a concerted Zimmerman-Traxler-like six-membered transition state (ΔG^{±}=23.1 kcal mol⁻¹). In contrast, the reaction from Ru-11-c to Ru-11-d exhibits a higher ΔG^{±} of 24.6 kcal mol⁻¹, indicating that this process is more energetically demanding than that in the 1 system. Another 0-hydride elimination from K²-hemiacetalate LS-Ru-1-d with a transition state of 17.1 kcal mol⁻¹, leads to the release of HEG, after which EG coordination regenerates LS-Ru-1-a. Importantly, the overall dehydrogenation of EG to HEG is calculated to be nearly thermoneutral in both the 1 and Ru-11 systems, with ΔG=0 kcal mol⁻¹, which indicates that the dehydrogenation and hydrogenation events are readily feasible and reversible. Overall, the DFT calculations show that the overall rate-determining process for dehydrogenation of EG to HEG is the dehydrogenation of the second EG molecular to form K²-hemiacetalate LS-Ru-1-d, which exhibits an apparently activation barrier of 29.5 kcal mol⁻¹. In contrast, the transition sate in the Ru-11 system, TS′_{c,d}, exhibits an apparently higher activation barrier of 33.6 kcal mol⁻¹. These results tentatively explain the higher reactivity of 1 compared to Ru-11 in the dehydrogenative coupling of EG.

Next, it was sought to get a reasonable explanation for the higher reactivity and enhanced ability for the late-stage dehydrogenative coupling of 1 compared to Ru-11. Based on the crystal structures of LS-Ru-1-OAc and Ru-11-OAc, topographic steric maps of these Ru-pincer complexes were drawn by SambVca web application to calculate the percentage of buried volume (% V_{bur}) around ruthenium center and quantify the steric hinderance of these catalytic pockets. The smaller % V_{bur} indicates the larger catalytic pocket. The results illustrated that the smaller hindrance of 1 is mainly contributed from its acridine part, which is almost perpendicular to the metal phosphine part. Correspondingly, the % V_{bur} decreases from 64.6% (Ru-11-OAc) to 60.4% (LS-Ru-1-OAc). Noteworthily, the steric hinderance is drastically reduced in the northern hemisphere of its catalytic pocket in LS-Ru-1-OAc. These visible changes in the pocket space and steric hindrance around the Ru center, resulting from the structural differences in the ligands, rationalize the observed variations in performance with different ligands. Therefore, compared to Ru-11, the larger catalytic pocket and reduced steric hindrance around the Ru center created by the current long-short arm acridine skeleton in 1 are advantageous for achieving higher reactivity and a greater degree of oligomerization, resulting in improved H₂ yield.

### Example 5

### Solvent- and Additive-Free Dehydrogenation/Hydrogenation Cycle

### Experimental

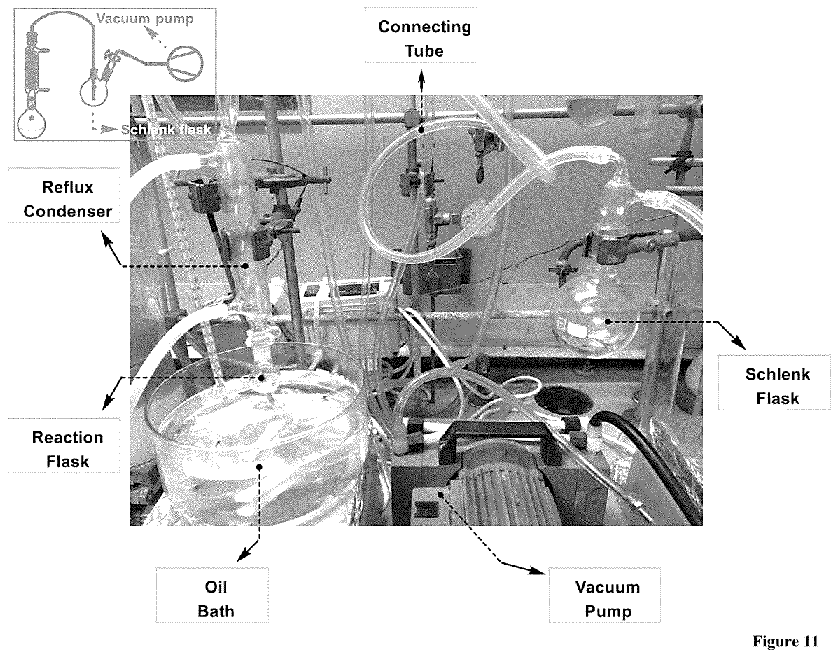

Dehydrogenation: In a glovebox, ethylene glycol (1.0 mL, 17.8 mmol) and 5 (0.036 mmol) were added into a 5.0 mL flask equipped with a magnetic stirring bar and a reflux condenser (FIG. 11). The reaction flask was taken out of the glovebox under nitrogen protected conditions. Then the reaction system was connected to the vacuum pump through the top of the reflux condenser (connecting quickly). The resulting mixture was stirred at 150° C. for 168 hours under a pressure of 95 mbar. Then the reaction mixture was firstly cooled to room temperature, and mesitylene (270.4 mg, 2.25 mmol) was added as an internal standard. The residue was dissolved in acetone-d₆, and the resulting solution was passed through a short Celite column and then submitted to NMR analysis. ¹H NMR indicated that the conversion was 95%.

Hydrogenation: In a glovebox, a 30 mL stainless steel autoclave with a Teflon tube containing a magnetic stirring bar was charged with the reaction mixture from the dehydrogenation reaction (from 17.8 mmol EG) (FIG. 11). The autoclave was taken out of the glovebox and purged five times with hydrogen and finally pressurized to 50 bar. The reaction mixture was stirred at 150° C. (oil bath temperature) for 24 hours, and then was cooled to room temperature in an ice bath. Then the reaction mixture was transferred into a 25 mL vial and the solvent was removed under vacuum and mesitylene (270.4 mg, 2.25 mmol) was added into Schlenk tube as an internal standard. The residue was dissolved in d₆-acetone, and the resulting solution was passed through a short Celite column and then submitted to NMR analysis. ¹H NMR indicated that the conversion was >99% and the yield of ethylene glycol was 92%.

Analysis of the purity of H₂ under partial vacumm: A large-scale reaction (17.8 mmol EG) was set under partial vacuum (95 mbar). After connecting to the vacuum, the reaction system was closed, and the mixture was stirred at 150° C. under the static partial vacuum. After 5 hours, the gas phase was analyzed by GC, showing that only hydrogen gas was released (purity of hydrogen: 100%). Because of the increasing volume of hydrogen, it is difficult to keep the vacuum of the reaction system as 95 mbar, therefore we stopped the reaction. This result indicates that almost no CO was formed in the large-scale reaction under partial vacuum.

### Discussion

Solvent- and additive-free reaction conditions offer several advantages, including optimal gravimetric and volumetric H₂ densities, potentially decreased reaction times, reduced energy consumption, and lower capital investment. These benefits make such conditions more environmentally benign and cost-effective, thereby rendering them more attractive for industrial applications. Furthermore, in the current EG system, solvent-free conditions may facilitate polymerization reactions and reduce CO formation due to the higher EG concentration compared to systems with solvents. Consequently, the performance of these new complexes under neat conditions was investigated. Firstly, 1 and 2 were tested, but their limited solubility in EG inhibited their performance, resulting in low conversions and low H₂ yields. To enhance the solubility of the complex in EG, 6 was modified by introducing poly(ethylene glycol) (PEG) as an EG-solubilizing moiety. To minimize the impact of the appended PEG on the coordination model, steric hindrance, stability, and activity compared to the original complex 1, it was chosen to introduce PEG at the para position of the phenyl moieties. (compound 10). The novel pincer complex LS-Ru-5-Cl was prepared by reaction of the new ligand 10 with [RuCl₂(DMSO)₃(CO)] in toluene at 80° C. for 10 h. The reaction of LS-Ru-5-Cl with 2 equivalents of NaHBEt₃ in a THF solution at room temperature for 7 hours, followed by the addition of pyridine, gave the novel complex 5. Next, the dehydrogenation reaction of EG was performed on a larger scale (17.8 mmol, 1 mL) under neat conditions at 150° C. and a partial vacuum of 95 mbar. The reduced pressure was employed to maintain reflux in the reaction system, facilitating the efficient removal of generated hydrogen and driving the reaction forward. Under these conditions, a 95% conversion was obtained after seven days using 0.2 mol % of 5. The remaining EG condensed in the reflux condenser, out of reach of the catalyst. Based on ¹H NMR spectroscopy of the crude reaction mixture, the hydrogen yield was estimated at 82% (referenced to the maximum HSC of EG, 6.5 wt %), with an average degree of oligomerization of approximately 6, and the realized HSC was 5.6 wt %. To complete the entire cycle, the hydrogenation of the above reaction mixture using 5 was investigated. Encouragingly, under solvent- and additive-free conditions, the above crude reaction mixture could be fully hydrogenated back to EG within 12 hours in the presence of 0.2 mol % of 5 under 50 bar of hydrogen. Thus, the entire cycle of the current LOHC system has been successfully achieved under solvent- and additive-free conditions for the first time. Notably, this achievement was accomplished using the same catalyst throughout the process.

While certain features of the present invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the present invention.

What is claimed is:

1. A compound represented by the structure of Formula (A) or any isomer thereof: 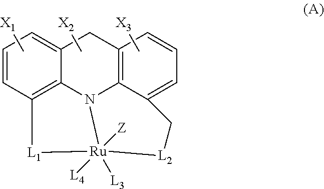
wherein,
L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently substituted or unsubstituted linear or branched C₁-C₁₀ alkyl;
L₃ and L₄ are each independently absent or a mono-dentate two-electron donor selected from the group consisting of CO, P(R)₃, P(OR)₃, NO⁺, As(R)₃, Sb(R)₃, S(R)₂, nitrile (RCN), isonitrile (RNC), ether or cyclic ether; and O—, N— or S— heterocycle or heteroaryl, wherein R is selected from the group consisting of alkyl, cycloalkyl, aryl, alkylaryl, heterocyclyl and heteroaryl; wherein if L₃ is absent then L₄ is mono-dentate two-electron donor selected from the above group; and wherein if L₄ is absent then L₃ is mono-dentate two-electron donor selected from the above group;
Z is H or an anionic ligand selected from the group consisting of halogen, OCOR, OCOCF₃, OSO₂R, OSO₂CF₃, CN, OH, OR, N(R)₂, RS and SH; wherein R is as defined above;
X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety.

2. The compound of claim 1, represented by the structure of Formula (Aa) or isomer thereof:

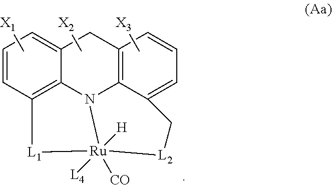

3. The compound according to claim 1, represented by the structure of Formula (Ab) or isomer thereof: 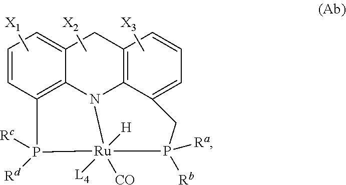
wherein
each of R^{a}, R^{b}, R^{c} and R^{d} is independently selected from the group consisting of substituted or unsubstituted aryl and linear or branched C₁-C₁₀ alkyl.

4. The compound according to claim 1, represented by the structure of Formula (Ac) or isomer thereof:

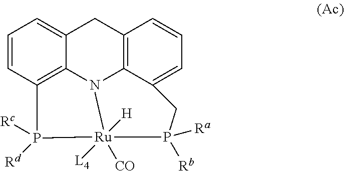

5. The compound according to claim 1, represented by structures 1-5 or isomer thereof: 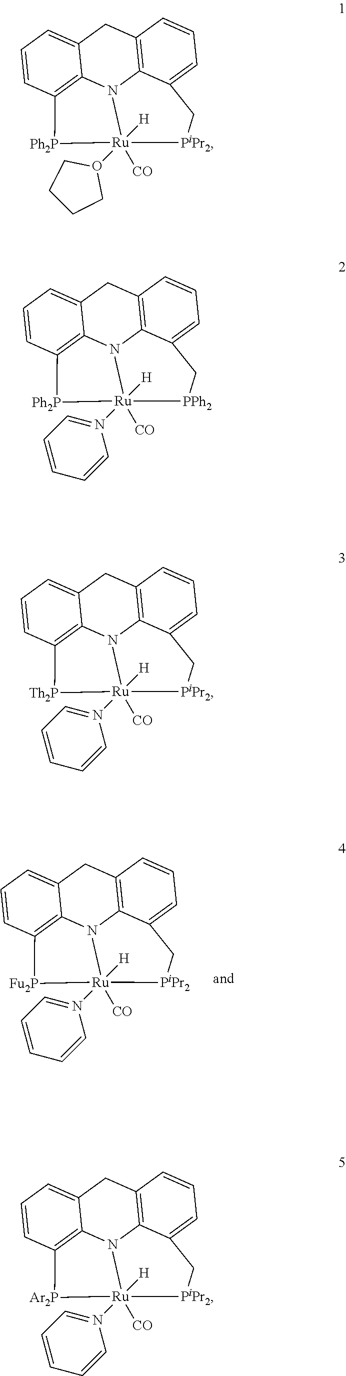
wherein 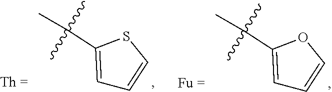 [SMILES: *c1cccs1 ; *c1ccco1]
Ph is phenyl, ⁱPr is isopropyl and

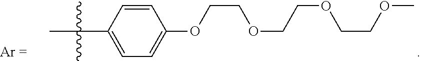 [SMILES: *c1ccc(OCCOCCOCCOC)cc1]

6. A compound represented by the structure of Formula (A1): 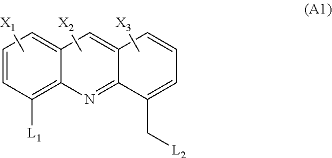
wherein
L₁ and L₂ is each independently selected from P(alk₁)(alk₂), P(alk₁)(aryl), P(aryl)(aryl), SH, S(alk₁), S(aryl), N(alk₁)(alk₂), NH(alk₁), NH(aryl), NH(benzyl), N(alk₁)(aryl), and N(aryl)(aryl), wherein alk₁, alk₂ are each independently linear or branched C₁-C₁₀ alkyl; and
X₁-X₃ each independently represents zero, one, two or three substituents selected from the group consisting of alkyl, aryl, halogen, nitro, amide, ester, cyano, alkoxy, cycloalkyl, alkylaryl, heterocyclyl, heteroaryl, an inorganic support and a polymeric moiety.

7. The compound of claim 6, represented by the structure of Formula (A1a): 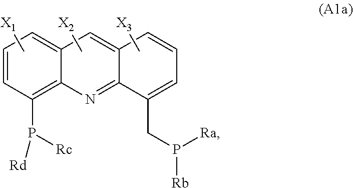
wherein
each of R^{a}, R^{b}, R^{c} and R^{d} is independently selected from the group consisting of substituted or unsubstituted aryl and linear or branched C₁-C₁₀ alkyl.

8. The compound of claim 7, represented by the structure of Formula (A1b):

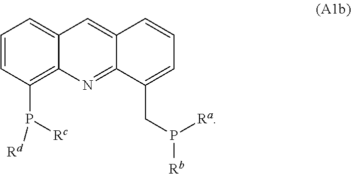

9. The compound of claim 6, represented by the following structures 6-10: 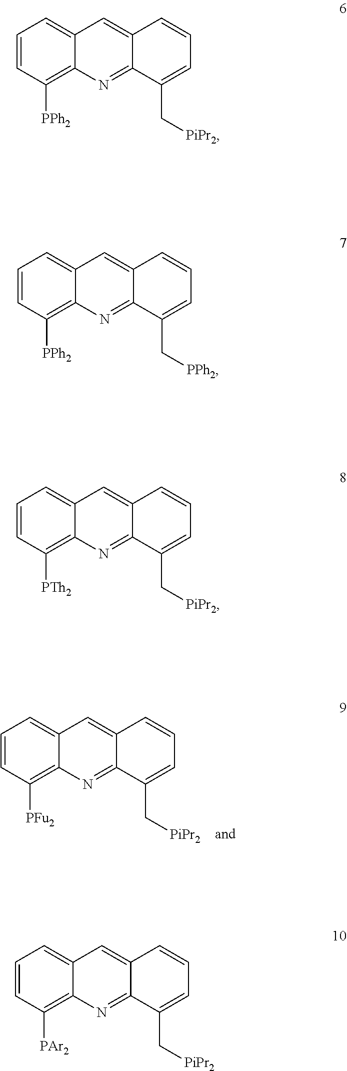
wherein 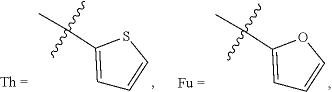 [SMILES: *c1cccs1 ; *c1ccco1]
Ph is phenyl, iPr is isopropyl, and

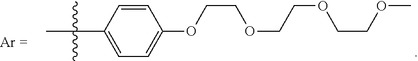 [SMILES: *c1ccc(OCCOCCOCCOC)cc1]

10. A reversible hydrogen loading and discharging method comprising the steps of
a) hydrogen releasing process wherein ethylene glycol is reacted with at least one compound according to claim 1; thereby forming hydrogen molecule (H₂) and oligoester of ethylene glycol;
b) hydrogen loading process wherein said oligoester of ethylene glycol is reacted with at least one compound according to claim 1 and hydrogen molecule (H₂); thereby forming ethylene glycol.

11. The reversible hydrogen loading and discharging method of claim 10, wherein said at least one compound is supported on insoluble matrices; wherein the insoluble matrices are inorganic compounds comprising inorganic oxides or insoluble polymers.

12. The reversible hydrogen loading and discharging method of claim 10, further comprising at least one organic solvent.

13. The reversible hydrogen loading and discharging method according to claim 10, wherein said method is conducted under a temperature of between about 120° C. to 170° C.

14. The reversible hydrogen loading and discharging method according to claim 10, wherein said method is functioning under pressure of between about 80 mbar to 110 mbar.

15. The reversible hydrogen loading and discharging method according to claim 10, capable of hydrogen storage capacity of at least 5 wt %.

16. The reversible hydrogen loading and discharging method of claim 15, capable of hydrogen storage capacity of at least 6 wt %.
